(19) United States
(12) Patent Application Publication
(10) Pub. No.: US 2026/0333429 A1
(43) Pub. Date: Oct. 22, 2026

(54) MULTI-PRIMARY CHANNEL ACCESS

(71) Applicant: QUALCOMM Incorporated, San Diego, CA (US)

(72) Inventors: Yanjun SUN, San Diego, CA (US); George CHERIAN, San Diego, CA (US); Gaurang NAIK, San Diego, CA (US); Abhishek Pramod PATIL, San Diego, CA (US); Alfred ASTERJADHI, San Diego, CA (US); Sai Yiu Duncan HO, San Diego, CA (US); Abdel Karim AJAMI, San Diego, CA (US); Yangjun ZHANG, Shanghai (CN); Lin YANG, Shanghai (CN); Yusheng YANG, Shanghai (CN); Sandip HOMCHAUDHURI, San Jose, CA (US)

(21) Appl. No.: 19/103,478

(22) PCT Filed: Nov. 4, 2022
(86) PCT No.: PCT/CN2022/129959

§ 371 Date: Feb. 12, 2025

(51) Int. Cl. H04W 74/0816; H04W 84/12

(52) U.S. Cl. CPC H04W 74/0816; H04W 84/12

(57) ABSTRACT

Methods, systems, and devices for wireless communications are described. An access point (AP) and a station (STA) may utilize a main primary subchannel (M-Primary channel) and an opportunistic primary channel (O-Primary channel) according to one or more rules. For example, the AP and the STA may align transmission opportunity (TXOP) boundaries across the O-Primary channel and the M-Primary channel so that transmissions or receptions on the O-Primary channel do not extend beyond (or end prematurely) with respect to a TXOP on the M-Primary channel. To facilitate such boundary alignment, the AP and the STA may perform an initial frame exchange indicating a remainder of a duration of a current TXOP on the M-Primary (facilitating alignment of the ending boundary of a new TXOP on the O-Primary). The initial frame exchange may include an initiating frame and a response frame, and may be initiated by the AP or the STA.

### CROSS REFERENCE

This application is a 371 National Stage of PCT Application No. PCT/CN2022/129959, filed on Nov. 4, 2022, entitled “MULTI-PRIMARY CHANNEL ACCESS”, and assigned to the assignee hereof. The disclosure of the prior Application is considered part of and is incorporated by reference into this Patent Application.

### TECHNICAL FIELD

The following relates to wireless communications, including sharing of multiple primary channels and coordination of transmission opportunity timing across the primary channels.

### DESCRIPTION OF THE RELATED TECHNOLOGY

Wireless communications systems are widely deployed to provide various types of communication content such as voice, video, packet data, messaging, broadcast, and so on. These systems may be multiple-access systems capable of supporting communication with multiple users by sharing the available system resources (such as time, frequency, and power). A wireless network, for example a WLAN, such as a Wi-Fi (Such as Institute of Electrical and Electronics Engineers (IEEE) 802.11) network may include AP that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via DL and UL. The DL (or forward link) may refer to the communication link from the AP to the station, and the UL (or reverse link) may refer to the communication link from the station to the AP.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless communication device. The wireless communication device includes one or more interfaces, and may include one or more processing systems configured to and capable of implementing features that include communicating during a first transmission opportunity via a first subchannel within an operating bandwidth of a wireless communication link, where the first subchannel is a primary channel and communicating during a second transmission opportunity that at least partially overlaps with the first transmission opportunity via a second subchannel, where the second subchannel is different from the primary channel.

Another innovative aspect of the subject matter described in this disclosure can be implemented in a method for wireless communication. The method includes communicating during a first transmission opportunity via a first subchannel within an operating bandwidth of a wireless communication link, where the first subchannel is a primary channel and communicating during a second transmission opportunity that at least partially overlaps with the first transmission opportunity via a second subchannel, where the second subchannel is different from the primary channel.

Another innovative aspect of the subject matter described in this disclosure can be implemented in an apparatus for wireless communications, which may include means for communicating during a first transmission opportunity via a first subchannel within an operating bandwidth of a wireless communication link, where the first subchannel is a primary channel and means for communicating during a second transmission opportunity that at least partially overlaps with the first transmission opportunity via a second subchannel, where the second subchannel is different from the primary channel.

Another innovative aspect of the subject matter described in this disclosure can be implemented in a non-transitory computer-readable medium storing code. The code may include instructions executable by a processor to communicating during a first transmission opportunity via a first subchannel within an operate bandwidth of a wireless communication link, where the first subchannel is a primary channel and communicating during a second transmission opportunity that at least partially overlap with the first transmission opportunity via a second subchannel, where the second subchannel is different from the primary channel.

In some examples, the methods and wireless communication devices may perform a handshake procedure with a first STA indicating that the operating bandwidth may be clear, where the operating bandwidth includes a quantity of subchannels that includes the first subchannel and the second subchannel, and where the quantity of subchannels satisfies a threshold quantity of subchannels supported by the first STA and communicating with the first STA simultaneously via each of the quantity of subchannels in accordance with the handshake procedure Another innovative aspect of the subject matter described in this disclosure can be implemented in a wireless communication device. The wireless communication device includes one or more interfaces, and may also include one or more processing systems configured to and capable of implementing features to communicate with an AP during a first transmission opportunity via a first subchannel within an operating bandwidth of a wireless communication link, where a second transmission opportunity of a second subchannel of the operating bandwidth at least partially overlaps with the first transmission opportunity, and where the STA is capable of performing a listen-before-talk procedure on the first subchannel, the second subchannel, or both.

Another innovative aspect of the subject matter described in this disclosure can be implemented in a method for wireless communication. The method includes communicating with an AP during a first transmission opportunity via a first subchannel within an operating bandwidth of a wireless communication link, where a second transmission opportunity of a second subchannel of the operating bandwidth at least partially overlaps with the first transmission opportunity, where the STA is capable of performing a listen-before-talk procedure on the first subchannel, the second subchannel, or both.

Another innovative aspect of the subject matter described in this disclosure can be implemented in an apparatus for wireless communications, which may include means for communicating with an AP during a first transmission opportunity via a first subchannel within an operating bandwidth of a wireless communication link, where a second transmission opportunity of a second subchannel of the operating bandwidth at least partially overlaps with the first transmission opportunity, where the STA is capable of performing a listen-before-talk procedure on the first subchannel, the second subchannel, or both.

Another innovative aspect of the subject matter described in this disclosure can be implemented in a non-transitory computer-readable medium storing code. The code may include instructions executable by a processor to communicate with an AP during a first transmission opportunity via a first subchannel within an operating bandwidth of a wireless communication link, where a second transmission opportunity of a second subchannel of the operating bandwidth at least partially overlaps with the first transmission opportunity, where the STA is capable of performing a listen-before-talk procedure on the first subchannel, the second subchannel, or both.

In some examples, the methods and wireless communication devices may a handshake procedure with the AP indicating that the operating bandwidth may be clear, where the operating bandwidth includes a quantity of subchannels that includes the first subchannel and the second subchannel, and where the quantity of subchannels satisfies a threshold quantity of subchannels supported by the first STA and communicating with the AP simultaneously via each of the quantity of subchannels in accordance with the handshake procedure

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 illustrates an example of a wireless communications system that supports multi-primary channel access.

FIG. 2 illustrates an example of a channel access scheme that supports multi-primary channel access.

FIGS. 3-15 illustrate examples of a timeline that supports multi-primary channel access.

FIG. 16 illustrate an example of a capability reporting scheme that supports multi-primary channel access.

FIGS. 17-18 illustrate examples of a timeline that supports multi-primary channel access.

FIG. 19 illustrates an example of a communications system that supports multi-primary channel access.

FIGS. 20 and 21 illustrate flowcharts showing methods that support multi-primary channel access.

FIG. 22 illustrates a block diagram of a communications manager that supports multi-primary channel access.

FIG. 23 illustrates a block diagram of a communications manager that supports multi-primary channel access.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to multi-primary channel access. Some aspects more specifically relate to how wireless devices may perform an initial frame exchange prior to data signaling on one or multiple primary channels, and may align transmission opportunity (TXOP) boundaries to avoid device unavailability while performing multi-primary channel communications. In some examples, wireless devices, such as access points (APs) and stations (STAs), may communicate via a channel, which may include one or more subchannels (such as, one or more 20 MHz, 10 MHz, or 5 MHz subchannels). An AP equipped with one or more radios may communicate with a STA, which also may be equipped with one or more radios (such as, a main radio and an auxiliary radio, or two main radios). The AP and the STA may establish a single wireless link using multiple subchannels (such as, a main primary channel (M-Primary) and an opportunistic primary channel (O-Primary)), and both devices may be able to sense the channel on either primary channel. However, even with the introduction of two or more radios per device, as well as an M-Primary channel and O-Primary channel, additional rules may ensure that communications may occur over the different primary channels. For example, if the AP is transmitting using a main radio on the O-Primary channel, the AP may be unavailable on the M-Primary channel for reception unless the second radio of the AP is also a main radio. Similarly, when the AP is receiving on the O-Primary channel, the AP may avoid self-interference to the receptions on the O-Primary channel arising from transmissions on the M-Primary channel (such as, beaconing, group addressed frames, etc.). To avoid such scenarios, the AP and the STA may utilize the M-Primary channel and the O-Primary channel according to one or more rules. For example, the AP and the STA may align transmission opportunity (TXOP) boundaries across the O-Primary channel and the M-Primary channel so that transmissions or receptions on the O-Primary channel do not extend beyond (or end prematurely) with respect to a TXOP on the M-Primary channel. To facilitate such boundary alignment, the AP and the STA may perform an initial frame exchange indicating a remainder of a duration of a current TXOP on the M-Primary channel (facilitating alignment of the ending boundary of a new TXOP on the O-Primary channel). The initial frame exchange may include an initiating frame and a response frame, and may be initiated by the AP or the STA.

An AP and a STA may prepare for communications via a full band (such as, a channel) by performing one or more protections (such as, may perform request-to-send (RTS) and clear-to-send (CTS) handshake procedures). The RTS and CTS handshake procedure may ensure that the full band (such as, a channel) is actually available for communications before initiating the communications. However, for subband communications, such handshake procedures on a subband basis may result in increased signaling overhead and system delays. In some examples, an AP and a STA may simultaneously establish multiple subchannel connections, but may protect the various subbands (such as, 5 MHz subbands or 10 MHz subbands) on a full band basis. For example, instead of performing individual RTS and CTS handshake procedures for each individual subband, the AP and the STA may protect all of the subbands by performing an RTS and CTS handshake procedure for the full channel, followed by subsequent communications via each individual subband. The simultaneous communications may still be via the individual subbands, but the full band may be protected.

Particular aspects of the subject matter described in this disclosure can be implemented to realize one or more of the following potential advantages. In some implementations, by supporting multiple primary channels, the described techniques may be used to improve throughput by utilizing otherwise unutilized resources (such as, additional subchannels other than an occupied primary subchannel). Such increased efficiency of resource utilization may result in increased throughput, and decreased system latency. As such, the AP and the one or more STAs may achieve higher data rates, greater spectral efficiency, and greater system capacity, among other benefits. Additionally, or alternatively, use of multiple subchannels protected by a handshake procedure for a full channel may result in more efficient utilization of resources of the full band, while harnessing the increased throughput and distance capacity of signaling via the multiple subbands.

Aspects of the disclosure are initially described in the context of a wireless communications system. Aspects of the disclosure are further illustrated by and described with reference to channel access schemes, timelines, and communications systems. Aspects of the disclosure are further illustrated by and described with reference to apparatus diagrams, system diagrams, and flowcharts that relate to multi-primary channel access for ultra-high reliability (UHR) communications, which are expected to be associated with Wi-Fi 8 (i.e., 802.11bX, where X is yet to be classified).

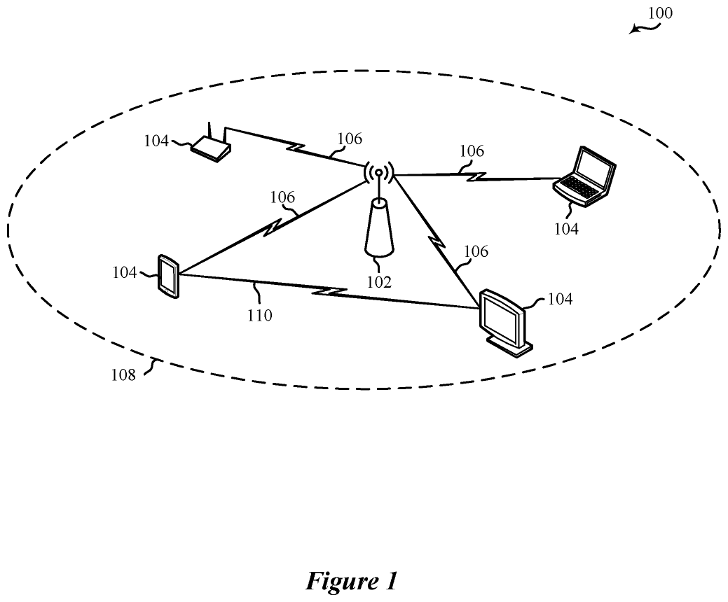

FIG. 1 shows a block diagram of an example WLAN 100. According to some aspects, the WLAN 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IOT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHZ or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHZ and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

In some wireless communications environments, Extremely High Throughput (EHT) systems or other systems compliant with future generations of the IEEE 802.11 family of wireless communication protocol standards may provide additional capabilities over other previous systems (for example, High Efficiency (HE) systems or other legacy systems). EHT and newer wireless communication protocols may support flexible operating bandwidth enhancements at APs and STAs, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device operates in a contiguous 320 MHz bandwidth mode or a 160+160 MHz bandwidth mode. Signals for transmission may be generated by two different transmit chains of the device each having a bandwidth of 160 MHz (and each coupled to a different power amplifier). In some other examples, signals for transmission may be generated by four or more different transmit chains of the device, each having a bandwidth of 80 MHz.

In some other examples, the wireless communication device may operate in a contiguous 240 MHz bandwidth mode, or a noncontiguous 160+80 MHz bandwidth mode. In some examples, the signals for transmission may be generated by three different transmit chains of the device, each having a bandwidth of 80 MHz. In some other examples, the 240 MHz/160+80 MHz bandwidth modes also may be formed by puncturing 320/160+160 MHz bandwidth modes with one or more 80 MHz subchannels. For example, signals for transmission may be generated by two different transmit chains of the device each having a bandwidth of 160 MHz with one of the transmit chains outputting a signal having an 80 MHz subchannel punctured therein.

The operating bandwidth also may accommodate concurrent operation on other unlicensed frequency bands (such as the 6 GHz band) and a portion of spectrum that includes frequency bands traditionally used by Wi-Fi technology. In noncontiguous examples, the operating bandwidth may span one or more disparate sub-channel sets. For example, the 320 MHz bandwidth may be contiguous and located in the same 6 GHz band or noncontiguous and located in different bands (such as partly in the 5 GHz band and partly in the 6 GHz band).

In some examples, operability enhancements associated with EHT and newer generations of the IEEE 802.11 family of wireless communication protocols, and in particular operation at an increased bandwidth, may include refinements to carrier sensing and signal reporting mechanisms. Such techniques may include modifications to existing rules, structure, or signaling implemented for legacy systems.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

Retransmission protocols, such as hybrid automatic repeat request (HARQ), also may offer performance gains. A HARQ protocol may support various HARQ signaling between transmitting and receiving wireless communication devices as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, If a receiving device cannot properly decode (and cannot correct the errors) a first HARQ transmission received from the transmitting device, the receiving device may transmit a HARQ feedback message to the transmitting device (for example, a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an ARQ protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

APs 102 and STAs 104 can support multi-user (MU) communications; that is, concurrent transmissions from one device to each of multiple devices (for example, multiple simultaneous downlink (DL) communications from an AP 102 to corresponding STAs 104), or concurrent transmissions from multiple devices to a single device (for example, multiple simultaneous uplink (UL) transmissions from corresponding STAs 104 to an AP 102). To support the MU transmissions, the APs 102 and STAs 104 may utilize multi-user multiple-input, multiple-output (MU-MIMO) and multi-user orthogonal frequency division multiple access (MU-OFDMA) techniques.

In MU-OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Larger 52 tone, 106 tone, 242 tone, 484 tone and 996 tone RUs also may be allocated. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL MU-OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP may allocate or assign multiple RUs to a single STA. As increasing bandwidth is supported by emerging standards (such as 802.11be supporting 320 MHz), various multiple RU (multi-RU) combinations may exist. Values indicating the various multi-RU combinations may be provided by a suitable standard specification (such as one or more of the IEEE 802.11 family of wireless communication protocol standards including 802.11be).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing is a wireless communication technique that enables a wireless communication device (such as an AP or a STA) to transmit and receive wireless communications over a portion of a wireless channel exclusive of one or more particular subchannels (hereinafter also referred to as “punctured subchannels”). Static puncturing specifically may be used to exclude one or more subchannels from the transmission of a PPDU, including the signaling of the preamble, to avoid interference from a static source such as an incumbent system. The transmitting device may puncture the subchannels on which there is interference and in essence spread the PPDU to cover the remaining portion of the bandwidth of the channel. For example, if a wireless communication device determines (for example, detects, identifies, ascertains, or calculates) that a 20 MHz subchannel of a 160 MHz or 320 MHz wireless channel is consistently occupied, the wireless communication device can use channel puncturing to avoid communicating over the occupied subchannel while still utilizing the remaining 140 MHz or 300 MHz of bandwidth. Accordingly, channel puncturing allows a wireless communication device to improve or maximize its throughput by utilizing more of the available spectrum that would otherwise have been idle. Static puncturing in particular makes it possible to consistently use wide channels in environments where there is insufficient contiguous spectrum available. Additionally, puncturing also may be used in conjunction with multi-RU transmissions to enable wide channels to be established using non-contiguous spectrum blocks. In such examples, the portion of the bandwidth between two RUs allocated to a particular STA may be punctured. Accordingly, spectrum efficiency and flexibility may be increased.

STA-specific RU allocation information is included in the EHT-SIG field of the PPDU's preamble. Because RUs may be individually allocated in a MU PPDU, use of the MU PPDU format may indicate preamble puncturing for SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

Some wireless communication devices (including both APs and STAs) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

In some examples, an AP 102 and the STA 104 may establish a single wireless link using multiple subchannels (such as, a main primary channel (M-Primary) and an opportunistic primary channel (O-Primary)), and both devices may be able to sense the channel on either primary channel. However, even with the introduction of two or more radios per device, as well as an M-Primary channel and O-Primary channel, additional rules may ensure that communications may occur over the different primary channels. For example, if the AP 102 is transmitting using a main radio on the O-Primary channel, the AP 102 may be unavailable on the M-Primary channel for reception unless the second radio at the AP 102 is also a main radio. Similarly, when the AP 102 is receiving on the O-Primary channel, the AP 102 may avoid self interference to the receptions on the O-Primary arising from transmissions on the M-Primary (such as, beaconing, group addressed frames, etc.). To avoid such scenarios, the AP 102 and the STA 104 may utilize the M-Primary and the O-Primary channel according to one or more rules. For example, the AP 102 and the STA 104 may align transmission opportunity (TXOP) boundaries across the O-Primary channel and the M-Primary channel so that transmissions or receptions on the O-Primary channel do not extend beyond (or end prematurely) with respect to a TXOP on the M-Primary channel. To facilitate such boundary alignment, the AP 102 and the STA 104 may perform an initial frame exchange indicating a remainder of a duration of a current TXOP on the M-Primary (facilitating alignment of the ending boundary of a new TXOP on the O-Primary). The initial frame exchange may include an initiating frame and a response frame, and may be initiated by the AP 102 or the STA 104.

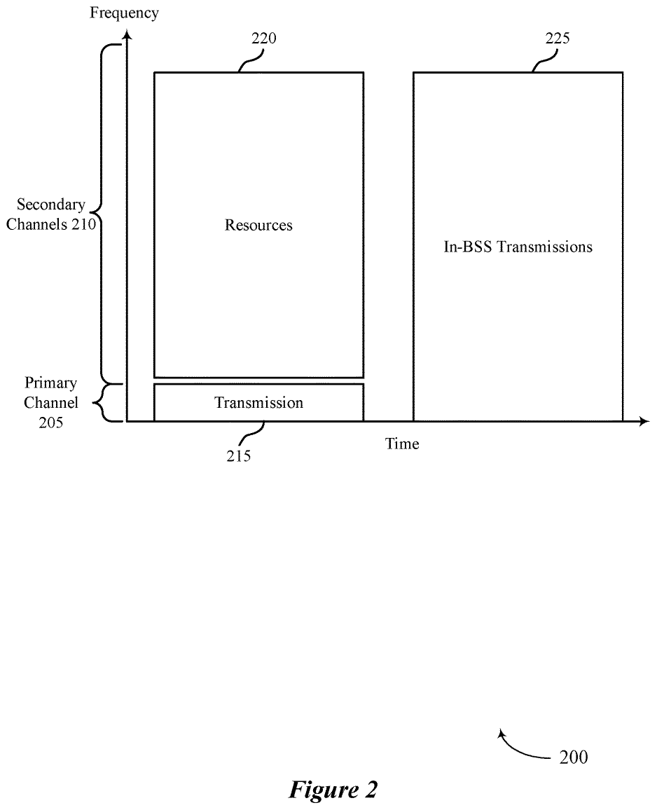

FIG. 2 illustrates an example of a channel access scheme 200 that supports multi-primary channel access aspects. Channel access scheme 200 may implement aspects of, or be implemented by aspects of, the WLAN 100. For example, an AP (such as, an AP 102), and a STA (such as, a STA 104), which may be examples of corresponding devices described with reference to FIG. 1, may communicate according to the channel access scheme 200.

In some examples, the STA 104 and the AP 102 may communicate according to one or more channels, including a primary channel 205, and one or more secondary channels 210. The primary channel may include a portion of available resources, and the remainder of the available resources may include one or more secondary channels. For instance, the primary channel 205 may be a 20 MHz channel, a 40 MHz channel, or 20 MHz portion of a 40 MHz channel, or any other example of a channel. In some examples, resources 220 may be divided into one or more secondary channels (such as, a 20 MHz channel, a 40 MHz channel, an 80 MHz channel, a 160 MHz channel, etc.). In-BSS transmissions 225 (such as, from a STAs in a basic service set (BSS) served by the AP 102) may occupy a full available bandwidth (such as, including the primary channel 205 and one or more secondary channels 210). In some examples, a transmission 215 may occupy the primary channel 205. The transmission 215 may be an overlapping basic service set (OBSS) transmission (such as, from another STA 104 in an OBSS associated with the AP 102), or may be a transmission from another STA in a basic service ser (BSS) served by the AP 102 (such as, an in-BSS legacy transmission). In such examples, because the 20 MHz channel is busy (such as, due to the transmission 215), the STA 104 may defer a pending transmission (such as, may not be able to gain access to resources 220 based on sensing the transmission 215 via the primary channel 205). Such procedures may result in under-utilization of resources 220, longer latency, and lower throughput.

Techniques described herein may improve spectrum efficiency and reduce system latency by supporting transmissions by STAs 115 via resources 220, even if the primary channel 205 is busy. Techniques described herein may further support mechanisms for high priority traffic to be served when the primary channel 205 is occupied by a transmission 215. To implement such techniques, wireless devices (such as, the STA 104 and the AP 102) may be equipped with one or more additional radios that are capable of monitoring one or more additional channels (such as, additional 20 MHz channels) within the operating bandwidth. Such devices may be ultra-high reliability (UHR) devise, and may monitor or contend on at least one additional channel (such as, a second or additional primary channel). The additional radio on such a device may be preamble detection (PD) capable, among other capabilities. Although techniques described herein may refer to two radios, techniques described herein may be applied for any number of radios, and any number of additional primary channels.

In some examples, a first primary channel may be referred to as a main primary (M-Primary) channel, and a second primary channel may be referred to as an opportunistic primary (O-Primary) channel. The M-Primary channel may perform one or more functions performed by the primary channel 205 (such as, beaconing, serving legacy clients, etc.). The O-Primary channel may support opportunistic access on under-utilized subchannels (such as, the resources 220). In some examples, such devices may not support simultaneous transmit/receive (Tx/Rx) operations on the M-Primary and the O-Primary. In some examples, such Tx/Rx operations may be possible, but may rely on some frequency separation between channels to operate effectively.

In some examples, communication on M-Primary and O-Primary channels may occur after a mode of communication is requested by a non-AP STA or enabled by an AP within the BSS, or both. In some other examples, when the mode is not enabled, the AP and non-AP STA may communicate only on the M-Primary channel.

Each device may include at least two radios. For instance, a first radio may be a main radio (MR), and may be associated (such as, at least initially) with communications via M-Primary. The device also may be equipped with a second radio (such as, associated, at least initially, with O-Primary). Such a second radio may be an auxiliary (AUX) radio, which may be capable of PD (such as, an AUX PD radio), an AUX radio capable of reception (such as, AUX-Rx), an AUX radio capable of transmission and reception (such as, AUX RxTx), or a second MR. AUX radios, as described herein, may refer to any type of AUX radio (such as, AUX-PD, AUX-Rx, AUX RxTx, etc.).

Some devices (such as, APs, and non-AP STAs) may have different radio configurations on O-Primary. For example, an AUX PD radio may rely on a physical (PHY) header of a physical layer protocol data unit (PPDU) to detect incoming traffic. Such a radio may be capable of clear channel assessments or listen-before-talk (LBT) procedures, but may not be capable of decoding media access control (MAC) protocol data units (MPDU)s within the PPDU. An AUX-Rx or AUX-RxTx radio may be capable of CCA and receiving certain PPDUs with one or more constrains on MCS, number of spatial streams (NSS), or the like. An AUX-RxTx radio may additionally be capable of transmitting some PDUs with one or more MCS or NSS constraints. An AUX-RxTx radio may be a lower capability radio such as an 802.11ac or 802.11n radio. In some implementations, an MR may include full capabilities (such as, of any AUX radio) and may support all the capabilities that are supported by the MR operating (at least initially) on the M-Primary channel.

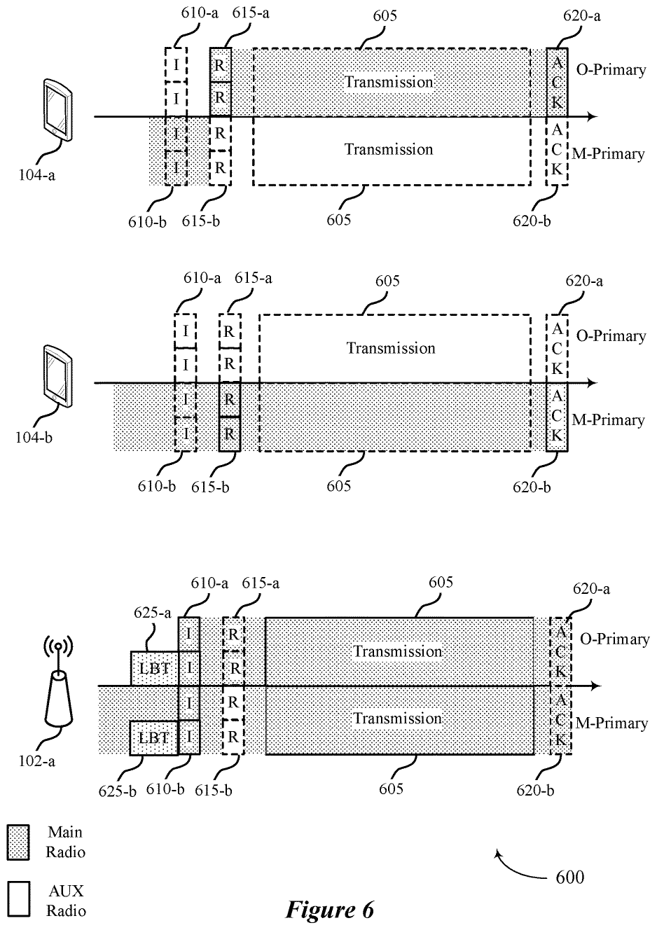

In some examples, use of resources 215 (such as, one or more O-Primary channels) when an M-Primary channel (such as, primary channel 205) is occupied may support narrow band devices in wideband BSSs (such as, as described in greater detail with reference to FIG. 6). In some examples, high efficiency (HE) subchannel selective transmission (SST) procedures may support improved spectral efficiency by allowing narrowband STAs 115 to negotiate individual TWT service periods (SPs) on secondary subchannels. However, transmissions on secondary subchannels under HE SST procedures may be possible when a primary channel is available. Such procedures may not utilize available resources if, for instance, an OBSS transmission occupies the primary channel (such as, in which case, one or more secondary channels cannot be used). Further, transmissions on such secondary subchannels may be limited to negotiated SPs. In some examples, only triggered transmissions may be allowed during the SPs in an HE SST procedure. However, techniques described herein do not rely on negotiated SPs, and are not limited to triggered transmissions or available primary channels, and are therefore more efficient.

Techniques described herein also may support multi-primary use cases. For example, the AP 102 and the STA 104 may communicate via an O-Primary simultaneously while an OBSS transmission occupies the M-Primary. The AP 102 and the STA 104 may perform an initial frame exchange (such as, including an initiating frame and a response frame) prior to communications on the M-Primary channel and the O-Primary channel. Techniques described herein also may support communications on the O-Primary channel when an in-BSS narrowband data transmission from another in-BSS STA occupies the M-Primary channel. In some cases, an AP may support reception of in-BSS data from a first in-BSS STA while simultaneously communicating (such as, receiving) control signaling (such as, a short frame, such as a feedback message) from an in-BSS STA (such as, a feedback message from the first STA 104 communicating via the M-Primary channel, or a control message from another in-BSS STA 104). Techniques described herein support any such scenarios where communication on the O-Primary channel while the M-Primary channel is occupied.

In some examples, STA 104 may support non-simultaneous transmit receive (NSTR) on the O-Primary channel, the M-Primary channel, or both. In some cases, the O-Primary channel and the M-Primary channel may be located within a same band. Frequency separation in the same band may not be sufficient to allow simultaneous transmit receive (STR) operations on the M-Primary and the O-Primary. Additionally, the STA 104 may experience some constraints on an ability to perform CCA procedures and receive uplink PPDUs. For example, the STA 104 may be considered available if the STA 104 is capable of performing a CCA and receiving uplink PPDUs on a channel without constraints. However, a STA 104 may become unavailable on the M-Primary channel when the STA 104 is transmitting on the O-Primary channel (such as, due to NSTR interference from the O-Primary channel to the M-Primary channel), or if the STA 104 has only one shared MR and the MR is tuned to the O-Primary channel (such as, either for transmission or reception). If the AP 102 becomes unavailable on the M-Primary channel, then the AP 102 may be unable to receive uplink PPDUs, or perform management functions such as beaconing.

To address such constraints, and to improve system efficiency by utilizing available system resources (such as, resources 220), techniques described herein may avoid or reduce unavailability of AP 102 on M-Primary channel according to a unified protocol that works across different radio configurations and use cases. Rules described herein may be the same for APs 105 or non-APs (such as, STAs 104) regardless of whether the device has two MRs or one MR and one AUX radio.

The AP 102 and the STA 104 may communicate via the M-Primary channel and the O-Primary channel according to a first rule, under which the end of a transmission opportunity (TXOP) on the M-Primary channel and a TXOP on the O-Primary channel are aligned. In some examples of an MR architecture (such as, one MR on the O-Primary channel and one MR on the M-Primary channel), the AP 102 may transmit on the O-Primary channel, and may avoid unavailability of the MR on the M-Primary by aligning TXOP ending boundaries across the O-Primary channel and the M-Primary channel. If the AP 102 is receiving on the O-Primary channel, the AP 102 may avoid NSTR interference to the reception on the O-Primary channel due to the transmission on the M-Primary channel (e., beaconing, group addressed frames, etc.) by aligning TXOP ending boundaries across the O-Primary channel and the M-Primary channel. In some examples of an AUX radio architecture (such as, one MR shared between the O-Primary channel and the M-Primary channel and one AUX radio), when the AP 102 is transmitting or receiving on the O-Primary channel, the AP 102 may avoid unavailability of the MR on the M-Primary channel by aligning TXOP ending boundaries across the O-Primary channel and the M-Primary channel.

In some examples, at least one peer device (such as, the AP 102 or the STA 104) may have access to information regarding a remaining TXOP duration on the M-Primary channel (such as, to support aligning TXOP ending boundaries). A non-AP STA 104 may not have access to such information (such as, resulting from complexity or power saving considerations). In some examples, the AP 102 may have access to such information (such as, may perform PD on an OBSS transmission, or may be receiving an in-BSS transmission from another STA 104). However, in some examples, the AP 102 may not be able to decode a preamble of an OBS transmission. In such instances, the AP 102 may perform SIFS bursting, and may monitor the M-Primary channel during block feedback (such as, block acknowledgement (BlockACK (BA))) reception to determine if the M-Primary channel is available. Thus, the AP 102 may align TXOPs across the O-Primary channel and the M-Primary channel (such as, via an initial frame exchange) as described herein. In some cases, the STA 104 also may have access to such information, and may similarly support such TXOP boundary alignment.

The AP 102 and one or more STAs 104 also may communicate according to a second rule. For example, an initial frame exchange may indicate a remaining TXOP duration on the M-Primary channel (such as, supporting TXOP ending boundary alignment). In some examples, an allowed TXOP duration on the O-Primary channel may be equal to an indicted remaining TXOP duration on the M-Primary channel. The AP 102, or the STA 104, may initiate transmission on the O-Primary channel with an initiating frame. The allowed TXOP duration on the O-Primary channel may be indicated in the initiating frame or in a response frame. Such indications may be supported if at least one of the devices (such as, the AP 102) has access to the TXOP duration on the M-Primary (such as, by perfuming PD on an OBSS transmission). The response frame may, in some examples, additionally indicate a non-AP STA 104 transmit power, target RSSI, a priority level, among other examples.

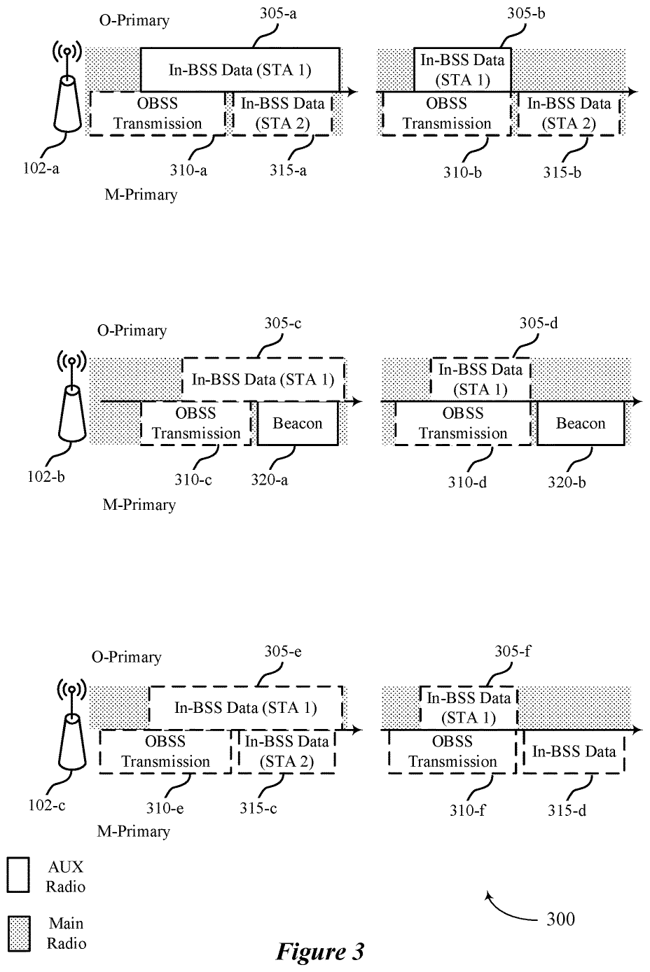

Examples of communications according to the first rule (such as, TXOP ending boundary alignment) are illustrated and described with reference to FIG. 3.

FIG. 3 illustrates an example of a timeline 300 that supports multi-primary channel access. The timeline 300 may implement or be implemented to realize or facilitate aspects of the WLAN 100, or the channel access scheme 200. For example, the communication timeline 300 illustrates communication between the AP 102-a, the AP 102-b, and the AP 102-c, and one or more STAs 104, and examples of APs 102 and STAs 104 are additionally illustrated by and described with reference to FIG. 1. In some implementations, the AP 102-a, the AP 102-b, and the AP 1025-c may implement the communication timeline 300. The AP 102-a, the AP 102-b, and the AP 102-c, may align TXOPs across one or more primary channels (such as, the M-Primary channel and the O-Primary channel) as described herein.

The AP 102-a may support an MR architecture (such as, a single MR or two MRs, a first MR on the O-Primary channel and a second MR on the M-Primary channel). The AP 102-a may avoid MR unavailability on the MR-Primary channel due to NSTR interference. For instance, without alignment of TXOPs, an OBSS transmission 310-a may occupy the M-Primary channel. The AP 102-a also may transmit in-BSS data 305-a (such as, to a first STA 104) via the O-Primary channel using the MR. The in-BSS data 305-a may overlap, at least partially in time, with the OBSS transmission 310-a. The AP 102-a may receive in-BSS data 315-a (such as, from a second STA 104) via the M-Primary channel using the MR. However, the AP 102-a may experience NSTR interference on the M-Primary channel while trying to receive the in-BSS data 305-a via the O-Primary channel. The AP 102-a also may fail to receive the in-BSS data 315-a due to transmitting the in-BSS data 305-a. However, if the AP 102-a aligns the ending boundary of the TXOP for the in-BSS data 305-b (such as, from the first STA 104) and the ending boundary of the TXOP for the OBSS transmission 310-b, then the AP 102-a may be able to successfully transmit the in-BSS data 305-b to the first STA 104, and subsequently receive the in-BSS data 315-b (such as, from the second STA 104).

The AP 102-b also may support the MR architecture. An OBSS transmission 310-c may occupy the M-Primary channel, and the AP 102-b may receive in-BSS data 305-c (such as, from a first STA 104). The AP 102-b may transmit signaling such as a beacon, or one or more group addressed frames that overlap at least partially in time with the in-BSS data 305-c. The AP 102-b may cause NSTR interference during transmission of the beacon 320-a (such as, to the in-BSS data 305-c). However, by aligning an ending TXOP of the in-BSS data 305-d and the OBSS transmission 310-d, the AP 102-b may be able to transmit the beacon 320-b (such as, or group addressed frames) without causing NSTR interference.

The AP 102-c may support an AUX radio architecture (such as, may support an AUX radio and an MR), and may avoid MR unavailability on the M-Primary channel due to transmissions or receptions on the O-Primary channel by aligning TXOP ending boundaries. For example, an OBSS transmission 310-e may occupy the M-Primary channel, and the AP 102-c may receive in-BSS data 305-e (such as, from a first STA 104) via the O-Primary channel using the MR. The in-BSS data 305-e may overlap in time with in-BSS data 315-c (such as, from a second STA) on the M-Primary channel, which the AP 102-c may receive using the AUX radio. However, in some examples, the AP 102-c may not support simultaneous reception of the in-BSS data 305-e and the in-BSS data 315-c. The AP 102-c may align the ending boundary of a TXOP for the in-BSS data 305-f and a TXOP for the OBSS transmission 310-f. In such examples, the AP 102-c may become available after the in-BSS data 305-f is received via the main radio, and may successfully receive the in-BSS data 315-d.

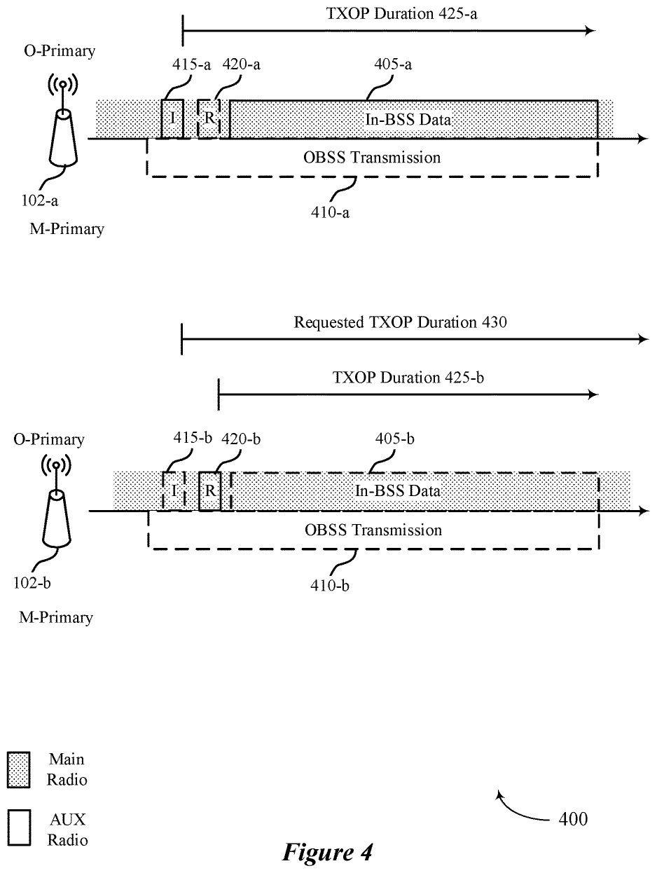

An AP 102 and a STA 104 may align TXOPs as described with reference to FIG. 3 via an initial frame exchange, including an initiating frame (I) and a response frame (R), as described in greater detail with reference to FIG. 4.

FIG. 4 illustrates an example of a timeline 400 that supports multi-primary channel access. The timeline 400 may implement or be implemented to realize or facilitate aspects of the WLAN 100, the channel access scheme 200, or the timeline 300. For example, the communication timeline 400 illustrates communication between the AP 102-a, the AP 102-b, and one or more STAs 104, and examples of APs 102 and STAs 104 are additionally illustrated by and described with reference to FIG. 1. The AP 102-a, and the AP 102-b, may align TXOPs across one or more primary channels (such as, the M-Primary channel and the O-Primary channel) by performing an initial frame exchange. The initiating frame exchange may indicate a remaining TXOP duration on the M-Primary.

The AP 102 may determine a remaining TXOP duration on the M-Primary channel via PD. The Allowed TXOP duration on the O-Primary channel may indicate a remaining TXOP duration on the M-Primary. The AP 102, or the STA 104, may then initiate transmissions on the O-Primary channel with an initiating frame The allowed TXOP duration on the O-Primary channel may be indicated in the initiating frame, or the response frame. Such techniques may support a non-AP STA 104 to end the TXOP without causing AP unavailability on the M-Primary channel.

For example, the AP 102-a may communicate with a STA (such as, using an MR on the O-Primary channel and an AUX radio on the M-Primary channel). An OBSS transmission 410-a may occupy the M-Primary channel (such as, as detected by the AP 102-a via PD). For a duration of an in-BSS data 405-a transmission to the STA, the AP 102-a may indicate an allowed TXOP duration in the initiating frame 415-a. The AP 102-a may transmit the initiating frame 415-a to the STA 104, and may include, in the initiating frame 415-a. an indication of TXOP duration 425-a (such as, a remaining duration of the OBSS transmission 410-a). The AP 102-a may receive the response frame 420-a from the STA, and may then transmit the in-BSS data 405-a to the STA according to the TXOP duration 425-a (such as, such that the ending boundary of the TXOP for the in-BSS data is aligned with the ending boundary of the TXOP for the OBSS transmission 410-a). In such examples, the AP 102-a may then be available on M-Primary for subsequent transmissions or receptions at the end of TXOP duration 425-a.

In some examples, the duration of an allowable TXOP for in-BSS data 405-b may be indicated in a response frame 420 (such as, for non-AP initiated frames). For instance, an OBSS transmission 410-b may occupy the M-Primary channel (such as, detected by the AP 102-b via PD). The AP 102-b may receive an initiating frame 415-b from the STA. The initiating frame 415-b may include an indication of a requested TXOP duration 430, which may extend beyond the OBSS transmission 410-b. The AP 102-b may transmit a response frame 420-b to the STA, indicating the TXOP duration 425-b (such as, where an ending boundary of the TXOP duration 425-b is aligned in time with the ending boundary of the TXOP for the OBSS transmission 410-b).

In some examples, initial frame exchanges may be limited (such as, based on allowed MPDU or PPDU types, modulation and coding schemes (MCSs), or NSSs of the initiating frames 415 and response frames 420). Such constraints may be the same as or associated with enhanced multi-link single radio (EMLSR) constraints. The initiating frame 415 may be a multi-user (MU) request to send (RTS) frame or buffer status report poll (BSRP) in a non-high-throughput (HT) PPDU (with additional constraints such as, at up to 24 Mbps and 1 SS). The response frame 420 may be a clear to send (CTS) or buffer status report (BSR) message (such as, in 1 SS). In some examples, the initiating frame 415 may be a RTS and the response frame may be a CTS. In some examples, the initiating frame 415 may be a request for trigger frame. For instance, an initiating frame 415 from a non-AP may be a request-to-trigger (RTX), and a response frame 420 from the AP 102 may be a trigger frame such as a multi user request to send (MU-RTS) or basic Trigger frame. In some examples, the initiating frame 415 from a non-AP may be an RTS, but the response frame 420 from the AP 102 may be an enhanced CTS (e-CTS) (such as, a CTS frame with a truncated duration). In some examples, the AUX radio PD may support a PPDU type, such as an ultra-high reliability (UHR) PPDU with UHR preamble, such as a legacy signal (L-SIG), legacy short training field (L-STF), legacy long training field (L-LTF), and an additional field). The duration of an allowed TXOP may be carried in the duration or identifier field of such initiating frames 415 or response frames 420, or both. The initiating frame 415 or the response frame 420 may carry information related to the priority of a current or subsequent frame. The initiating frame 415 or the response frame 420, or both, may carry information related to a transmit power or target RSSI.

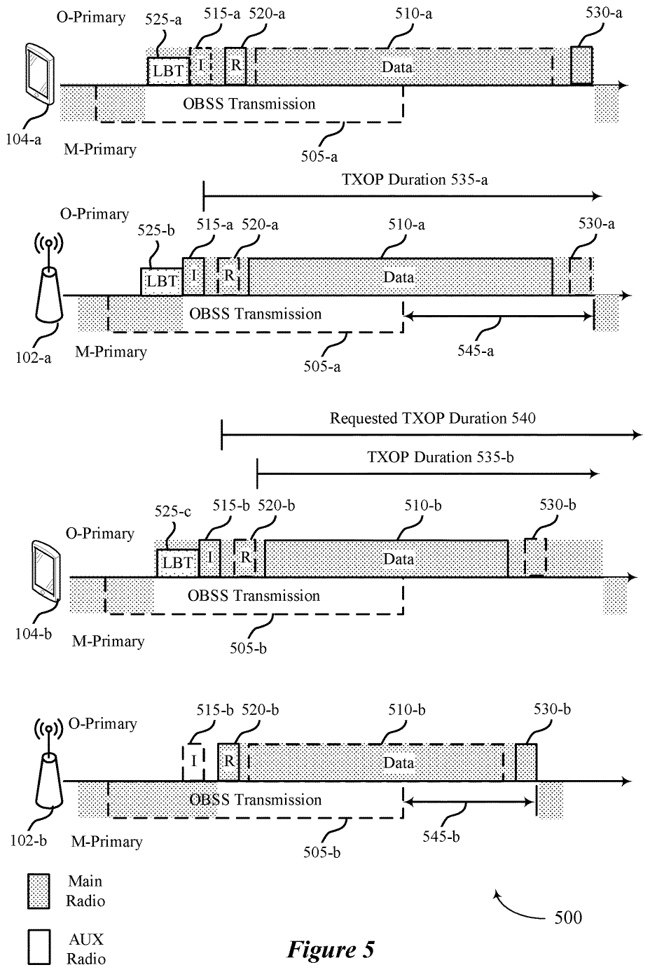

In some examples, an AP 102 may not have access to information regarding a remainder of a TXOP for an OBSS transmission 410. Techniques to align TXOP boundaries in such cases are described with reference to FIG. 5.

FIG. 5 illustrates an example of a timeline 500 that supports multi-primary channel access. The timeline 500 may implement or be implemented to realize or facilitate aspects of the WLAN 100, the channel access scheme 200, or the timelines 300 and 400. For example, the communication timeline 500 illustrates communication between the AP 102-a, AP 102-b, the STA 104-a, and the STA 104-b, and examples of APs 102 and STAs 104 are additionally illustrated by and described with reference to FIG. 1. The AP 102-a, the AP 102-b, the STA 104-a, and the STA 104-b, may align TXOPs across one or more primary channels (such as, the M-Primary channel and the O-Primary channel) by performing an initial frame exchange.

In some examples, an OBSS transmission 505 may occupy the M-Primary channel, but the AP 102 may be unable to perform PD to detect the OBSS duration of the OBSS transmission 505. Additionally, or alternatively, an OBSS device (such as another STA 104) may continue to extend a transmission network allocation vector (TXNAV). The TXNAV may be defined by a parameter value stored by the transmitting device, which indicates how much time the transmitter rightfully has to occupy the medium. The TXNAV may be initially set to a value carried in a duration or identifier field of a MAC header of a first frame successfully transmitted by the STA 104. The value may decrement thereafter. The STA 104 may increase the TXNAV value by successfully transmitting another frame with the increased duration. If the transmission fails (such as, no ACK message is received), then the STA 104 may relinquish the medium. The transmission that extends the TXNAV value and a corresponding ACK message may be completed before a previous TXNAV expires. In some examples, the AP 102 may make an estimate (such as, a conservative estimate) of the OBSS duration. Further, the AP 102 may use periods during which the AP 102 is receiving on the O-Primary channel to sense the medium on the M-Primary channel (such as, because when the AP 102 is transmitting on the O-primary channel, it may not be able to sense the M-Primary channel because of NSTR interference).

For example, the AP 102-a and the STA 104-a may communicate with each other. The OBSS transmission 505-a may occupy the M-Primary channel. The STA 104-a may switch a MR from the M-Primary channel to the O-Primary channel and perform an LBT procedure 525-a. The AP 102-a may use an AUX radio to perform the LBT procedure 525-b, and may then switch the MR to the O-Primary channel to transmit the initiating frame 515-a. The initiating frame 515-a may indicate the TXOP duration 535-a (such as, which may be based on a conservative estimate of a duration of the OBSS transmission 505-a). The STA 104-a may transmit the response frame 520-a (such as, using the MR). The AP 102-a may transmit data 510-a to the STA 104-a via the O-Primary channel, and the STA 104-a may transmit a feedback message 530-a (such as, an ACK message). Upon transmitting the feedback message 530-a, the STA 104-a may switch the MR back to the M-Primary channel.

Upon expiration of the OBSS transmission 505-a, the AP 102-a may perform a CCA (such as, an LBT procedure) during portions of the duration 545-a. CCA on the M-Primary channel may not be possible when the O-Primary channel is occupied by a transmission (such as due to NSTR interference). However, a CCA procedure during reception (such as, of the ACK message 530-a) may be possible when the M-Primary channel is idle (such as, the transmission on the O-Primary channel has ceased).

Similarly, the AP 102-b and the STA 104-b may communicate with each other, and may perform a non-AP initiated frame exchange. For example, an OBSS transmission 505-b may occupy the M-Primary channel. The STA 104-b may switch a main radio to the O-Primary channel, and may perform an LBT procedure 525-c. The STA 104-b may transmit an initiating frame 515-b indicating a requested TXOP duration 540. The AP 102-b may receive the initiating frame 515-b (such as, on the O-Primary channel using an AUX radio), and may transmit a response frame 520-b (such as, via the O-Primary channel using the MR), which may indicate the TXOP duration 535-b. The AP 102-b may receive the data 510-b (such as, from the STA 104-b) and may transmit a feedback message 530-b (such as, an ACK message) to the STA 104-b). During a portion of the unavailability duration 545-b, the AP 102-b may perform sensing (such as, during reception of the data 510-b). For example, the AUX radio may continue to monitor the M-Primary channel. The AP 102-b may indicate to the MR to stop accepting requests on the O-Primary radio. Any subsequent initiating frames 515 on the O-Primary channel may be responded to with an indicated TXOP equal to 0. During the duration 545-b, even though the AUX radio may detect that the M-Primary channel is available, and current PPDU(s) may be flushed.

FIG. 6 illustrates an example of a timeline 600 that supports multi-primary channel access. The timeline 600 may implement or be implemented to realize or facilitate aspects of the WLAN 100, the channel access scheme 200, or the timelines 300 through 500. For example, the communication timeline 600 illustrates communication between the AP 102-a, the STA 104-a, and the STA 104-b, and examples of APs 102 and STAs 104 are additionally illustrated by and described with reference to FIG. 1. The AP 102-a, the STA 104-a, and the STA 104-b, may support narrow band devices in a wideband BSS. The AP 102-a, the STA 104-a, and the STA 104-b may each support one MR and one AUX radio, supported by an O-Primary channel and an M-Primary channel.

The AP 102-a may perform an LBT procedure 625-a (such as, using an AUX radio) for the O-Primary channel), and an LBT procedure 625-b (such as, using an MR) for the M-Primary channel. The AP 102-a may transmit an initiating frame 610. In some examples, the AP 102-a may address the initiating frame 610-b to the STA 104-b (such as, or the STA 104-b may receive the initiating frame 610-b via an MR on the M-Primary without need of an address), and may address the initiating frame 610-a to the STA 104-a. The STA 104-b may receive the initiating frame 610-b, and may transmit a response frame 615-b (such as, via the M-Primary channel using an MR). The STA 104-a may switch the main radio from the M-Primary channel to the O-Primary channel (such as, upon receiving the initiating frame 610-a on the O-Primary channel) and may transmit the response frame 615-a (such as, via the O-Primary channel via the MR). The AP 102-a may send transmission 605 to the STA 104-b and the STA 104-b (such as, may transmit a downlink MU PPDU to both the STA 104-a and the STA 104-b via a set of resource units (RUs) for the STA 104-a and another set of RUs for the STA 104-b. The STA 104-a may transmit a feedback message (such as, ACK 620-a), and the STA 104-b may transmit the ACK 620-b. The AP 102-a may receive the ACK 620-a and the ACK 620-b via the O-Primary channel and the M-Primary channel, respectively, using the MR. In some examples, the AP 102-a may continue to use the AUX radio for the O-Primary channel after receiving the Ack 620-a using the MR.

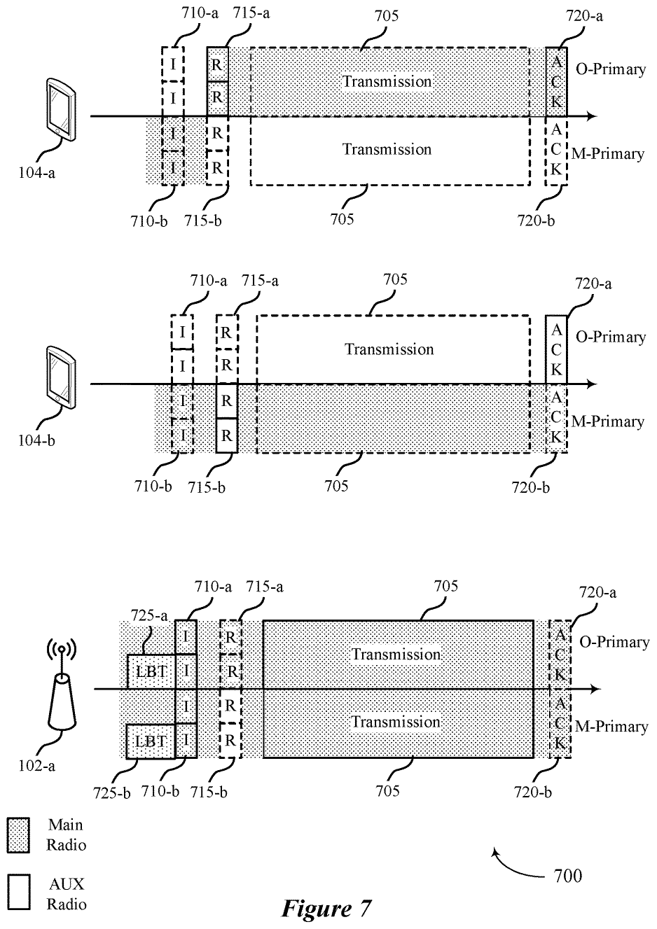

APs 102 and STAs 104 may perform similar procedures in cases when the AP 102-a only supports one or more MRs (such as, but no AUX radio), as described in greater detail with reference to FIG. 7.

FIG. 7 illustrates an example of a timeline 700 that supports multi-primary channel access. The timeline 700 may implement or be implemented to realize or facilitate aspects of the WLAN 100, the channel access scheme 200, or the timelines 300-600. For example, the communication timeline 700 illustrates communication between the AP 102-a, the STA 104-a, and the STA 104-b, and examples of APs 102 and STAs 104 are additionally illustrated by and described with reference to FIG. 1. The AP 102-a, and the STA 104-a, and the STA 104-b may support narrow band devices in a wideband BSS. The AP 102-a may support two MRs, and the STA 104-a, and the STA 104-b may each support one MR and one AUX radio.

The AP 102-a may perform an LBT procedure 725-a (such as, using one MR) for the O-Primary channel), and an LBT procedure 725-b (such as, using another MR) for the M-Primary channel. The AP 102-a may transmit an initiating frame 710. In some examples, the AP 102-a may address the initiating frame 710-b to the STA 104-b (such as, or the STA 104-b may receive the initiating frame 710-b via an MR on the M-Primary without need of an address), and may address the initiating frame 710-a to the STA 104-a. The STA 104-b may receive the initiating frame 710-b, and may transmit a response frame 715-b (such as, via the M-Primary channel using an MR). The STA 104-a may switch the main radio from the M-Primary channel to the O-Primary channel (such as, upon receiving the initiating frame 710-a on the O-Primary channel) and may transmit the response frame 715-a (such as, via the O-Primary channel via the MR). The AP 102-a may send transmission 705 to the STA 104-b and the STA 104-b (such as, may transmit a downlink MU PPDU to both the STA 104-a and the STA 104-b via a set of resource units (RUs) for the STA 104-a and another set of RUs for the STA 104-b. The STA 104-a may receive the transmission 705, and may transmit a feedback message (such as, ACK 720-a). The STA 104-b may also receive the transmission 705, and may transmit the ACK 720-b. The AP 102-a may receive the ACK 720-a and the ACK 720-b via the O-Primary channel and the M-Primary channel, respectively, using the MR.

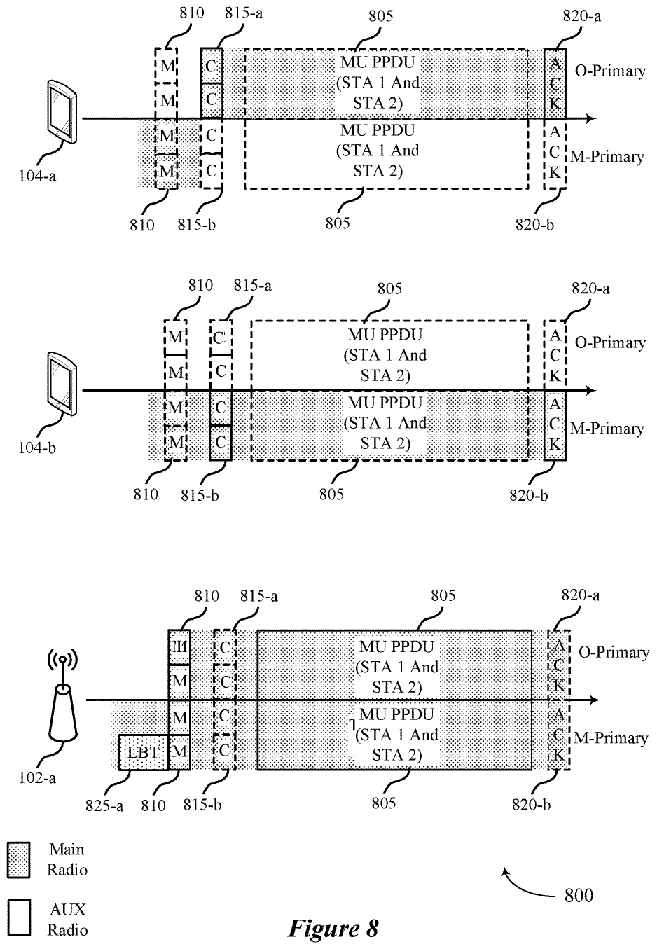

FIG. 8 illustrates an example of a timeline 800 that supports multi-primary channel access. The timeline 800 may implement or be implemented to realize or facilitate aspects of the WLAN 100, the channel access scheme 200, or the timelines 300-700. For example, the communication timeline 800 illustrates communication between the AP 102-a, the STA 104-a, and the STA 104-b, and examples of APs 102 and STAs 104 are additionally illustrated by and described with reference to FIG. 1. The AP 102-a, the STA 104-a, and the STA 104-b, may support narrow band devices in a wideband BSS. The AP 102-a may support a single MR (such as, but no second radio), the STA 104-a, and the STA 104-b may each support one MR and one AUX radio. The STA 104-a and the STA 104-b may each be narrowband STAs, with a MR parked on the M-Primary channel and an AUX radio parked on the O-Primary channel. Initiating frames 810 may be MU-RTSs sent in a non-HT duplicate PPDU format on all subchannels (such as, including O-Primary channels and M-Primary channels). One or more STAs 104 (such as, the STA 104-a) may be able to receive MU-RTS on either the O-Primary channel or the M-Primary channel.

The AP 102-a may perform an LBT procedure 825-a (such as, using the MR) for the O-Primary channel). The AP 102-a may retune the MR to cover the M-Primary channel and the O-Primary channel. The AP 102-a may transmit an initiating frame 810, which may be an MU-RTS. The MU-RTS may be addressed to both the STA 104-a and the STA 104-b or may be transmitted to a broadcast address. The M-Primary channel may be assigned to the STA 104-b and the O-Primary channel may be assigned to the STA 104-a (such as, as indicated via the MU-RTS initiating frame 810). The STA 104-b may receive the initiating frame 810, and may transmit a response frame 815-b (such as, via the M-Primary channel using an MR). The STA 104-a may switch the main radio from the M-Primary channel to the O-Primary channel (such as, upon receiving the initiating frame 810 on the O-Primary channel) and may transmit the response frame 815-a (such as, via the O-Primary channel via the MR). The AP 102-a may send transmission 805 to the STA 104-b and the STA 104-b (such as, may transmit a single PPDU spanning the entire bandwidth including both the M-Primary channel and the O-Primary channel) via the MR to both the STA 104-a and the STA 104-b (such as, via a set of resource units (RUs) for the STA 104-a and another set of RUs for the STA 104-b). The STA 104-a may transmit a feedback message (such as, ACK 820-a), and the STA 104-b may transmit the ACK 820-b. The AP 102-a may receive the ACK 820-a and the ACK 820-b via the O-Primary channel and the M-Primary channel, respectively, using the MR. In some examples, the AP 102-a may continue to use the AUX radio for the O-Primary channel after receiving the Ack 820-a using the MR.

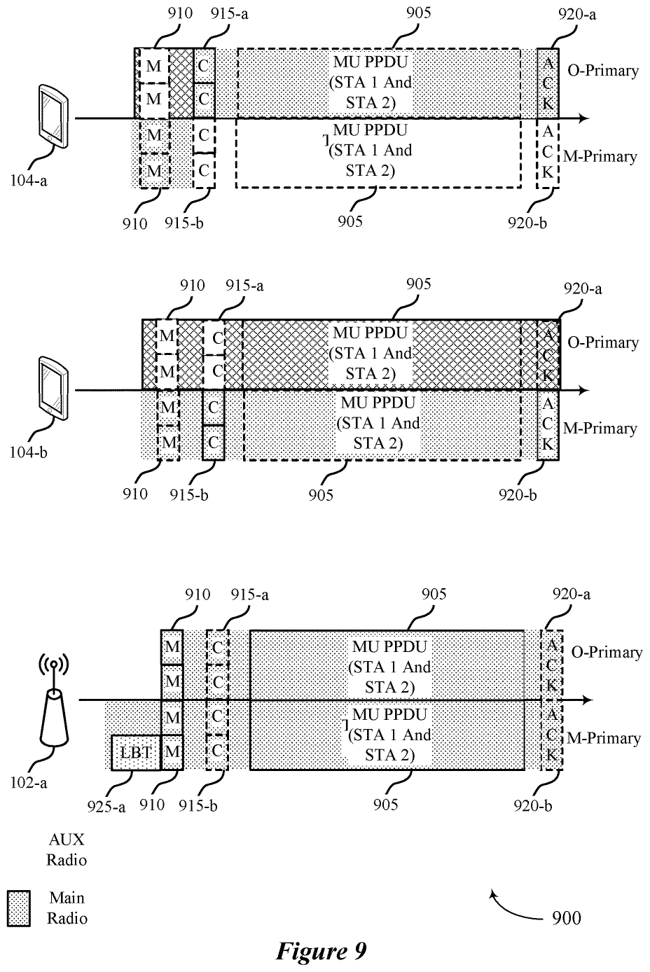

FIG. 9 illustrates an example of a timeline 900 that supports multi-primary channel access. The timeline 900 may implement or be implemented to realize or facilitate aspects of the WLAN 100, the channel access scheme 200, or the timelines 300-800. For example, the communication timeline 900 illustrates communication between the AP 102-a, the STA 104-a, and the STA 104-b, and examples of APs 102 and STAs 104 are additionally illustrated by and described with reference to FIG. 1. The AP 102-a, the STA 104-a, and the STA 104-b, may support narrow band devices in a wideband BSS. The AP 102-a may support a single MR (such as, but no second radio), the STA 104-a, and the STA 104-b may each support one MR (such as, the STAs 104 may have a MR and an AUX radio). The STA 104-a and the STA 104-b may each be narrowband STAs, with a MR parked on the M-Primary channel. Initiating frames 910 may be MU-RTSs sent in a non-HT duplicate PPDU format on all subchannels (such as, including O-Primary channels and M-Primary channels). One or more STAs 104 (such as, the STA 104-a) may be able to receive MU-RTS on either the O-Primary channel or the M-Primary channel. Techniques described with reference to FIG. 9 may be implemented in cases when the M-Primary channel is available for the AP 102-a.

The AP 102-a may perform an LBT procedure 925-a (such as, using the MR) for the O-Primary channel). The AP 102-a may retune the MR to cover the M-Primary channel and the O-Primary channel. The AP 102-a may transmit an initiating frame 910, which may be an MU-RTS. The MR-RTS may be addressed to both the STA 104-a and the STA 104-b or may be transmitted to a broadcast address. In some examples, the MU-RTS may include an indication that the STA 104-a switch the operations from the M-Primary channel to the O-Primary channel. The M-Primary channel may be assigned to the STA 104-b and the O-Primary channel may be assigned to the STA 104-a (such as, as indicated via the MU-RTS initiating frame 910). The STA 104-b may receive the initiating frame 910, and may transmit a response frame 915-b (such as, via the M-Primary channel using an MR). The STA 104-a may switch the main radio from the M-Primary channel to the O-Primary channel (such as, upon receiving the initiating frame 910 on the O-Primary channel) and may transmit the response frame 915-a (such as, via the O-Primary channel via the MR). The AP 102-a may send transmission 905 to the STA 104-b and the STA 104-b (such as, may transmit a single PPDU spanning the entire bandwidth including both the M-Primary channel and the O-Primary channel) via the MR to both the STA 104-a and the STA 104-b (such as, via a set of resource units (RUs) for the STA 104-a and another set of RUs for the STA 104-b). In some examples, the AP 102-a may transmit a single MU PPDU to the STA 104-a and STA 104-b. The STA 104-a may transmit a feedback message (such as, ACK 920-a), and the STA 104-b may transmit the ACK 920-b. The AP 102-a may receive the ACK 920-a and the ACK 920-b via the O-Primary channel and the M-Primary channel, respectively, using the MR.

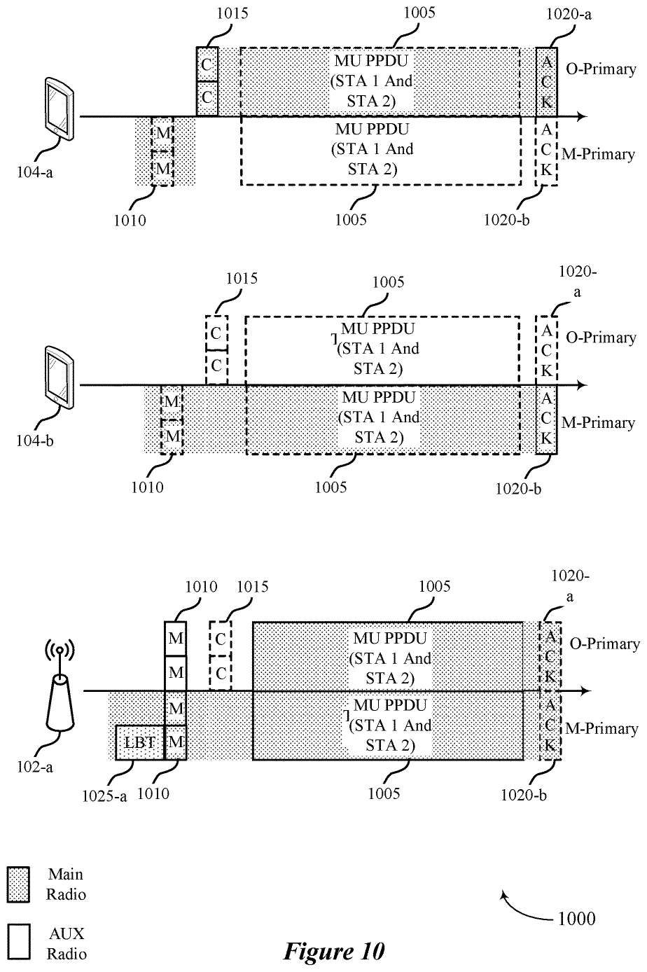

FIG. 10 illustrates an example of a timeline 1000 that supports multi-primary channel access. The timeline 1000 may implement or be implemented to realize or facilitate aspects of the WLAN 100, the channel access scheme 200, or the timelines 300-900. For example, the communication timeline 1000 illustrates communication between the AP 102-a, the STA 104-a, and the STA 104-b, and examples of APs 102 and STAs 104 are additionally illustrated by and described with reference to FIG. 1. The AP 102-a, the STA 104-a, and the STA 104-b, may support narrow band devices in a wideband BSS. The AP 102-a may support a single MR (such as, but no second radio), the STA 104-a, and the STA 104-b may each support one MR. The STA 104-a and the STA 104-b may each be narrowband STAs, with a MR parked on the M-Primary channel. Initiating frames 1010 may be MU-RTSs sent in a non-HT duplicate PPDU format on all subchannels (such as, including O-Primary channels and M-Primary channels). One or more STAs 104 (such as, the STA 104-a) may be able to receive MU-RTS on either the O-Primary channel or the M-Primary channel.

The AP 102-a may perform an LBT procedure 1025-a (such as, using the MR) for the O-Primary channel). The AP 102-a may transmit an initiating frame 1010, which may be an MU-RTS. The MU-RTS may be addressed to both the STA 104-a and the STA 104-b, or may be transmitted to a broadcast address or may be addressed only to STA 104-a. In some examples, the MU-RTS may include an indication that the STA 104-a switch the operations from the M-Primary channel to the O-Primary channel. The AP 102-a may transmit the initiating frame 1010 on the M-Primary channel, or on both the M-Primary channel and the O-Primary channel. The O-Primary channel may be assigned to the STA 104-a (such as, as indicated via the MU-RTS initiating frame 1010). The STA 104-b may receive the initiating frame 1010 using the main radio. The STA 104-b may receive the MU-RTS frame on the M-Primary channel (such as, or may receive the MU-RTS frame via the O-Primary channel if the STA 104-b also supports an AUX radio). The STA 104-a may switch the main radio from the M-Primary channel to the O-Primary channel (such as, upon receiving the initiating frame 1010 on the O-Primary channel) and may transmit the response frame 1015 (such as, via the O-Primary channel using the MR). The AP 102-a may send transmission 1005 to the STA 104-b and the STA 104-b (such as, may transmit a single PPDU spanning the entire bandwidth including both the M-Primary channel and the O-Primary channel) via the MR to both the STA 104-a and the STA 104-b (such as, via a set of resource units (RUs) for the STA 104-a and another set of RUs for the STA 104-b). In some examples, the AP 102-a may transmit a single MU PPDU to the STA 104-a and STA 104-b. The STA 104-a may transmit a feedback message (such as, ACK 1020-a), and the STA 104-b may transmit the ACK 1020-b. The AP 102-a may receive the ACK 1020-a and the ACK 1020-b via the O-Primary channel and the M-Primary channel, respectively, using the MR.

Techniques described with reference to FIGS. 6-10 may be implemented by various types of devices, or may be constrained to transmission types. For example, a first STA 104-b may be served on the M-Primary channel, and may be an HE+ device (such as a HE STA, EHT STA or a UHR STA), or a pre-HE device (such as a VHT STA or HT STA, in which case a gap in a timeline may be supported). A second STA 104-a may be served on the O-Primary channel, and may be, for example, an UHR STA. Downlink PPDUs may be MU PPDUs, or frequency domain Aggregate PPDUs (A-PPDUs). For example, HE, EHT, or UHR MU PPDUs may be supported by STA 104-b if STA 104-b is an HE, EHT, or UHR STA. UHR STAs may operate as HE STAs as well as EHT STAs. Frequency domain A-PPDUs may be supported if the STA 104-b is a non-HE STA (such as, a VHT or HT STA).

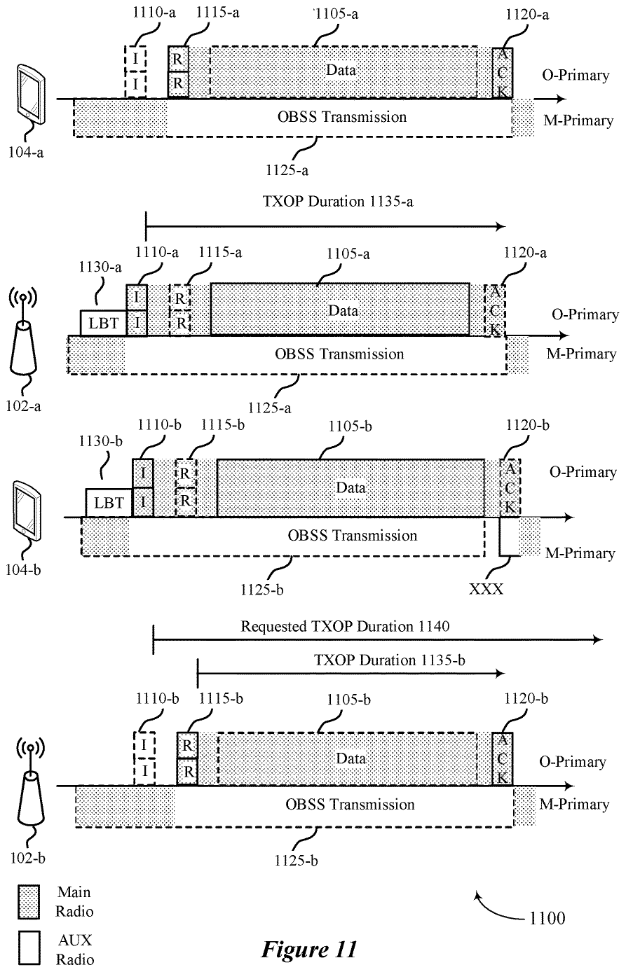

FIG. 11 illustrates an example of a timeline 1100 that supports multi-primary channel access. The timeline 1100 may implement or be implemented to realize or facilitate aspects of the WLAN 100, the channel access scheme 200, or the timelines 300-1000. For example, the communication timeline 1100 illustrates communication between the AP 102-a, and the STA 104-a, and the AP 102-b and the STA 104-b, and examples of APs 102 and STAs 104 are additionally illustrated by and described with reference to FIG. 1. The AP 102-a, the AP 102-b, the STA 104-a, and the STA 104-b, may support communications via an O-Primary channel and an M-Primary channel. The AP 102-a, the AP 102-b, the STA 104-a, and the STA 104-b, may each support a MR and an AUX radio, and may perform initial frame exchanges (such as, as described in any of FIGS. 6-10).

The AP 102-a and the STA 104-a may communicate via the O-Primary channel and the M-Primary channel. An OBSS transmission 1125-a may occupy the M-Primary channel. AP 102-a may perform an LBT procedure 1130-a for the O-Primary channel (such as, using an AUX radio while the MR is parked on the M-Primary channel). The AP 102-a may switch the MR to the O-Primary channel, and may transmit an initiating frame 1110-a (such as, to the STA 104-a). The STA 104-a may receive the initiating frame 1110-a on the O-Primary channel (such as, using an AUX radio while the MR is parked on the M-Primary channel). The initiating frame 1110-a may include an indication of a TXOP duration 1135-a (such as, aligning a TXOP ending boundary for the data 1105-a with the OBSS transmission 1125-a). Having received the initiating frame 1110-a, the STA 104-a may switch the MR to the O-Primary channel, and may transmit a response frame 1115-a. The AP 102-a may align the TXOP for the data 1105-a with the OBSS transmission 1125-a. The AP 102-a may transmit the data to the STA 104-a on the O-Primary channel, and may receive the feedback message 1120-a (such as, an ACK message) from the STA 104-a on the O-Primary channel. The AP 102-a may switch the MR back to the M-Primary channel (such as, upon receiving the feedback message 1120-a).

Similarly, the OBSS transmission 1125-b may occupy the M-Primary channel for the AP 102-b and the STA 104-b. For a non-AP initiated frame exchange, the STA 104-b may perform an LBT procedure 1130-b (such as, using an AUX radio while the MR is parked on the M-Primary channel). The STA 104-b may switch the MR to the O-Primary channel and transmit the initiating frame 1110-b using the MR. The AP 102-b may receive the initiating frame 1110-b via the O-Primary channel (such as, using the AUX radio), and may switch the MR to the O-Primary channel to transmit the response frame 1115-b. In some examples, the initiating frame 1110-b may indicate a requested TXOP 1140 (such as, which may extend beyond the ending boundary of a TXOP for the OBSS transmission 1125-b). The response frame 1115-b may include an indication of a TXOP duration 1135-b (such as, aligning the TXOP for the data 1105-b with a TXOP for the OBSS transmission 1125-b). The STA 104-b may transmit data 1105-b to the AP 102-b, and the AP 102-b may transmit the feedback message 1120-b. In some examples, the AP 102-b may switch the MR back to the M-Primary channel (such as, after transmitting the feedback message 1120-b).

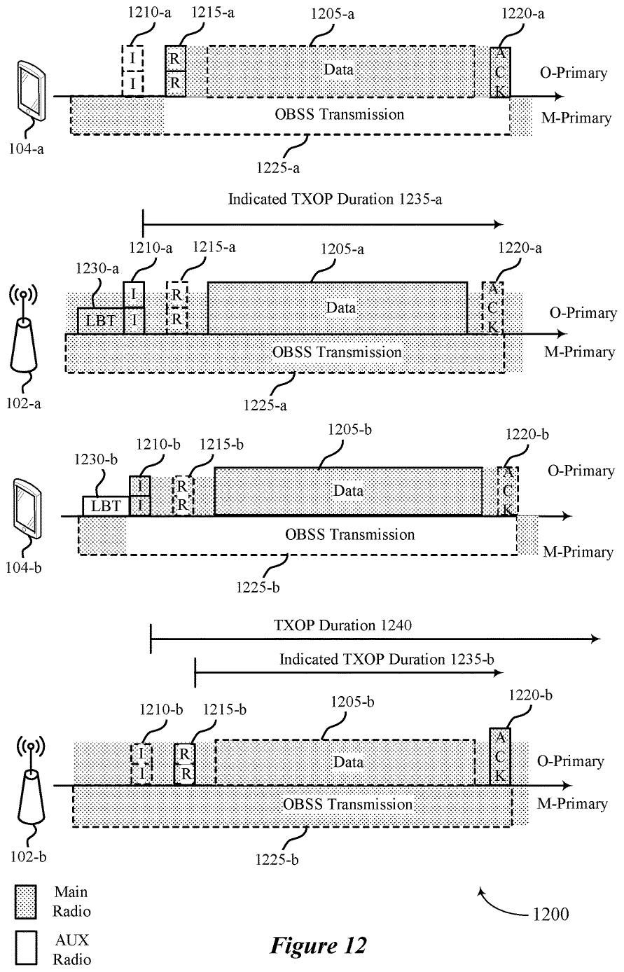

FIG. 12 illustrates an example of a timeline 1200 that supports multi-primary channel access. The timeline 1200 may implement or be implemented to realize or facilitate aspects of the WLAN 100, the channel access scheme 200, or the timelines 300-1100. For example, the communication timeline 1200 illustrates communication between the AP 102-a and the STA 104-a, and the AP 102-b and the STA 104-b, and examples of APs 102 and STAs 104 are additionally illustrated by and described with reference to FIG. 1. The AP 102-a, the AP 102-b, the STA 104-a, and the STA 104-b, may support communications via an O-Primary channel and an M-Primary channel. The AP 102-a, and the AP 102-b may support two MRs, and the STA 104-a and the STA 104-b may each support a MR and an AUX radio, and may perform initial frame exchanges (such as, as described in any of FIGS. 6-10).

The AP 102-a and the STA 104-a may communicate via the O-Primary channel and the M-Primary channel. An OBSS transmission 1225-a may occupy the M-Primary channel. AP 102-a may perform an LBT procedure 1230-a for the O-Primary channel (such as, using a first MR). The AP 102-a may transmit an initiating frame 1210-a (such as, to the STA 104-a). The STA 104-a may receive the initiating frame 1210-a on the O-Primary channel (such as, using an AUX radio while the MR is parked on the M-Primary channel). The initiating frame 1210-a may include an indication of a TXOP duration 1235-a (such as, aligning a TXOP ending boundary for the data 1205-a with the OBSS transmission 1225-a). Having received the initiating frame 1210-a, the STA 104-a may switch the MR to the O-Primary channel, and may transmit a response frame 1215-a. The AP 102-a may align the TXOP for the data 1205-a with the OBSS transmission 1225-a. The AP 102-a may transmit the data to the STA 104-a on the O-Primary channel, and may receive the feedback message 1220-a (such as, an ACK message) from the STA 104-a on the O-Primary channel.

Similarly, the OBSS transmission 1225-b may occupy the M-Primary channel for the AP 102-b and the STA 104-b. For a non-AP initiated frame exchange, the STA 104-b may perform an LBT procedure 1230-b (such as, using the MR). The AP 102-b may receive the initiating frame 1210-b via the O-Primary channel (such as, using the MR). In some examples, the initiating frame 1210-b may indicate a requested TXOP 1240 (such as, which may extend beyond the ending boundary of a TXOP for the OBSS transmission 1225-b). The response frame 1215-b may include an indication of a TXOP duration 1235-b (such as, aligning the TXOP for the data 1205-b with a TXOP for the OBSS transmission 1225-b). The STA 104-b may transmit data 1205-b to the AP 102-b, and the AP 102-b may transmit the feedback message 1220-b.

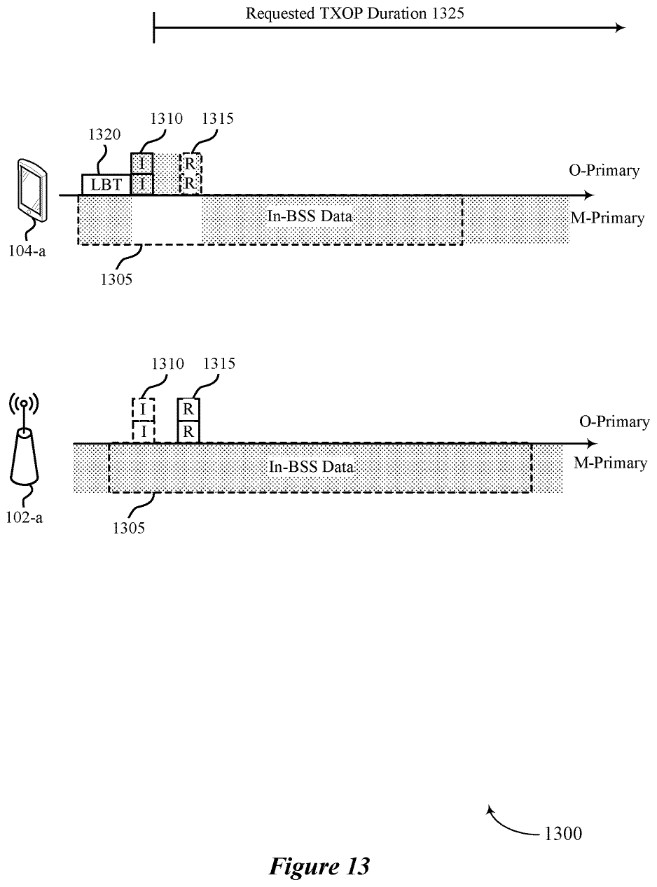

FIG. 13 illustrates an example of a timeline 1300 that supports multi-primary channel access. The timeline 1300 may implement or be implemented to realize or facilitate aspects of the WLAN 100, the channel access scheme 200, or the timelines 300-1200. For example, the communication timeline 1300 illustrates communication between the AP 102-a and the STA 104-a, and examples of APs 102 and STAs 104 are additionally illustrated by and described with reference to FIG. 1. The AP 102-a, and the STA 104-a, may support communications via an O-Primary channel and an M-Primary channel. The AP 102-a, and the AP 102-b may each support a MR and an AUX radio, and may perform initial frame exchanges (such as, as described in any of FIGS. 6-10). In some examples, the AP 102-a and the STA 104-a may support simultaneous reception, (such as, in a simultaneous transmission case, NSTR interference may disrupt a CCA procedure). The AP 102-a may be equipped with an AUX radio that supports transmission and reception (such as, if the AP 102-a is equipped with an AUX radio for reception, or PD, it will not transmit the response frame 1315). IN-BSS data 1305 (such as, transmitted by another STA 104) may occupy the M-Primary channel.

In an example of non-AP initiated frame exchange, the STA 104-a may perform an LBT procedure 1320 on the O-Primary channel (such as, using an AUX radio while the MR is parked on the M-Primary channel). Based on a successful LBT procedure 1320, the STA 104-a may switch the MR to the O-Primary channel, and may transmit the initiating frame 1310. The initiating frame 1310 may include an indication of a requested TXOP duration 1325. The AP 102-a may receive the initiating frame 1310 on the O-Primary channel using the AUX radio, and may transmit the response frame 1315 on the O-Primary channel using the AUX radio. Transmission of the responsive frame 1315 using the AUX radio, while receiving the in-BSS data 1305, may result in NSTR interference on the M-Primary channel. However, such interference may be tolerable if a priority level of the O-Primary transmission is high. Such priority may be indicated in the initiating frame. For instance, the initiating frame 1310 may include an indication of a priority level of a pending transmission by the STA 104-a or requested from the AP 102-a. Additionally, or alternatively, the duration of the NSTR interference may be small (such as, and errors in reception of the in-BSS data 1305 may be recoverable or negligible).

The AP 102-a may determine whether the priority level indicated in the initiating frame 1310 satisfies a threshold (such as, is higher than a priority level of the in-BSS data 1305). If the priority level in the initiating frame 1310 does not satisfy the threshold, then the AP 102-a may indicate, in the response frame 1315, a TXOP duration of 0 (such as, TXOP=0), and the AP 102-a may continue to receive the in-BSS data 1305 on the M-Primary channel.

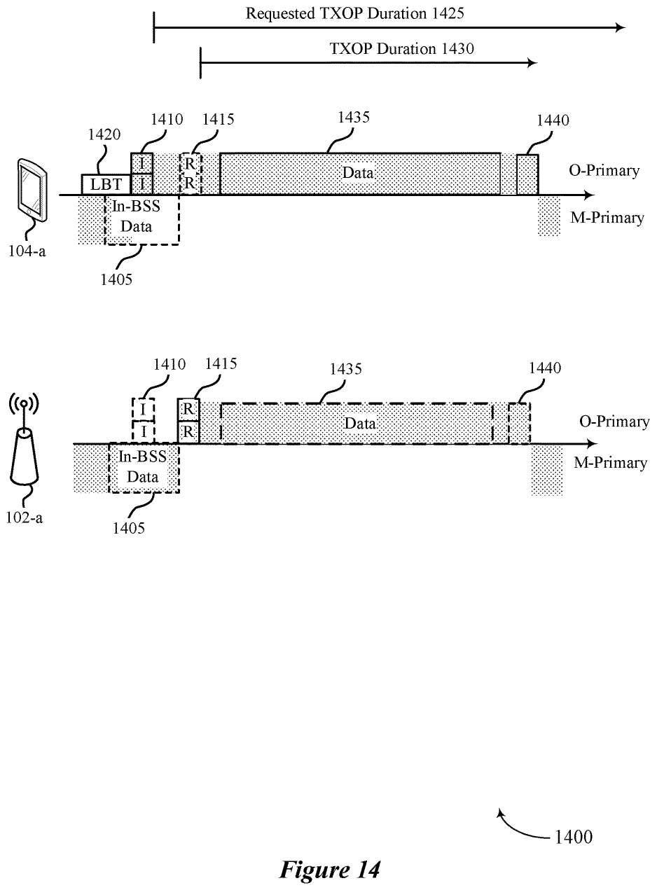

FIG. 14 illustrates an example of a timeline 1400 that supports multi-primary channel access. The timeline 1400 may implement or be implemented to realize or facilitate aspects of the WLAN 100, the channel access scheme 200, or the timelines 300-1300. For example, the communication timeline 1400 illustrates communication between the AP 102-a and the STA 104-a, and examples of APs 102 and STAs 104 are additionally illustrated by and described with reference to FIG. 1. The AP 102-a, and the STA 104-a, may support communications via an O-Primary channel and an M-Primary channel. The AP 102-a, and the AP 102-b may each support a MR and an AUX radio, and may perform initial frame exchanges (such as, as described in any of FIGS. 6-10). In some examples, the AP 102-a and the STA 104-a may support simultaneous reception, (such as, in a simultaneous transmission case, NSTR interference may disrupt a CCA procedure). The AP 102-a may be equipped with an AUX radio that supports transmission and reception (such as, if the AP 102-a is equipped with an AUX radio for reception, or PD, it will not transmit the response frame 1415). In-BSS data 1405 (such as, transmitted by another STA 104) may occupy the M-Primary channel.

In an example of non-AP initiated frame exchange, the STA 104-a may perform an LBT procedure 1420 on the O-Primary channel (such as, using an AUX radio while the MR is parked on the M-Primary channel). Based on a successful LBT procedure 1420, the STA 104-a may switch the MR to the O-Primary channel, and may transmit the initiating frame 1410. The initiating frame 1410 may include an indication of a requested TXOP duration 1425. The AP 102-a may receive the initiating frame 1410 on the O-Primary channel, and may transmit the response frame 1415 on the O-Primary channel using the MR radio. Transmission of the responsive frame 1415 using the AUX radio, while receiving the in-BSS data 1405, may result in NSTR interference on the M-Primary channel.

The AP 102-a on the O-Primary channel contains information related to the priority of the subsequent data transmission (such as, the data 1435), the AP 102-a may elect to drop the ongoing PPDU reception from an in-BSS STA (such as, the in-BSS data 1405), on the M-Primary channel. For example, the AP 102-a may determine whether the priority level indicated in the initiating frame 1410 satisfies a threshold (such as, is higher than a priority level of the in-BSS data 1405). If the priority level in the initiating frame 1410 does satisfy the threshold (such as, if the priority level of the data 1435 is higher than the priority level of the in-BSS data 1405), then the AP 102-a may indicate, in the response frame 1415, a TXOP duration 1430. In such examples, the AP 102-a may drop the in-BSS data 1405 (such as, may stop receiving the in-BSS data 1405), and may instead receive the data 1435 from the STA 104-a.

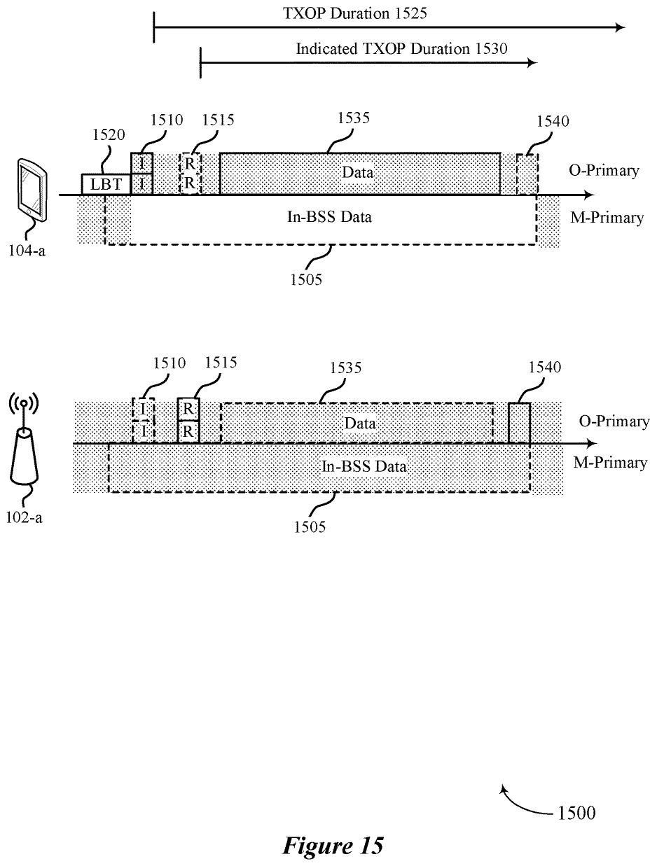

FIG. 15 illustrates an example of a timeline 1500 that supports multi-primary channel access. The timeline 1500 may implement or be implemented to realize or facilitate aspects of the WLAN 100, the channel access scheme 200, or the timelines 300-1400. For example, the communication timeline 1500 illustrates communication between the AP 102-a and the STA 104-a, and examples of APs 102 and STAs 104 are additionally illustrated by and described with reference to FIG. 1. The AP 102-a, and the STA 104-a, may support communications via an O-Primary channel and an M-Primary channel. The AP 102-a may support two MRs, and the STA 104-a may support a MR and an AUX radio, and may perform initial frame exchanges (such as, as described in any of FIGS. 6-10). In some examples, the AP 102-a and the STA 104-a may support simultaneous reception (such as, in a simultaneous transmission case, NSTR interference may disrupt a CCA procedure). In-BSS data 1505 (such as, transmitted by another STA 104) may occupy the M-Primary channel.

In an example of non-AP initiated frame exchange, the STA 104-a may perform an LBT procedure 1520 on the O-Primary channel (such as, using an AUX radio while the MR is parked on the M-Primary channel). Based on a successful LBT procedure 1520, the STA 104-a may switch the MR to the O-Primary channel, and may transmit the initiating frame 1510. The initiating frame 1510 may include an indication of a requested TXOP duration 1525. The AP 102-a may receive the initiating frame 1510 on the O-Primary channel (such as, using an MR), and may transmit the response frame 1515 on the O-Primary channel using the MR radio. Transmission of the responsive frame 1515 using the first MR, while receiving the in-BSS data 1505 with the second MR, may result in NSTR interference on the M-Primary channel. However, such interference may be tolerable if a priority level of the O-Primary transmission is high. Such priority may be indicated in the initiating frame. For instance, the initiating frame 1510 may include an indication of a priority level of a pending transmission by the STA 104-a or requested from the AP 102-a. Additionally, or alternatively, the duration of the NSTR interference may be small (such as, and errors in reception of the in-BSS data 1505 may be recoverable or negligible).

If the initiating frame on the O-Primary channel contains information related to the priority of the subsequent data transmission (such as, the data 1535), the AP 102-a may elect receive an ongoing PPDU from an in-BSS STA (such as, the in-BSS data 1505), on the M-Primary channel while receiving the data 1535, and may then transmit the feedback message 1540. For example, if the priority level in the initiating frame 1510 does satisfy the threshold, then the AP 102-a may indicate, in the response frame 1515, a TXOP duration 1530, aligning the TXOP for the data 1535 with the TXOP for the in-BSS data 1505.

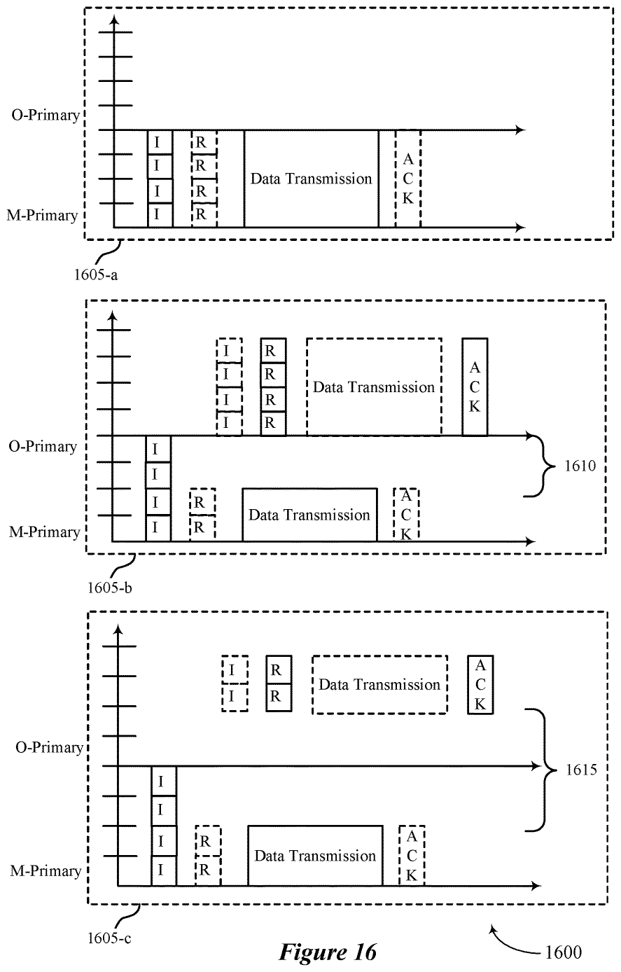

FIG. 16 illustrates a capability reporting scheme 1600 that supports multi-primary channel access. The capability reporting scheme 1600 may implement or be implemented to realize or facilitate aspects of the WLAN 100, the channel access scheme 200, or the timelines 300-1500. For example, the capability reporting scheme 1600 illustrates communication between an AP 102 and a STA 104, and examples of APs 102 and STAs 104 are additionally illustrated by and described with reference to FIG. 1. The AP 102 and the STA 104 may support communications via an O-Primary channel and an M-Primary channel.

In some examples, a device (such as, such as an AP 102 or a STA 104) may perform capability signaling (such as, transmit an indication of a capability announcement). The device may announce how many AUX radios it supports for multi-primary transmissions. In some examples, the device may announce a capability of the AUX radios (such as, AUX-Rx, AUX-RxTx, supported PPDY types, AUX PD, etc.). The device may announce a minimum frequency separation for STR operations. When the AP announces such information, a non-AP may decide whether it can transmit a PPDU to the AP on one primary channel when the AP is receiving on the other primary channel. Additionally, or alternatively, if a frequency separation is sufficient for the non-AP STA, the same non-AP STA may transmit control feedback (such as, live feedback) to the AP.

For instance, an AP 102 may report capability 1605-a, with a frequency separation between the O-Primary channel and the M-Primary channel of 0. Non-AP STAs may not transmit on the O-Primary according to capability 1605-a. The AP 102 may report a capability 1605-b, which may indicate a support frequency separation 1610 (such as, 40 MHz) between the O-Primary channel and the M-Primary channel. Under capability 1605-b, a non-AP STA may transmit on the O-Primary channel. In some examples, the AP 102 may report a capability 1605-c, indicating a separation 1615 (such as, of 80 MHz) separation between the O-Primary channel and the M-Primary channel (such as, a lower edge of the O-Primary channel to the upper edge of the M-Primary channel is 80 MHz). Such a frequency separation 1615 may be sufficient to support both AP and non-AP STA to support STR. The STA may transmit live feedback on the O-Primary channel in such examples.

Thus, if an AP 102 transmits an initiating frame with the intention of transmitting on the 80 MHz channel, but a STA 104 responds only on a primary 40 MHz channel, then the AP 102 a support transmissions on the 40 MHz channel where it receives a response frame from the STA 104.

Devices may announce other capabilities as well. For example, STA 104 (such as, or an AP 102) may announce capabilities such as whether the device is an STR or NSTR device between O-Primary channels and M-Primary channels, a threshold number of simultaneous transmission and reception it can perform over the O-Primary channel, the M-Primary channel, or both, a threshold number of simultaneous receptions over the O-Primary channel and the M-Primary channel, or any combination thereof. The announcements may be performed during discovery procedures (such as, for an AP 102), or a setup procedure (such as, for an AP 102 or a STA 104). If the STA 104 is an STR device on the O-Primary channel or the M-Primary channel, an MR architecture may be associated with or the same as an STR MLO. The STA 104 may announce a threshold number of simultaneous transmission reception operations as 1 (such as, or 1, based on encoding), may announce a threshold number of simultaneous reception procedures as 2 (such as, or 1, based on encoding), or a combination thereof. An AP 102 may announce whether it can transmit or receive on two primary channels at any time. Non-AP STAs with NSTR capability may impose some transmission constrains across the M-Primary channel and the O-Primary channel. If non-AP STAs are NSTR, the AP 102 perform end-alignment PPDU transmission to a same STA 104 similar to NSTR MLO operations. An AUX radio architecture may not support STR structure (such as, because STR relies on simultaneous transmission and reception capabilities). In such examples, a STA 104 may announce a threshold number of simultaneous transmissions and receptions as 1 (such as, or 0, based on the encoding).

If a STA 104 supports NSTR on the O-Primary channel and the M-Primary channel, the STA 104 may announce a threshold number of simultaneous transmissions and receptions as 1 (such as, or 0). For the MR, the STA 104 may announce a threshold number of simultaneous receptions as 2 (such as, or 1). For the AUX radio, the STA 104 may announce a threshold number of simultaneous receptions as 1 (such as, or 0).

Non-AP STAs 104 may support one or more behaviors (such as, according to one or more rules). A UHR non-AP STA 104 may use the AP capabilities as a factor in performing association with the AP (such as, if capabilities of a non-AP STA 104 are superior to the capabilities of the AP 102, the non-AP STA 104 may elect not to associate with that AP 102). Based on the AP capabilities, a non-AP STA 104 may follow one or more additional rules. For instance, before initiating a frame exchange, the STA 104 may monitor the O-Primary channel and the M-Primary channel. The AP 102 may be in reception on one primary channel from another in-BSS STA 104. If the threshold number of simultaneous receptions for the AP 102 is 2, then the STA 104 may be allowed to initiate a frame exchange on the other primary channel. If the threshold number of simultaneous receptions is 1, then the STA 104 may not be allowed to initiate frame exchange on the other primary channel. If one primary channel is occupied by an OBSS, then the STA may initiate a frame exchange with the AP 102. If the AP 102 is transmitting on one primary channel and the AP is an STR deice, then the STA 104 may be allowed to initiate a frame exchange on the other primary channel. If the AP is transmitting on one primary channel and the AP 102 is an NSTR device, then the STA 104 may not be allowed to initiate a frame exchange on the other primary channel.

In some examples, a STA 104 may announce whether it relies on (such as, requires) the initial frame exchange. Such announcements may be performed during a discovery procedure (such as, for an AP 102), or during a setup procedure (such as, for an AP 102 or a STA 104). Such announcements may be performed per primary channel (such as, may not be required for an M-Primary channel, but may be required for an O-Primary channel). If an initial frame exchange is performed using an RTS and CTS, an AP 102 may not announce the requirement during setup, but may enable one or more features to require an RTS/CTS before each frame exchange. In some examples, the AP 102 may enable the features on the M-Primary channel and the O-Primary channel based on device capabilities).

If the initial frame exchange is not required, then the AP 102 may be unable to indicate the remaining TXOP duration on the M-Primary channel or the non-AP initiated frame exchanges. In such examples, the non-AP initiated frame exchanges may continue beyond OBSS transmissions on the M-Primary channel. For a MR, the AP 102 transmissions on the M-Primary channel may interfere with the non-AP transmissions on the O-Primary channel. The AP 102 may elect to decrease transmissions on the M-Primary channel while reception on the O-Primary channel is ongoing. For the AUX radio, the AP 102 may become unavailable on the M-Primary channel until reception on the O-Primary channel ends.

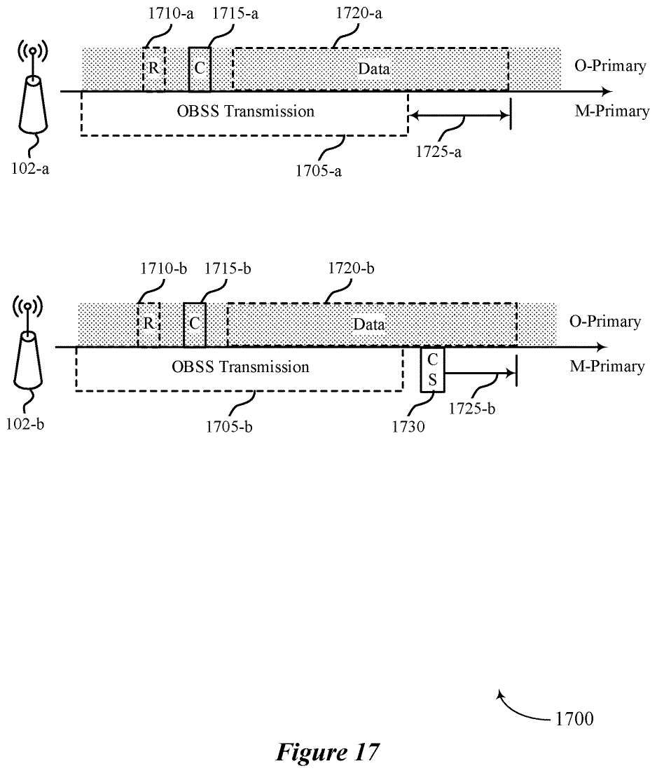

FIG. 17 illustrates an example of a timeline 1700 that supports multi-primary channel access. The timeline 1700 may implement or be implemented to realize or facilitate aspects of the WLAN 100, the channel access scheme 200, or the timelines 300-1500, and capability reporting scheme 1600. For example, the communication timeline 1700 illustrates communication between an AP 102-a and one or more STAs 104, and an AP 102-b and one or more STAs 104, and examples of APs 102 and STAs 104 are additionally illustrated by and described with reference to FIG. 1.

In some examples, the AP 102-a may be unavailable on the M-Primary channel. For example, an OBSS transmission 1705-a may occupy the M-Primary channel. The AP 102-a may receive an initiating frame 1710-a (such as, an RTS), and may transmit a response frame 1715-a (such as, a CTS), and may receive data 1720-a (such as, from a STA 104) on the O-primary channel (such as, using the MR). Thus, the AP 102-a may be unavailable on the M-Primary channel (such as, during duration 1725-a) because the MR is engaged on the O-Primary channel.

To address such AP unavailability (such as due to OBSS transmission 1705-b), the AP 102-b (such as, which may be equipped with an AUX-RxTx radio), may transmit a CTS2S 1730 message to block the M-Primary channel (such as, during or prior to duration 1725-b. For instance, the AP 102-b may receive the initiating frame 1710-b, may transmit the response frame 1715-b, and may receive the data 1720-b. The AP 102-b also may transmit the CTS2Self 1730. A non-AP STA 104 (such as, a legacy device, a UHR device, among other examples) may receive the CTS2Self 1730, and may set a NAV to the value indicated in the duration or identifier field of the CTS2Self 1730. The STAs 104 may not contend for the medium access until the NAV expires, and as a result, all in-BSS and OBSS transmissions will be blocked on the M-Primary channel until the AP 102-b becomes available.

In some other examples, the AP 102-b may lower the transmission power of the CTS2Self 1730. A non-AP STA 104 (such as, a legacy device, a UHR device, among other examples) may receive the CTS2Self 1730, and may set a NAV to the value indicated in the duration or identifier field of the CTS2Self 1730. The STAs 104 may not contend for the medium access until the NAV expires, and as a result, all in-BSS will be blocked on the M-Primary channel until the AP 102-b becomes available. Due to the lower transmission power, an OBSS STA may not receive the CTS2Self 1730 and may not set the NAV to the value indicated in the duration or identifier field of the CTS2Self 1730. As a result, OBSS transmissions will not be blocked on the M-Primary channel until the AP 102-b becomes unavailable, thereby mitigating the impact on OBSS transmissions.

In some other examples, the AP 102-b may transmit a message 1730, which may be a Quality of Service (QOS) Null frame, in an HE Single User (SU) PPDU or HE MU PPDU. Furthermore, the AP 102-b may indicate in the HE-SIG-A field of the HE preamble that an OBSS STA may perform spatial reuse, i.e., the OBSS STA may ignore the value indicated in the duration or identifier field of the QoS Null frame. As a result, OBSS transmissions will not be blocked on the M-Primary channel until the AP 102-b becomes unavailable, thereby mitigating the impact on OBSS transmissions.

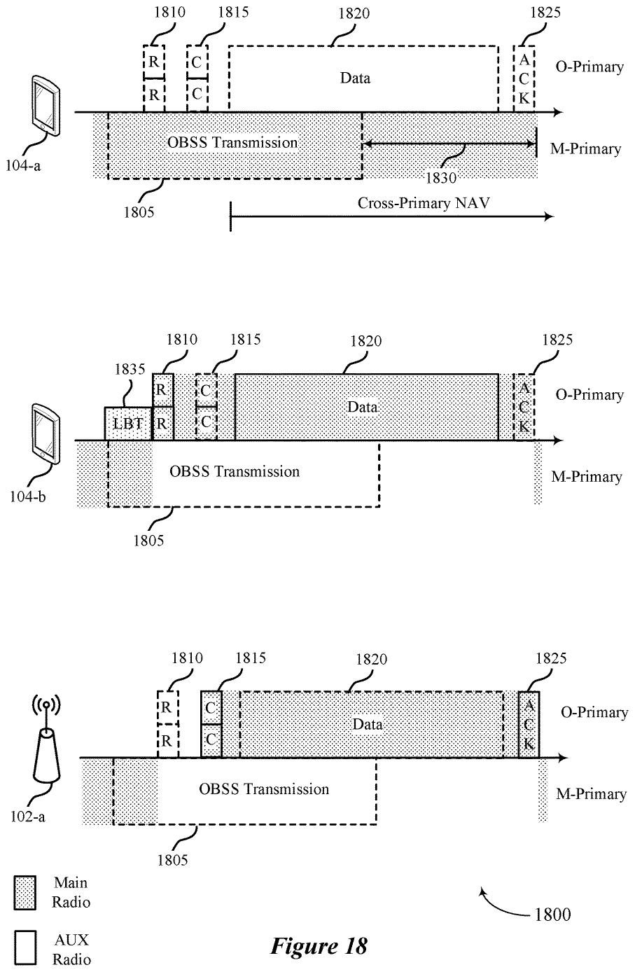

In some other examples, the AP 102-b may transmit a message 1730, which may be a protected UHR Action frame. A non-AP STA 104 (such as, a UHR device) may receive the frame 1730 and may set a NAV to the value indicated in the duration or identifier field of the frame 1730 since the STA belongs to AP 102-b's BSS. A non-AP STA that is an OBSS STA may refrain from setting a NAV to the value indicated in the duration or identifier field of the frame 1730. The STAs 104 may not contend for the medium access until the NAV expires, and as a result, all in-BSS transmissions from UHR STAs will be blocked on the M-Primary channel until the AP 102-b becomes available. However, since OBSS STAs may refrain from setting the NAV to the value indicated in the duration or identifier field of the frame 1730, OBSS transmissions will not be blocked on the M-Primary channel until the AP 102-b becomes unavailable, thereby mitigating the impact on OBSS transmissions. Cross-NAV schemes are described in greater detail with reference to FIG. 18.

FIG. 18 illustrates an example of a timeline 1800 that supports multi-primary channel access. The timeline 1800 may implement or be implemented to realize or facilitate aspects of the WLAN 100, the channel access scheme 200, or the timelines 300-1500 and 1700, and capability reporting scheme 1600. For example, the communication timeline 1800 illustrates communication between an AP 102-a and a STA 104-a and a STA 104-b, and examples of APs 102 and STAs 104 are additionally illustrated by and described with reference to FIG. 1. The AP 102-a, the STA 104-a, and the STA 104-b, may be equipped with a MR and an AUX radio. An OBSS transmission 1805 may occupy the M-Primary Channel (prior to duration 1830).

The STA 104-b may perform an LBT procedure 1835 (such as, using the AUX radio), and may switch the MR to the O-Primary channel. The STA 104-b may transmit an initiating frame 1810 (such as, an RTS) to the AP 102-a, and the AP 102-a may transmit a response frame 1815 (such as, a CTS) to the STA 104-b. The initiating frame 1810 may indicate a requested duration, and the response frame 1815 may indicate a duration for the data 1820. The STA 104-b may transmit the data 1820 to the AP 102-a, and the AP 102-a may transmit an ACK 1825 to the STA 104-b on the O-Primary channel.

The AP 102-a may specify how many cross-primary NAVs a given STA is required to maintain. If the AP 102-a indicate that the STA 104-a is to maintain a number (such as, X) of NAVs, the STA 104-a may initiate a frame exchange on any primary channel as long as the number of NAVs set (such as, a non-zero value) is smaller than the value of X. If the number of NAVs is equal to X, then the STA 104-a may not initiate a frame exchange. For example, the STA 104-a may maintain a first NAV (such as, upon reception of the response frame 1815) for the O-Primary channel, and may initiate a cross-primary NAV for the M-Primary channel. In such examples (such as, for X=2), the STA 104-a may not initiate any frame exchanges.

For an AP 102 with one MR and one AUX radio, the AP 102 may be unavailable on the M-Primary channel if the AP 102 is receiving or transmitting a PPDU on the O-Primary channel. If the MR of the AP 102 is tuned to the O-Primary channel, then the AP 102 may enable RTS/CTS for uplink signaling and may record all RTSs received from any non-AP STAs 104 on the M-Primary channel on the AUX radio while the AP 102 is unavailable on the M-Primary channel. After the in-BSS reception on the O-Primary channel ends, the AP 102 may trigger all pending requests. If the AP 102 enables RTS/CTS for uplink signaling and records all RTSs received from STAs 104 on the M-Primary channel on the AUX radio while the AP 102 was unavailable on the M-Primary channel, then after the in-BSS reception on the O-Primary channel ends, the AP 102 may transmit all delayed CTSs to all STAs 104 from which it received RTSs.

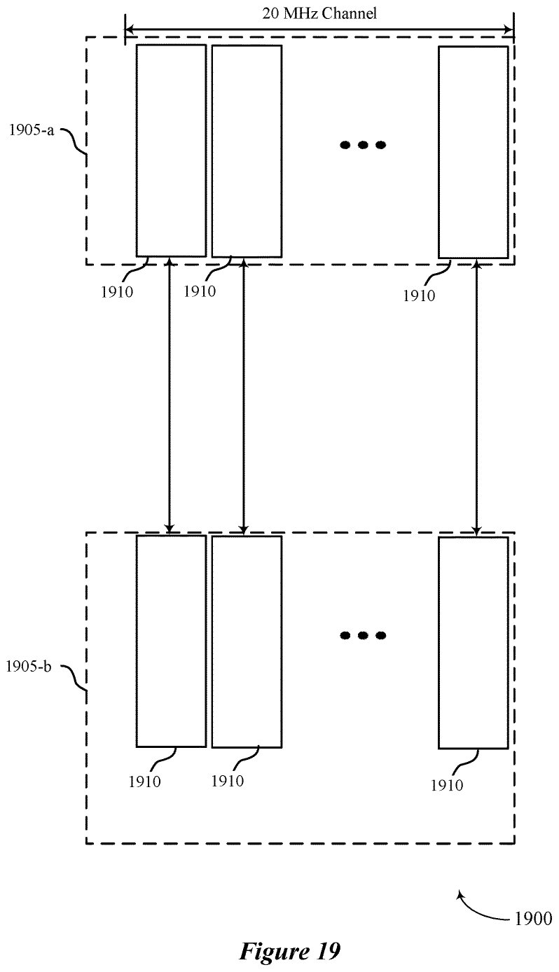

FIG. 19 illustrates an example of a communication system 1900 that supports multi-primary channel access. The communication system 1900 may implement or be implemented to realize or facilitate aspects of the WLAN 100, the channel access scheme 200, or the timelines 300-1500 and 1700-1800, and capability reporting scheme 1600. For example, the communication system 1900 illustrates communication between a device 1905-a and a device 1905-b, which may be examples of an AP 102 or a STA 104, and examples of APs 102 and STAs 104 are additionally illustrated by and described with reference to FIG. 1.

The device 1905-a and the device 1905-b may communicate via one or more bands or channels (such as, a 20 MHz channel). The device 1905-a and the device 1905-b may simultaneously establish multiple sub-20 MHz band connections (such as, for multiple subbands 1910). For example, the devices 1905 may support four (4) 5 MHz subchannels, or two (2) 10 MHz subchannels. Some subchannels 1910 may shift their center frequencies if the 20 MHz subchannel cannot support 4 standard 5 MHz bands. The number of subchannels 1910 may be defined or determined by users, or in one or more standards documents (such as, or may be based on a quantity of subbands 1910 supported by hardware of a given device 1905, or based on a transmit power limit defined by regulations). The devices 1905 may protect each subbands 1910 by protecting the 20 MHz subchannel. For example, the devices 1905 may exchange handshake signals (such as, RTS and CTS messages) for the full 20 MHz subband, and the devices 1905 may communicate on the individual subbands 1910. In some examples, the device 1905-a may transmit the same data (such as, a transmission and multiple copies of the transmission), such as control commands or other high priority data, via the subbands 1910 of the 20 MHz channel. Such signaling may improve robust and stable control link, and may improve reliability of such high priority signaling. In some examples, the device 1905-a may transmit different data on the multiple subband connections (such as, for video streaming) to improve throughput, and performance over long distances (such as, for drone communication when a distance between the device 1905-a and the device 1905-b exceeds a threshold).

Such techniques may be applied to any bandwidth (such as, in a wide band, such as a 40 MHz channel, an 80 MHz channel, a 160 MHz channel, or a 320 MHz channel). In such scenarios, the device 1905-a and the device 1905-b may perform wideband protections, and then perform multiple transmissions on the multiple subbands 1910. In some examples, the devices 1905 may establish the multiple subchannels 1910 for a single band (such as, a single 20 MHz channel), and may then extend such subband communications to another channel (such as, another 20 MHz channel). One or more devices 1905 may share connection information (such as, a key or connection map) with other connections (such as, other bands or subchannels 1910). Such techniques may improve the reliability of a connection. If a channel becomes noisy, one connection may still be able to find a new clean channel, while the remaining connections can maintain on-going traffic. When a new channel is found, the connections may be moved shamelessly to the new channel.

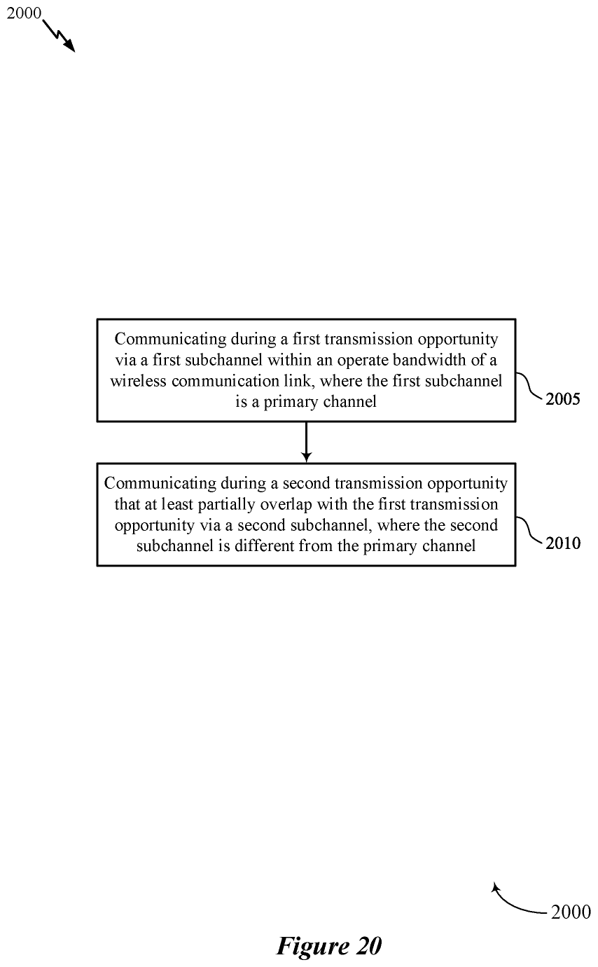

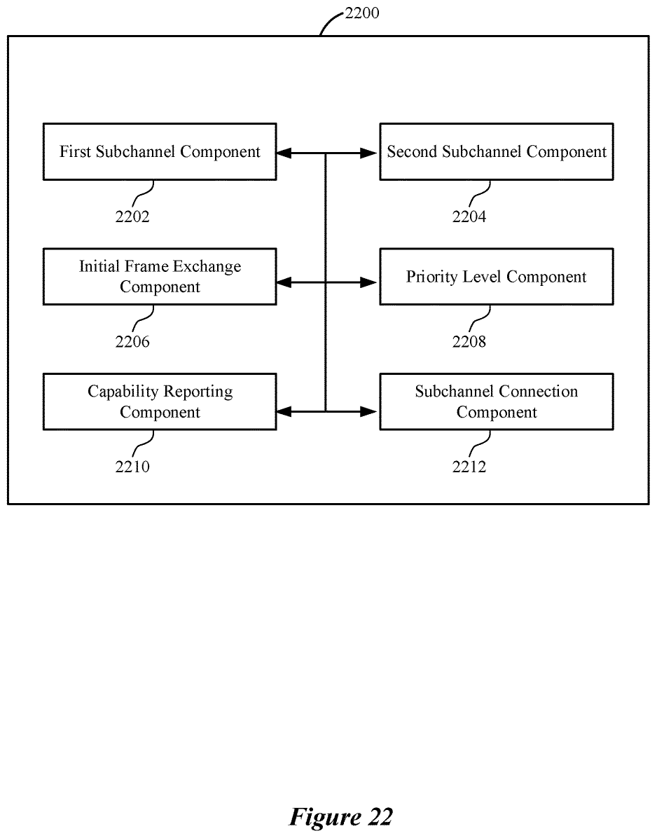

FIG. 20 shows a flowchart illustrating an example process 2000 performable at a wireless AP that supports multi-primary channel access. The operations of the process 2000 may be implemented by a wireless AP or its components as described herein. For example, the process 2000 may be performed by a wireless communication device, such as the wireless communication device 2200 described with reference to FIG. 22, operating as or within a wireless AP. In some implementations, the process 2000 may be performed by a wireless AP such as one of the APs 102 described with reference to FIG. 1.

At 2005, the wireless AP may communicate during a first transmission opportunity via a first subchannel within an operating bandwidth of a wireless communication link, where the first subchannel is a primary channel. The operations of 2005 may be performed in accordance with examples as disclosed herein. In some examples, aspects of the operations of 2005 may be performed by a first subchannel component 2025 as described with reference to FIG. 20.

At 2010, the wireless AP may communicate during a second transmission opportunity that at least partially overlaps with the first transmission opportunity via a second subchannel, where the second subchannel is different from the primary channel. The operations of 2010 may be implemented by a wireless STA or its components as described herein. For example, the process 2010 may be performed by a wireless communication device, such as the wireless communication device as described with reference to FIG. 20.

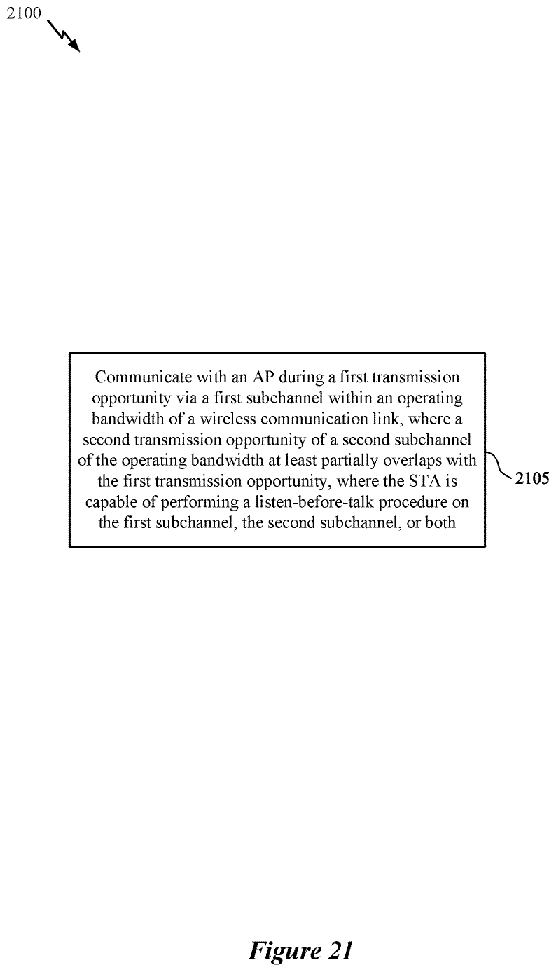

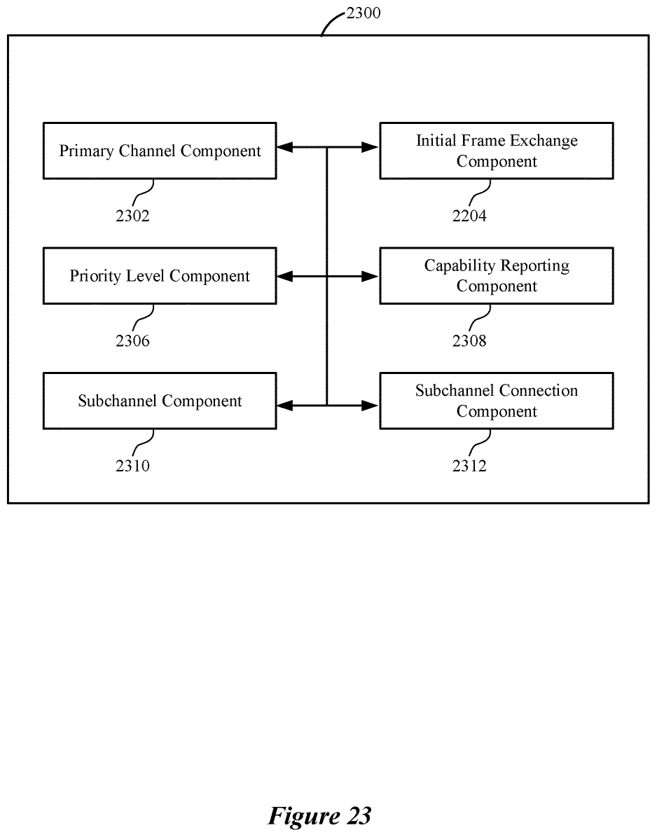

FIG. 21 shows a flowchart illustrating an example process 2100 performable at a wireless STA that supports multi-primary channel access. The operations of the process 2100 may be implemented by a wireless STA or its components as described herein. For example, the process 2100 may be performed by a wireless communication device, such as the wireless communication device 2300 described with reference to FIG. 23, operating as or within a wireless STA. In some examples, the process 2100 may be performed by a wireless STA such as one of the STAs 104 described with reference to FIG. 1.

At 2105, the wireless STA may communicate with an AP during a first transmission opportunity via a first subchannel within an operating bandwidth of a wireless communication link, where a second transmission opportunity of a second subchannel of the operating bandwidth at least partially overlaps with the first transmission opportunity, where the STA is capable of performing a LBT procedure on the first subchannel, the second subchannel, or both. The operations of 2105 may be performed in accordance with examples as disclosed herein. In some examples, aspects of the operations of 2105 may be performed by a primary channel component 2125 as described with reference to FIG. 21.

FIG. 22 shows a block diagram that supports multi-primary channel access. In some examples, the wireless communication device 2200 is configured or operable to perform the process 2000 described with reference to FIG. 20. In various examples, the wireless communication device 2200 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some examples, the wireless communication device 2200 can be a device for use in an AP, such as AP 102 described with reference to FIG. 1. In some other examples, the wireless communication device 2200 can be an AP that includes such a chip, SoC, chipset, package or device as well as multiple antennas. The wireless communication device 2200 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 2200 also includes or can be coupled with an application processor which may be further coupled with another memory. In some examples, the wireless communication device 2200 further includes at least one external network interface that enables communication with a core network or backhaul network to gain access to external networks including the Internet.

The wireless communication device 2220 may include a first subchannel component 2202, a second subchannel component 2204, an initial frame exchange component 2206, a priority level component 2208, a capability reporting component 2210, a subchannel connection component 2212, or any combination thereof. Portions of one or more of the components 2202, 2204, 2206, 2208, 2210, and 2212 may be implemented at least in part in hardware or firmware. For example, the second subchannel component 2204 may be implemented at least in part by a modem. In some examples, at least some of the components 2202, 2204, 2206, 2208, 2210, and 2212 are implemented at least in part by a processor and as software stored in a memory. For example, portions of one or more of the components 2202, 2204, 2206, 2208, 2210, and 2212 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the device 2200). For example, a processing system of the device 2200 may refer to a system including the various other components or subcomponents of the device 2200, such as the processor, or a transceiver, or a communications manager, or other components or combinations of components of the device 2200. The processing system of the device 2200 may interface with other components of the device 2200, and may process information received from other components (such as inputs or signals) or output information to other components. For example, a chip or modem of the device 2200 may include a processing system, a first interface to output information and a second interface to obtain information. In some implementations, the first interface may refer to an interface between the processing system of the chip or modem and a transmitter, such that the device 2200 may transmit information output from the chip or modem. In some implementations, the second interface may refer to an interface between the processing system of the chip or modem and a receiver, such that the device 2200 may obtain information or signal inputs, and the information may be passed to the processing system. A person having ordinary skill in the art will readily recognize that the first interface also may obtain information or signal inputs, and the second interface also may output information or signal outputs.

The first subchannel component 2202 is capable of, configured to, or operable to communicate during a first transmission opportunity via a first subchannel within an operating bandwidth of a wireless communication link, where the first subchannel is a primary channel. The second subchannel component 2204 is capable of, configured to, or operable to communicate during a second transmission opportunity that at least partially overlaps with the first transmission opportunity via a second subchannel, where the second subchannel is different from the primary channel.

In some examples, the AP is capable of performing a LBT procedure on the first subchannel, the second subchannel, or both. In some examples, the PPDU is a frequency domain aggregate PPDU (A-PPDU) or a high efficiency (HE) multi-user (MU) PPDU, an extremely high throughput MU PPDU (EHT) PPDU, or an ultra-high reliability MU PPDU (UHR MU PPDU). In some examples, the first subchannel is a main primary channel, and the second subchannel is an opportunistic primary subchannel.

In some examples, the second transmission opportunity is the same as the first transmission opportunity and a transmission is carried in a same Physical Layer Convergence Protocol (PLCP) protocol data unit (PPDU).

In some examples, the initial frame exchange component 2206 is capable of, configured to, or operable to perform an initial frame exchange prior to communicating via at least one of the first subchannel or the second subchannel in accordance with monitoring the first subchannel or monitoring the second subchannel, the initial frame exchange including an initiating frame and a response frame.

In some examples, one of the initiating frame or the response frame includes an indication of a remaining duration of a first transmission opportunity on the first subchannel, a duration of the second transmission opportunity on the second subchannel, a priority level for signaling associated with the second transmission opportunity, a transmit power, a received signal strength, or any combination thereof.

In some examples, the initial frame exchange component 2206 is capable of, configured to, or operable to receive, from a first STA, a reporting message indicating that the first STA supports the initial frame exchange, where performing the initial frame exchange is based on receiving the reporting message.

In some examples, the initial frame exchange component 2206 is capable of, configured to, or operable to transmit, to a first STA, an indication that the initial frame exchange is enabled, where performing the initial frame exchange is based on transmitting the indication.

In some examples, the initiating frame includes a request to send message, a multi-user request to send, or a request to trigger message, and the response frame includes a clear to send message or a trigger message. In some examples, the initiating frame or the response frame or both are transmitted in a non-High Throughput (HT) PPDU, a non-HT duplicate PPDU, or a UHR PPDU and are transmitted with one spatial stream at 24 Mbps or less.

In some examples, the initial frame exchange component 2206 is capable of, configured to, or operable to transmit, to a first STA via the first subchannel using a first radio, a first initiating frame indicating a first transmission opportunity on the first subchannel. In some examples, the initial frame exchange component 2206 may be configured as or otherwise support a means for transmitting, to a second STA via the first subchannel or the second subchannel, the first initiating frame or a second initiating frame indicating a second transmission opportunity on the second subchannel, where an ending boundary of the first transmission opportunity is aligned in time with an ending boundary of the second transmission opportunity. In some examples, the initial frame exchange component 2206 is capable of, configured to, or operable to receive a first response frame from the first STA via the first subchannel and a second response frame from the second STA via the second subchannel. In some examples, the initial frame exchange component 2206 is capable of, configured to, or operable to transmit a first message to the first STA and a second message to the second STA during the transmission opportunity according to the first initiating frame and the second initiating frame, respectively.

In some examples, the second transmission opportunity is the same as the first transmission opportunity and a transmission is carried in a same Physical Layer Convergence Protocol (PLCP) protocol data unit (PPDU).

In some examples, the PPDU is a frequency domain aggregate PPDU (A-PPDU) or a high efficiency (HE) multi-user (MU) PPDU, an extremely high throughput MU PPDU (EHT) PPDU, or an ultra-high reliability MU PPDU (UHR MU PPDU).

In some examples, the initial frame exchange component 2206 is capable of, configured to, or operable to perform a first LBT procedure for the first subchannel using the first radio. In some examples, the initial frame exchange component 2206 is capable of, configured to, or operable to tune the first radio to cover the first subchannel and the second subchannel according to the first LBT procedure, a second LBT procedure for the second subchannel using the second radio, or both, where transmitting the first initiating frame and the second initiating frame using the first radio is based on tuning the first radio.

In some examples, the initial frame exchange component 2206 is capable of, configured to, or operable to perform a first LBT procedure for the first subchannel using the first radio. In some examples, the initial frame exchange component 2206 is capable of, configured to, or operable to perform a second LBT procedure for the second subchannel using the first radio, where transmitting the first initiating frame and the second initiating frame is based on the first LBT procedure and the second LBT procedure.

In some examples, the initial frame exchange component 2206 is capable of, configured to, or operable to detect, using a first radio, a first message from a first STA associated with an overlapping basic service set via the first subchannel during a first transmission opportunity. In some examples, the initial frame exchange component 2206 is capable of, configured to, or operable to transmit, to a second STA via the second subchannel using the first radio, an initiating frame indicating a second transmission opportunity on the second subchannel. In some examples, the initial frame exchange component 2206 is capable of, configured to, or operable to receive a response frame from the second STA via the second subchannel using the first radio. In some examples, the initial frame exchange component 2206 communicate a second message from the second STA via the second subchannel using the first radio during the second transmission opportunity according to the response frame.

In some examples, the initial frame exchange component 2206 is capable of, configured to, or operable to support a means for performing a LBT procedure for the second subchannel using the second radio. In some examples, the initial frame exchange component 2206 is capable of, configured to, or operable to switch the first radio to the second subchannel and the second radio to the first subchannel based on the LBT procedure, where transmitting the initiating frame is based on the switching.

In some examples, the initial frame exchange component 2206 is capable of, configured to, or operable to support a means for performing a LBT procedure for the first subchannel using the second radio after a duration of the detected first message.

In some examples, the initial frame exchange component 2206 is capable of, configured to, or operable to estimate a duration of the first transmission opportunity, where transmitting the initiating frame is based on the estimating.

In some examples, the initial frame exchange component 2206 is capable of, configured to, or operable to perform a LBT procedure for the first subchannel while receiving the second message. In some examples, the initial frame exchange component 2206 is capable of, configured to, or operable to determine that the first transmission opportunity has ended based on the LBT procedure.

In some examples, the initial frame exchange component 2206 is capable of, configured to, or operable to detect, using a first radio, a first message from a first STA associated with an overlapping basic service set via the first subchannel during a first transmission opportunity. In some examples, the initial frame exchange component 2206 is capable of, configured to, or operable to receive, from a second STA via the second subchannel, an initiating frame indicating a requested duration of a second transmission opportunity on the second subchannel. In some examples, the initial frame exchange component 2206 is capable of, configured to, or operable to transmit, to the second STA via the second subchannel using the first radio, a response frame indicating an updated duration of the second transmission opportunity. In some examples, the initial frame exchange component 2206 is capable of, configured to, or operable to communicate a second message with the second STA via the second subchannel using the first radio during the second transmission opportunity according to the response frame.

In some examples, an ending boundary of the first transmission opportunity is not aligned in time with an ending boundary of the requested duration of the second transmission opportunity. In some examples, an ending boundary of the first transmission opportunity is aligned in time with an ending boundary of the updated duration of the second transmission opportunity. In some examples, an ending boundary of the updated second transmission opportunity is aligned in time with an ending boundary of the requested duration of the second transmission opportunity.

In some examples, the initial frame exchange component 2206 is capable of, configured to, or operable to support a means for switching the first radio to the second subchannel and the second radio to the first subchannel based on having received the initiating frame via the second radio, where transmitting the response frame using the first radio is based on the switching. In some examples, to support receiving the initiating frame, the initial frame exchange component 2206 is capable of, configured to, or operable to receive the initiating frame using the first radio.

In some examples, the initial frame exchange component is capable of, configured to, or operable to estimate a duration of the first transmission opportunity, where transmitting the response frame is based on the estimating.

In some examples, the initial frame exchange component 2206 is capable of, configured to, or operable to perform a LBT procedure for the first subchannel while receiving the second message.

In some examples, the priority level component 2208 is capable of, configured to, or operable to receive, based on monitoring for communications with a first STA and a second STA, a first portion of a first message associated with a first priority level from a second STA associated with a basic service set via the first subchannel during a first transmission opportunity, where the first STA is associated with the basic service set. In some examples, the priority level component 2208 is capable of, configured to, or operable to receive, from the first STA via the second subchannel, an initiating frame indicating a requested duration of a second transmission opportunity on the second subchannel, where the initiating frame includes an indication of a second priority level associated with the second transmission opportunity. In some examples, the priority level component 2208 is capable of, configured to, or operable to transmit, to the first STA via the second subchannel, a response frame indicating an updated duration of the second transmission opportunity, where the first priority level is higher than the second priority level, and where the updated duration of the second transmission opportunity is equal to zero. In some examples, the priority level component 2208 is capable of, configured to, or operable to receive a remainder of the first message via the first subchannel.

In some examples, the priority level component 2208 is capable of, configured to, or operable to receive, based on monitoring for communications with a first STA and a second STA, a first portion of a first message associated with a first priority level from a second STA associated with a basic service set via the first subchannel during a first transmission opportunity, where the first STA is associated with the basic service set. In some examples, the priority level component 2208 is capable of, configured to, or operable to receive, from the first STA via the second subchannel, an initiating frame indicating a requested duration of a second transmission opportunity on the second subchannel, where the initiating frame includes an indication of a second priority level associated with the second transmission opportunity. In some examples, the priority level component 2208 is capable of, configured to, or operable to transmit, to the first STA via the second subchannel, a response frame indicating an updated duration of the second transmission opportunity, where the second priority level is higher than the first priority level. In some examples, the priority level component 2208 is capable of, configured to, or operable to drop a remainder of the first message via the first subchannel while receiving a second message from the first STA via the second subchannel during the second transmission opportunity.

In some examples, the capability reporting component 2210 is capable of, configured to, or operable to receive, from first STA, a reporting message indicating that the first STA supports simultaneous transmit receive operations or non-simultaneous transmit receive operations, a quantity of simultaneous transmit or a quantity of simultaneous receive operations supported over the first subchannel, the second subchannel, or both, or any combination thereof.

In some examples, a first radio includes a main radio associated with the first subchannel, and a second radio includes an auxiliary radio capable of preamble detection, reception, transmission, simultaneous reception and transmission, or any combination thereof. In some examples, transmission or reception procedures via the first radio or the second radio are based on a PPDU type, a modulation and coding scheme (MCS), a number of spatial streams (NSS), or any combination thereof.

In some examples, the capability reporting component 2210 is capable of, configured to, or operable to transmit, to a first STA, an indication that request to send and clear to send signaling is enabled. In some examples, the capability reporting component 2210 is capable of, configured to, or operable to record one or more request to send message received from the first STA via the second subchannel while communicating one or more Physical Layer Convergence Protocol (PLCP) protocol data units (PPDUs) via the first subchannel. In some examples, the capability reporting component 2210 is capable of, configured to, or operable to transmit one or more delayed triggering messages, or one or more delayed clear to send messages corresponding to the one or more received request to send messages, or a combination thereof, after receiving the one or more PPDUs via the first subchannel.

In some examples, the subchannel connection component 2212 is capable of, configured to, or operable to perform a handshake procedure with a first STA indicating that the operating bandwidth is clear, where the operating bandwidth includes a quantity of subchannels that includes the first subchannel and the second subchannel, and where the quantity of subchannels satisfies a threshold quantity of subchannels supported by the first STA. In some examples, the subchannel connection component 2212 is capable of, configured to, or operable to communicate with the first STA simultaneously via each of the quantity of subchannels in accordance with the handshake procedure.

In some examples, to support communicating with the first STA, the subchannel connection component 2212 is capable of, configured to, or operable to communicate an initial transmission via one subchannel of the quantity of subchannels. In some examples, to support communicating with the first STA, the subchannel connection component 2212 is capable of, configured to, or operable to communicate a copy of the initial transmission via each remaining subchannel of the quantity of subbands.

In some examples, to support communicating with the first STA, the subchannel connection component 2212 is capable of, configured to, or operable to communicate a first portion of a data transmission via one subchannel of the quantity of subbands. In some examples, to support communicating with the first STA, the subchannel connection component 2212 is capable of, configured to, or operable to communicate a second portion of the data via another subchannel of the quantity of subbands.

In some examples, the subchannel connection component 2212 is capable of, configured to, or operable to shift a center frequency to a non-center frequency for each of a subset of the quantity of subbands.

In some examples, to support performing the handshake procedure, the subchannel connection component 2212 is capable of, configured to, or operable to exchange a request to send message and a clear to send message, or a clear-to-send-to-self message, with the first STA.

In some examples, the handshake procedure with the first STA further indicates that a second operating bandwidth including a second quantity of subchannels is clear. In some examples, the communicating with the first STA further includes communicating with the first STA simultaneously via each of the second quantity of subchannels.

In some examples, the subchannel connection component 2212 is capable of, configured to, or operable to receive, from the AP, a mapping of the quantity of subchannels for application to the second quantity of subchannels. In some examples, the first STA includes a drone located at least a threshold distance from the AP.

FIG. 23 shows a block diagram of an example wireless communication device 2300 that supports multi-channel access. In some examples, the wireless communication device 2300 is configured or operable to perform the process 2100 described with reference to FIG. 21. In various examples, the wireless communication device 2300 can be a chip, SoC, chipset, package or device that may include: one or more modems (such as, a Wi-Fi (IEEE 802.11) modem or a cellular modem such as 3GPP 4G LTE or 5G compliant modem), one or more processors, processing blocks or processing elements (collectively “the processor”); one or more radios (collectively “the radio”); and one or more memories or memory blocks (collectively “the memory”).

In some examples, the wireless communication device 2300 can be a device for use in a STA, such as STA 104 described with reference to FIG. 1. In some other examples, the wireless communication device 2300 can be a STA that includes such a chip, SoC, chipset, package or device as well as multiple antennas. The wireless communication device 2300 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 2300 also includes or can be coupled with an application processor which may be further coupled with another memory. In some examples, the wireless communication device 2300 further includes a user interface (UI) (such as a touchscreen or keypad) and a display, which may be integrated with the UI to form a touchscreen display. In some examples, the wireless communication device 2300 may further include one or more sensors such as, for example, one or more inertial sensors, accelerometers, temperature sensors, pressure sensors, or altitude sensors.

The wireless communication device 2300 includes a primary channel component 2302, an initial frame exchange component 2304, a priority level component 2306, a capability reporting component 2308, a subchannel component 2310, a subchannel connection component 2312, or any combination thereof. Portions of one or more of the components 2302, 2304, 2306, 2308, 2310, and 2312 may be implemented at least in part in hardware or firmware. For example, the initial frame exchange component 2304 may be implemented at least in part by a modem. In some examples, at least some of the components 2302, 2304, 2306, 2308, 2310, and 2312 are implemented at least in part by a processor and as software stored in a memory. For example, portions of one or more of the components 2302, 2304, 2306, 2308, 2310, and 2312 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the device 2300). For example, a processing system of the device 2300 may refer to a system including the various other components or subcomponents of the device 2300, such as the processor, or a transceiver, or a communications manager, or other components or combinations of components of the device 2300. The processing system of the device 2300 may interface with other components of the device 2300, and may process information received from other components (such as inputs or signals) or output information to other components. For example, a chip or modem of the device 2300 may include a processing system, a first interface to output information and a second interface to obtain information. In some implementations, the first interface may refer to an interface between the processing system of the chip or modem and a transmitter, such that the device 2300 may transmit information output from the chip or modem. In some implementations, the second interface may refer to an interface between the processing system of the chip or modem and a receiver, such that the device 2300 may obtain information or signal inputs, and the information may be passed to the processing system. A person having ordinary skill in the art will readily recognize that the first interface also may obtain information or signal inputs, and the second interface also may output information or signal outputs.

The primary channel component 2302 is capable of, configured to, or operable to communicate with an AP during a first transmission opportunity via a first subchannel within an operating bandwidth of a wireless communication link, where a second transmission opportunity of a second subchannel of the operating bandwidth at least partially overlaps with the first transmission opportunity, where the STA is capable of performing a LBT procedure on the first subchannel, the second subchannel, or both.

In some examples, the first transmission opportunity is associated with the second subchannel. In some examples, a transmission is carried in a same Physical Layer Convergence Protocol (PLCP) protocol data unit (PPDU). In some examples, the PPDU is a frequency domain aggregate PPDU (A-PPDU) or a high efficiency (HE) multi-user (MU) PPDU, an extremely high throughput MU PPDU (EHT) PPDU, or an ultra-high reliability MU PPDU (UHR MU PPDU).

In some examples, the initial frame exchange component 2304 is capable of, configured to, or operable to perform an initial frame exchange prior to communicating via at least one of the first subchannel or the second subchannel in accordance with at least one of monitoring the first subchannel or monitoring the second subchannel, the initial frame exchange including an initiating frame and a response frame.

In some examples, one of the initiating frame or the response frame includes an indication of a remaining duration of a first transmission opportunity on the first subchannel, a duration of a second transmission opportunity, a priority level for signaling associated with the second transmission opportunity, a transmit power, a received signal strength, or any combination thereof.

In some examples, the capability reporting component 2308 is capable of, configured to, or operable to transmit, to an AP, a reporting message indicating that the first STA supports the initial frame exchange, where performing the initial frame exchange is based on transmitting the reporting message.

In some examples, the initial frame exchange component 2304 is capable of, configured to, or operable to receive, from the AP, an indication that the initial frame exchange is enabled, where performing the initial frame exchange is based on receiving the indication. In some examples, the initiating frame includes a request to send message or a multi-user request to send or a request to trigger message, and the response frame includes a clear to send message or a trigger message.

In some examples, the initial frame exchange component 2304 is capable of, configured to, or operable to receive, from the AP via the first subchannel or the second subchannel using a first radio, an initiating frame indicating the first transmission opportunity on the first subchannel. In some examples, the initial frame exchange component 2304 is capable of, configured to, or operable to tune a second radio to the second subchannel. In some examples, the initial frame exchange component 2304 is capable of, configured to, or operable to transmit, to the AP via the second subchannel using the second radio, a response frame. In some examples, the initial frame exchange component 2304 is capable of, configured to, or operable to receive a message from the AP during the first transmission opportunity on the first subchannel.

In some examples, the initial frame exchange component 2304 is capable of, configured to, or operable to receive, from the AP via the second subchannel using a first radio, an initiating frame indicating a transmission opportunity on the second subchannel. In some examples, the initial frame exchange component 2304 is capable of, configured to, or operable to tune a second radio to the second subchannel. In some examples, the initial frame exchange component 2304 is capable of, configured to, or operable to transmit, to the AP via the second subchannel using the second radio, a response frame. In some examples, the initial frame exchange component 2304 is capable of, configured to, or operable to communicate a message with the AP via the second subchannel using the second radio during the transmission opportunity according to the response frame. In some examples, an ending boundary of the transmission opportunity is aligned in time with an ending boundary of a second transmission opportunity on the first subchannel.

In some examples, the initial frame exchange component 2304 is capable of, configured to, or operable to perform a listen-before talk procedure for the second subchannel using a first radio. In some examples, the initial frame exchange component 2304 is capable of, configured to, or operable to tune a second radio to the second subchannel. In some examples, the initial frame exchange component 2304 is capable of, configured to, or operable to transmit, to the AP via the second subchannel using the second radio, an initiating frame. In some examples, the initial frame exchange component 2304 is capable of, configured to, or operable to receive, from the AP via the second subchannel using the second radio, a response frame. In some examples, the initial frame exchange component 2304 is capable of, configured to, or operable to transmit a message to the AP via the second subchannel using the second radio during the first transmission opportunity according to the response frame.

In some examples, the priority level component 2306 m is capable of, configured to, or operable to perform a listen-before talk procedure for the second subchannel using a first radio. In some examples, the priority level component 2306 is capable of, configured to, or operable to tune a second radio to the second subchannel. In some examples, the priority level component 2306 is capable of, configured to, or operable to transmit, to the AP via the second subchannel using the second radio, an initiating frame indicating a requested duration of a transmission opportunity on the second subchannel, where the initiating frame includes an indication of a priority level associated with the transmission opportunity. In some examples, the priority level component 2306 is capable of, configured to, or operable to receive, from the AP via the second subchannel using the second radio, a response frame indicating an updated duration of the second transmission opportunity, where the updated duration of the second transmission opportunity is equal to zero. In some examples, the priority level component 2306 is capable of, configured to, or operable to refrain from transmitting during the transmission opportunity according to the updated duration of the second transmission opportunity.

In some examples, the priority level component 2306 is capable of, configured to, or operable to perform a listen-before talk procedure for the second subchannel using a using a first radio. In some examples, the priority level component 2306 is capable of, configured to, or operable to tune a second radio to the second subchannel. In some examples, the priority level component 2306 is capable of, configured to, or operable to transmit, to the AP via the second subchannel using the first radio, an initiating frame indicating a requested duration of a transmission opportunity on the second subchannel, where the initiating frame includes an indication of a priority level associated with the transmission opportunity. In some examples, the priority level component 2306 is capable of, configured to, or operable to receive, from the AP via the second subchannel using the second radio, a response frame indicating an updated duration of the second transmission opportunity, where the updated duration of the second transmission opportunity is less than or equal to the requested duration. In some examples, the priority level component 2306 is capable of, configured to, or operable to transmit a message to the AP via the second subchannel using the second radio during a second transmission opportunity according to the updated duration of the second transmission opportunity.

In some examples, the capability reporting component 2308 is capable of, configured to, or operable to transmit, to the AP, a reporting message indicating that the STA supports simultaneous transmit receive operations or non-simultaneous transmit receive operations, a quantity of simultaneous transmit or a quantity of simultaneous receive operations supported over the first subchannel, the second subchannel, or both, or any combination thereof.

In some examples, the capability reporting component is capable of, configured to, or operable to refrain from initiating additional communication on one of the first subchannel or the second subchannel based on detecting communication by the AP via the other of the first subchannel or the second subchannel, where the refraining is based on the quantity of simultaneous transmit or the quantity of simultaneous receive operations supported over the first subchannel, the second subchannel, or both.

In some examples, a first radio includes a main radio associated with the first subchannel, and a second radio includes an auxiliary radio capable of preamble detection, reception, transmission, simultaneous reception and transmission, or any combination thereof, where transmission or reception procedures via the first radio or the second radio are based on a PPDU type, a modulation and coding scheme (MCS), a network security.

In some examples, the initial frame exchange component 2304 is capable of, configured to, or operable to receive, based on monitoring the first subchannel, a multi-user request to send message (MU-RTS). In some examples, the initial frame exchange component 2304 is capable of, configured to, or operable to switch from the first subchannel to the second subchannel based on receiving the multi-user request to send message, where monitoring the second subchannel is based on the switching.

In some examples, the initial frame exchange component 2304 is capable of, configured to, or operable to receive, from the AP, an indication of a threshold quantity of cross-primary network allocation vectors (NAVs) the STA is to maintain. In some examples, the initial frame exchange component 2304 is capable of, configured to, or operable to initiate an initial frame exchange including an initiating frame and a response frame based on a quantity of non-zero cross-primary NAVs maintained by the STA not exceeding the threshold quantity.

In some examples, the subchannel component 2310 is capable of, configured to, or operable to perform a handshake procedure with the AP indicating that the operating bandwidth is clear, where the operating bandwidth includes a quantity of subchannels that includes the first subchannel and the second subchannel, and where the quantity of subchannels satisfies a threshold quantity of subchannels supported by the first STA. In some examples, the subchannel connection component 2312 is capable of, configured to, or operable to communicate with the AP simultaneously via each of the quantity of subchannels in accordance with the handshake procedure.

In some examples, to support communicating with the AP, the subchannel connection component 2312 is capable of, configured to, or operable to communicate an initial transmission via one subchannel of the quantity of subchannels. In some examples, to support communicating with the AP, the subchannel connection component 2312 is capable of, configured to, or operable to communicate a copy of the initial transmission via each remaining subchannel of the quantity of subbands.

In some examples, to support communicating with the AP, the subchannel connection component 2312 is capable of, configured to, or operable to communicate a first portion of a data transmission via one subchannel of the quantity of subchannels. In some examples, to support communicating with the AP, the subchannel connection component 2312 is capable of, configured to, or operable to communicate a second portion of the data via another subchannel of the quantity of subchannels.

In some examples, the subchannel connection component 2312 is capable of, configured to, or operable to shift a center frequency to a non-center frequency for each of a subset of the quantity of subchannels.

In some examples, to support performing the handshake procedure, the subchannel connection component 2312 is capable of, configured to, or operable to exchange a request to send message and a clear to send message, or a clear-to-send-to-self message, with the AP. In some examples, the handshake procedure with the AP further indicates that a second operating bandwidth including a second quantity of subchannel is clear. In some examples, the communicating with the AP further includes communicating with the AP simultaneously via each of the second quantity of subbands.

In some examples, the subchannel connection component 2312 is capable of, configured to, or operable to transmit, to the first STA, a mapping of the quantity of subbands for application to the second quantity of subbands. In some examples, the first STA includes a drone located at least a threshold distance from the AP.

Implementation examples are described in the following numbered clauses:
Clause 1: An apparatus for wireless communications at an AP, including: one or more interfaces, and one or more processing systems capable of and configured to: communicate during a first transmission opportunity via a first subchannel within an operate bandwidth of a wireless communication link, where the first subchannel is a primary channel; and communicate during a second transmission opportunity that at least partially overlap with the first transmission opportunity via a second subchannel, where the second subchannel is different from the primary channel.
Clause 2: The apparatus of clause 1, where the apparatus is capable of performing a listen-before-talk procedure on the first subchannel, the second subchannel, or both.
Clause 3: The apparatus of clause 2, where the PPDU is a frequency domain aggregate PPDU (A-PPDU) or a high efficiency (HE) multi-user (MU) PPDU, an extremely high throughput MU PPDU (EHT) PPDU, or an ultra high reliability MU PPDU (UHR MU PPDU).
Clause 4: The apparatus of any of clauses 1 through 3, where the first subchannel is a main primary channel, and the second subchannel is an opportunistic primary subchannel.
Clause 5: The apparatus of any of clauses 1 through 4, where the second transmission opportunity is the same as the first transmission opportunity and a transmission is carried in a same Physical Layer Convergence Protocol (PLCP) protocol data unit (PPDU).
Clause 6: The apparatus of any of clauses 1 through 5, where the one or more interfaces are further configured to: perform an initial frame exchange prior to communicating via at least one of the first subchannel or the second subchannel in accordance with monitoring the first subchannel or monitoring the second subchannel, the initial frame exchange including an initiating frame and a response frame.
Clause 7: The apparatus of clause 6, where one of the initiating frame or the response frame includes an indication of a remaining duration of a first transmission opportunity on the first subchannel, a duration of the second transmission opportunity on the second subchannel, a priority level for signaling associated with the second transmission opportunity, a transmit power, a received signal strength, or any combination thereof.
Clause 8: The apparatus of any of clauses 6 through 7, the one or more interfaces are further configured to: obtain, from a first STA, a reporting message indicating that the first STA supports the initial frame exchange, where performing the initial frame exchange is based on receiving the reporting message.
Clause 9: The apparatus of any of clauses 6 through 8, the one or more interfaces are further configured to: output, to a first STA, an indication that the initial frame exchange is enabled, where performing the initial frame exchange is based on outputting the indication.
Clause 10: The apparatus of any of clauses 6 through 9, where the initiating frame includes a request to send message, a multi-user request to send, or a request to trigger message, and the response frame includes a clear to send message or a trigger message, and the initiating frame or the response frame or both are outputted in a non High Throughput (HT) PPDU, a non-HT duplicate PPDU, or a UHR PPDU and are outputted with one spatial stream at 24 Mbps or less.
Clause 11: The apparatus of any of clauses 1 through 10, the one or more interfaces are further configured to: output, to a first STA via the first subchannel using a first radio, a first initiating frame indicating a first transmission opportunity on the first subchannel; output, to a second STA via the first subchannel or the second subchannel, the first initiating frame or a second initiating frame indicating a second transmission opportunity on the second subchannel, where an ending boundary of the first transmission opportunity is aligned in time with an ending boundary of the second transmission opportunity; obtain a first response frame from the first STA via the first subchannel and a second response frame from the second STA via the second subchannel; and output a first message to the first STA and a second message to the second STA during the transmission opportunity according to the first initiating frame and the second initiating frame, respectively.
Clause 12: The apparatus of clause 11, where the second transmission opportunity is the same as the first transmission opportunity and a transmission is carried in a same Physical Layer Convergence Protocol (PLCP) protocol data unit (PPDU).
Clause 13: The apparatus of clause 12, where the PPDU is a frequency domain aggregate PPDU (A-PPDU) or a high efficiency (HE) multi-user (MU) PPDU, an extremely high throughput MU PPDU (EHT) PPDU, or an ultra high reliability MU PPDU (UHR MU PPDU).
Clause 14: The apparatus of any of clauses 11 through 13, the one or more interfaces are further configured to: perform a first listen-before-talk procedure for the first subchannel using the first radio; and tune the first radio to cover the first subchannel and the second subchannel according to the first listen-before-talk procedure, a second listen-before-talk procedure for the second subchannel using the second radio, or both, where outputting the first initiating frame and the second initiating frame using the first radio is based on tuning the first radio.
Clause 15: The apparatus of any of clauses 11 through 14, the one or more interfaces are further configured to: perform a first listen-before-talk procedure for the first subchannel using the first radio; and perform a second listen-before-talk procedure for the second subchannel using the first radio, where outputting the first initiating frame and the second initiating frame is based on the first listen-before-talk procedure and the second listen-before-talk procedure.
Clause 16: The apparatus of any of clauses 1 through 15, the one or more interfaces are further configured to: detect, using a first radio, a first message from a first STA associated with an overlapping basic service set via the first subchannel during a first transmission opportunity; output, to a second STA via the second subchannel using the first radio, an initiating frame indicating a second transmission opportunity on the second subchannel, obtain a response frame from the second STA via the second subchannel using the first radio; and communicate a second message from the second STA via the second subchannel using the first radio during the second transmission opportunity according to the response frame.
Clause 17: The apparatus of clause 16, the one or more interfaces are further configured to: perform a listen-before-talk procedure for the second subchannel using the second radio; and switch the first radio to the second subchannel and the second radio to the first subchannel based on the listen-before-talk procedure, where outputting the initiating frame is based on the switching.
Clause 18: The apparatus of any of clauses 16 through 17, the one or more interfaces are further configured to: perform a listen-before-talk procedure for the first subchannel using the second radio after a duration of the detected first message.
Clause 19: The apparatus of any of clauses 16 through 18, the one or more interfaces are further configured to: estimate a duration of the first transmission opportunity, where outputting the initiating frame is based on the estimating.
Clause 20: The apparatus of any of clauses 16 through 19, the one or more interfaces are further configured to: perform a listen-before-talk procedure for the first subchannel while receiving the second message; and determine that the first transmission opportunity has ended based on the listen-before-talk procedure.
Clause 21: The apparatus of any of clauses 1 through 20, the one or more interfaces are further configured to: detect, using a first radio, a first message from a first STA associated with an overlapping basic service set via the first subchannel during a first transmission opportunity; obtain, from a second STA via the second subchannel, an initiating frame indicating a requested duration of a second transmission opportunity on the second subchannel; output, to the second STA via the second subchannel using the first radio, a response frame indicating an updated duration of the second transmission opportunity; and communicate a second message with the second STA via the second subchannel using the first radio during the second transmission opportunity according to the response frame.
Clause 22: The apparatus of clause 21, where an ending boundary of the first transmission opportunity is not aligned in time with an ending boundary of the requested duration of the second transmission opportunity, and an ending boundary of the first transmission opportunity is aligned in time with an ending boundary of the updated duration of the second transmission opportunity.
Clause 23: The apparatus of any of clauses 21 through 22, where an ending boundary of the updated second transmission opportunity is aligned in time with an ending boundary of the requested duration of the second transmission opportunity.
Clause 24: The apparatus of any of clauses 21 through 23, the one or more interfaces are further configured to: switch the first radio to the second subchannel and the second radio to the first subchannel based on having obtained the initiating frame via the second radio, where outputting the response frame using the first radio is based on the switching.
Clause 25: The apparatus of any of clauses 21 through 24, where the instructions to obtain the initiating frame are executable by the processor to cause the apparatus to: obtain the initiating frame using the first radio.
Clause 26: The apparatus of any of clauses 21 through 25, the one or more interfaces are further configured to: estimate a duration of the first transmission opportunity, where transmitting the response frame is based on the estimating.
Clause 27: The apparatus of any of clauses 21 through 26, the one or more interfaces are further configured to: perform a listen-before-talk procedure for the first subchannel while receiving the second message.
Clause 28: The apparatus of any of clauses 1 through 27, the one or more interfaces are further configured to: obtain, based on monitoring for communications with a first STA and a second STA, a first portion of a first message associated with a first priority level from a second STA associated with a basic service set via the first subchannel during a first transmission opportunity, where the first STA is associated with the basic service set; obtain, from the first STA via the second subchannel, an initiating frame indicating a requested duration of a second transmission opportunity on the second subchannel, where the initiating frame includes an indication of a second priority level associated with the second transmission opportunity; output, to the first STA via the second subchannel, a response frame indicating an updated duration of the second transmission opportunity, where the first priority level is higher than the second priority level, and where the updated duration of the second transmission opportunity is equal to zero; and obtain a remainder of the first message via the first subchannel.
Clause 29: The apparatus of any of clauses 1 through 28, the one or more interfaces are further configured to: obtain, based on monitoring for communications with a first STA and a second STA, a first portion of a first message associated with a first priority level from a second STA associated with a basic service set via the first subchannel during a first transmission opportunity, where the first STA is associated with the basic service set; obtain, from the first STA via the second subchannel, an initiating frame indicating a requested duration of a second transmission opportunity on the second subchannel, where the initiating frame includes an indication of a second priority level associated with the second transmission opportunity; output, to the first STA via the second subchannel, a response frame indicating an updated duration of the second transmission opportunity, where the second priority level is higher than the first priority level; and drop a remainder of the first message via the first subchannel while receiving a second message from the first STA via the second subchannel during the second transmission opportunity.
Clause 30: The apparatus of any of clauses 1 through 29, the one or more interfaces are further configured to: obtain, from first STA, a reporting message indicating that the first STA supports simultaneous transmit obtain operations or non-simultaneous output obtain operations, a quantity of simultaneous output or a quantity of simultaneous obtain operations supported over the first subchannel, the second subchannel, or both, or any combination thereof.
Clause 31: The apparatus of any of clauses 1 through 30, where a first radio includes a main radio associated with the first subchannel, and a second radio includes an auxiliary radio capable of preamble detection, reception, transmission, simultaneous reception and transmission, or any combination thereof, transmission or reception procedures via the first radio or the second radio are based on a PPDU type, a modulation and coding scheme (MCS), a number of spatial streams (NSS), or any combination thereof.
Clause 32: The apparatus of any of clauses 1 through 31, the one or more interfaces are further configured to: output, to a first STA, an indication that request to send and clear to send signaling is enabled; record one or more request to send message obtain d from the first STA via the second subchannel while communicating one or more Physical Layer Convergence Protocol (PLCP) protocol data units (PPDUs) via the first subchannel; and output one or more delayed triggering messages, or one or more delayed clear to send messages corresponding to the one or more obtained request to send messages, or a combination thereof, after receiving the one or more PPDUs via the first subchannel.
Clause 33: The apparatus of any of clauses 1 through 32, the one or more interfaces are further configured to: perform a handshake procedure with a first STA indicating that the operating bandwidth is clear, where the operating bandwidth includes a quantity of subchannels that includes the first subchannel and the second subchannel, and where the quantity of subchannels satisfies a threshold quantity of subchannels supported by the first STA; and communicate with the first STA simultaneously via each of the quantity of subchannels in accordance with the handshake procedure.
Clause 34: The apparatus of clause 33, where the instructions to communicate with the first STA are executable by the processor to cause the apparatus to: communicate an initial transmission via one subchannel of the quantity of subchannels; and communicate a copy of the initial transmission via each remaining subchannel of the quantity of subbands.
Clause 35: The apparatus of any of clauses 33 through 34, where the instructions to communicate with the first STA are executable by the processor to cause the apparatus to: communicate a first portion of a data transmission via one subchannel of the quantity of subbands; and communicate a second portion of the data via another subchannel of the quantity of subbands.
Clause 36: The apparatus of any of clauses 33 through 35, the one or more interfaces are further configured to: shift a center frequency to a non-center frequency for each of a subset of the quantity of subbands.
Clause 37: The apparatus of any of clauses 33 through 36, where the instructions to perform the handshake procedure are executable by the processor to cause the apparatus to: exchange a request to send message and a clear to send message, or a clear-to-send-to-self message, with the first STA.
Clause 38: The apparatus of any of clauses 33 through 37, where the handshake procedure with the first STA further indicates that a second operating bandwidth including a second quantity of subchannels is clear, and the communicating with the first STA further includes communicating with the first STA simultaneously via each of the second quantity of subchannels.
Clause 39: The apparatus of clause 38, the one or more interfaces are further configured to: obtain, from the AP, a mapping of the quantity of subchannels for application to the second quantity of subchannels.
Clause 40: The apparatus of any of clauses 33 through 39, where the first STA includes a drone located at least a threshold distance from the AP.
Clause 41: An apparatus for wireless communications at a first STA, including one or more interfaces, and one or more processing systems capable of and configured to: communicate with an AP during a first transmission opportunity via a first subchannel within an operating bandwidth of a wireless communication link, where a second transmission opportunity of a second subchannel of the operating bandwidth at least partially overlaps with the first transmission opportunity, where the STA is capable of performing a listen-before-talk procedure on the first subchannel, the second subchannel, or both.
Clause 42: The apparatus of clause 41, where the first transmission opportunity is associated with the second subchannel, and a transmission is carried in a same Physical Layer Convergence Protocol (PLCP) protocol data unit (PPDU).
Clause 43: The apparatus of clause 42, where the PPDU is a frequency domain aggregate PPDU (A-PPDU) or a high efficiency (HE) multi-user (MU) PPDU, an extremely high throughput MU PPDU (EHT) PPDU, or an ultra high reliability MU PPDU (UHR MU PPDU).
Clause 44: The apparatus of any of clauses 41 through 43, the one or more interfaces are further configured to: perform an initial frame exchange prior to communicating via at least one of the first subchannel or the second subchannel in accordance with at least one of monitoring the first subchannel or monitoring the second subchannel, the initial frame exchange including an initiating frame and a response frame.
Clause 45: The apparatus of clause 44, where one of the initiating frame or the response frame includes an indication of a remaining duration of a first transmission opportunity on the first subchannel, a duration of a second transmission opportunity, a priority level for signaling associated with the second transmission opportunity, a transmit power, a received signal strength, or any combination thereof.
Clause 46: The apparatus of any of clauses 44 through 45, the one or more interfaces are further configured to: output, to an AP, a reporting message indicating that the first STA supports the initial frame exchange, where performing the initial frame exchange is based on output ting the reporting message.
Clause 47: The apparatus of any of clauses 44 through 46, the one or more interfaces are further configured to: obtain, from the AP, an indication that the initial frame exchange is enabled, where performing the initial frame exchange is based on receiving the indication.
Clause 48: The apparatus of any of clauses 44 through 47, where the initiating frame includes a request to send message or a multi-user request to send or a request to trigger message, and the response frame includes a clear to send message or a trigger message.
Clause 49: The apparatus of any of clauses 41 through 48, the one or more interfaces are further configured to: obtain, from the AP via the first subchannel or the second subchannel using a first radio, an initiating frame indicating the first transmission opportunity on the first subchannel; tune a second radio to the second subchannel; output, to the AP via the second subchannel using the second radio, a response frame; and obtain a message from the AP during the first transmission opportunity on the first subchannel.
Clause 50: The apparatus of any of clauses 41 through 49, the one or more interfaces are further configured to: obtain, from the AP via the second subchannel using a first radio, an initiating frame indicating a transmission opportunity on the second subchannel; tune a second radio to the second subchannel; output, to the AP via the second subchannel using the second radio, a response frame; and communicate a message with the AP via the second subchannel using the second radio during the transmission opportunity according to the response frame.
Clause 51: The apparatus of clause 50, where an ending boundary of the transmission opportunity is aligned in time with an ending boundary of a second transmission opportunity on the first subchannel.
Clause 52: The apparatus of any of clauses 41 through 51, the one or more interfaces are further configured to: perform a listen-before talk procedure for the second subchannel using a first radio; tune a second radio to the second subchannel; output, to the AP via the second subchannel using the second radio, an initiating frame; obtain, from the AP via the second subchannel using the second radio, a response frame; and output a message to the AP via the second subchannel using the second radio during the first transmission opportunity according to the response frame.
Clause 53: The apparatus of any of clauses 41 through 52, the one or more interfaces are further configured to: perform a listen-before talk procedure for the second subchannel using a first radio; tune a second radio to the second subchannel; output, to the AP via the second subchannel using the second radio, an initiating frame indicating a requested duration of a transmission opportunity on the second subchannel, where the initiating frame includes an indication of a priority level associated with the transmission opportunity; obtain, from the AP via the second subchannel using the second radio, a response frame indicating an updated duration of the second transmission opportunity, where the updated duration of the second transmission opportunity is equal to zero; and refrain from output ting during the transmission opportunity according to the updated duration of the second transmission opportunity.
Clause 54: The apparatus of any of clauses 41 through 53, the one or more interfaces are further configured to: perform a listen-before talk procedure for the second subchannel using a using a first radio; tune a second radio to the second subchannel; output, to the AP via the second subchannel using the first radio, an initiating frame indicating a requested duration of a transmission opportunity on the second subchannel, where the initiating frame includes an indication of a priority level associated with the transmission opportunity; obtain, from the AP via the second subchannel using the second radio, a response frame indicating an updated duration of the second transmission opportunity, where the updated duration of the second transmission opportunity is less than or equal to the requested duration; and output a message to the AP via the second subchannel using the second radio during a second transmission opportunity according to the updated duration of the second transmission opportunity.
Clause 55: The apparatus of any of clauses 41 through 54, the one or more interfaces are further configured to: output, to the AP, a reporting message indicating that the STA supports simultaneous transmit obtain operations or non-simultaneous transmit obtain operations, a quantity of simultaneous transmit or a quantity of simultaneous obtain operations supported over the first subchannel, the second subchannel, or both, or any combination thereof.
Clause 56: The apparatus of clause 55, the one or more interfaces are further configured to: refrain from initiating additional communication on one of the first subchannel or the second subchannel based on detecting communication by the AP via the other of the first subchannel or the second subchannel, where the refraining is based on the quantity of simultaneous transmit or the quantity of simultaneous obtain operations supported over the first subchannel, the second subchannel, or both.
Clause 57: The apparatus of any of clauses 41 through 56, the one or more interfaces are further configured to: where a first radio include a main radio associated with the first subchannel, and a second radio includes an auxiliary radio capable of preamble detection, reception, transmission, simultaneous reception and transmission, or any combination thereof, where transmission or reception procedures via the first radio or the second radio are based on a PPDU type, a modulation and coding scheme (MCS), a network security.
Clause 58: The apparatus of any of clauses 41 through 57, the one or more interfaces are further configured to: obtain, based on monitoring the first subchannel, a multi-user request to send message (MU-RTS); and switch from the first subchannel to the second subchannel based on receiving the multi-user request to send message, where monitoring the second subchannel is based on the switching.
Clause 59: The apparatus of any of clauses 41 through 58, the one or more interfaces are further configured to: obtain, from the AP, an indication of a threshold quantity of cross-primary network allocation vectors (NAVs) the STA is to maintain; and initiate an initial frame exchange including an initiating frame and a response frame based on a quantity of non-zero cross-primary NAVs maintained by the STA not exceeding the threshold quantity.
Clause 60: The apparatus of any of clauses 41 through 59, the one or more interfaces are further configured to: perform a handshake procedure with the AP indicating that the operating bandwidth is clear, where the operating bandwidth includes a quantity of subchannels that includes the first subchannel and the second subchannel, and where the quantity of subchannels satisfies a threshold quantity of subchannels supported by the first STA; and communicate with the AP simultaneously via each of the quantity of subchannels in accordance with the handshake procedure.
Clause 61: The apparatus of clause 60, where the instructions to communicate with the AP are executable by the processor to cause the apparatus to: communicate an initial transmission via one subchannel of the quantity of subchannels; and communicate a copy of the initial transmission via each remaining subchannel of the quantity of subbands.
Clause 62: The apparatus of any of clauses 60 through 61, where the instructions to communicate with the AP are executable by the processor to cause the apparatus to: communicate a first portion of a data transmission via one subchannel of the quantity of subchannels; and communicate a second portion of the data via another subchannel of the quantity of subchannels.
Clause 63: The apparatus of any of clauses 60 through 62, the one or more interfaces are further configured to: shift a center frequency to a non-center frequency for each of a subset of the quantity of subchannels.
Clause 64: The apparatus of any of clauses 60 through 63, where the instructions to perform the handshake procedure are executable by the processor to cause the apparatus to: exchange a request to send message and a clear to send message, or a clear to send to self message, with the AP.
Clause 65: The apparatus of any of clauses 60 through 64, where the handshake procedure with the AP further indicates that a second operating bandwidth including a second quantity of subchannel is clear, and the communicating with the AP further includes communicating with the AP simultaneously via each of the second quantity of subbands.
Clause 66: The apparatus of clause 65, the one or more interfaces are further configured to: output, to the first STA, a mapping of the quantity of subbands for application to the second quantity of subbands.
Clause 67: The apparatus of any of clauses 60 through 66, where the first STA includes a drone located at least a threshold distance from the AP.
Clause 68: A method for wireless communications at an AP, including: communicating during a first transmission opportunity via a first subchannel within an operating bandwidth of a wireless communication link, where the first subchannel is a primary channel; and communicating during a second transmission opportunity that at least partially overlaps with the first transmission opportunity via a second subchannel, where the second subchannel is different from the primary channel.
Clause 69: The method of clause 68, where the AP is capable of performing a listen-before-talk procedure on the first subchannel, the second subchannel, or both.
Clause 70: The method of any of clauses 68 through 69, where the first subchannel is a main primary channel, and the second subchannel is an opportunistic primary subchannel.
Clause 71: The method of any of clauses 68 through 70, where the second transmission opportunity is the same as the first transmission opportunity and a transmission is carried in a same Physical Layer Convergence Protocol (PLCP) protocol data unit (PPDU).
Clause 72: The method of clause 71, where the PPDU is a frequency domain aggregate PPDU (A-PPDU) or a high efficiency (HE) multi-user (MU) PPDU, an extremely high throughput MU PPDU (EHT) PPDU, or an ultra high reliability MU PPDU (UHR MU PPDU).
Clause 73: The method of any of clauses 68 through 72, further including: performing an initial frame exchange prior to communicating via at least one of the first subchannel or the second subchannel in accordance with monitoring the first subchannel or monitoring the second subchannel, the initial frame exchange including an initiating frame and a response frame.
Clause 74: The method of clause 73, where one of the initiating frame or the response frame includes an indication of a remaining duration of a first transmission opportunity on the first subchannel, a duration of the second transmission opportunity on the second subchannel, a priority level for signaling associated with the second transmission opportunity, a transmit power, a obtained signal strength, or any combination thereof.
Clause 75: The method of any of clauses 73 through 74, further including: receiving, from a first STA, a reporting message indicating that the first STA supports the initial frame exchange, where performing the initial frame exchange is based on receiving the reporting message.
Clause 76: The method of any of clauses 73 through 75, further including: transmitting, to a first STA, an indication that the initial frame exchange is enabled, where performing the initial frame exchange is based on transmitting the indication.
Clause 77: The method of any of clauses 73 through 76, where the initiating frame includes a request to send message, a multi-user request to send, or a request to trigger message, and the response frame includes a clear to send message or a trigger message, and the initiating frame or the response frame or both are transmitted in a non High Throughput (HT) PPDU, a non-HT duplicate PPDU, or a UHR PPDU and are transmitted with one spatial stream at 24 Mbps or less.
Clause 78: The method of any of clauses 68 through 77, further including: transmitting, to a first STA via the first subchannel using a first radio, a first initiating frame indicating a first transmission opportunity on the first subchannel; transmitting, to a second STA via the first subchannel or the second subchannel, the first initiating frame or a second initiating frame indicating a second transmission opportunity on the second subchannel, where an ending boundary of the first transmission opportunity is aligned in time with an ending boundary of the second transmission opportunity; receiving a first response frame from the first STA via the first subchannel and a second response frame from the second STA via the second subchannel; and transmitting a first message to the first STA and a second message to the second STA during the transmission opportunity according to the first initiating frame and the second initiating frame, respectively.
Clause 79: The method of clause 78, where the second transmission opportunity is the same as the first transmission opportunity and a transmission is carried in a same Physical Layer Convergence Protocol (PLCP) protocol data unit (PPDU).
Clause 80: The method of clause 79, where the PPDU is a frequency domain aggregate PPDU (A-PPDU) or a high efficiency (HE) multi-user (MU) PPDU, an extremely high throughput MU PPDU (EHT) PPDU, or an ultra high reliability MU PPDU (UHR MU PPDU).
Clause 81: The method of any of clauses 78 through 80, further including: performing a first listen-before-talk procedure for the first subchannel using the first radio; and tuning the first radio to cover the first subchannel and the second subchannel according to the first listen-before-talk procedure, a second listen-before-talk procedure for the second subchannel using the second radio, or both, where transmitting the first initiating frame and the second initiating frame using the first radio is based on tuning the first radio.
Clause 82: The method of any of clauses 78 through 81, further including: performing a first listen-before-talk procedure for the first subchannel using the first radio; and performing a second listen-before-talk procedure for the second subchannel using the first radio, where transmitting the first initiating frame and the second initiating frame is based on the first listen-before-talk procedure and the second listen-before-talk procedure.
Clause 83: The method of any of clauses 68 through 82, further including: detecting, using a first radio, a first message from a first STA associated with an overlapping basic service set via the first subchannel during a first transmission opportunity; transmitting, to a second STA via the second subchannel using the first radio, an initiating frame indicating a second transmission opportunity on the second subchannel, receiving a response frame from the second STA via the second subchannel using the first radio; and communicating a second message from the second STA via the second subchannel using the first radio during the second transmission opportunity according to the response frame.
Clause 84: The method of clause 83, further including: performing a listen-before-talk procedure for the second subchannel using the second radio; and switching the first radio to the second subchannel and the second radio to the first subchannel based on the listen-before-talk procedure, where transmitting the initiating frame is based on the switching.
Clause 85: The method of any of clauses 83 through 84, further including: performing a listen-before-talk procedure for the first subchannel using the second radio after a duration of the detected first message.
Clause 86: The method of any of clauses 83 through 85, further including: estimating a duration of the first transmission opportunity, where transmitting the initiating frame is based on the estimating.
Clause 87: The method of any of clauses 83 through 86, further including: performing a listen-before-talk procedure for the first subchannel while receiving the second message; and determining that the first transmission opportunity has ended based on the listen-before-talk procedure.
Clause 88: The method of any of clauses 68 through 87, further including: detecting, using a first radio, a first message from a first STA associated with an overlapping basic service set via the first subchannel during a first transmission opportunity; receiving, from a second STA via the second subchannel, an initiating frame indicating a requested duration of a second transmission opportunity on the second subchannel; transmitting, to the second STA via the second subchannel using the first radio, a response frame indicating an updated duration of the second transmission opportunity; and communicating a second message with the second STA via the second subchannel using the first radio during the second transmission opportunity according to the response frame.
Clause 89: The method of clause 88, where an ending boundary of the first transmission opportunity is not aligned in time with an ending boundary of the requested duration of the second transmission opportunity, and an ending boundary of the first transmission opportunity is aligned in time with an ending boundary of the updated duration of the second transmission opportunity.
Clause 90: The method of any of clauses 88 through 89, where an ending boundary of the updated second transmission opportunity is aligned in time with an ending boundary of the requested duration of the second transmission opportunity.
Clause 91: The method of any of clauses 88 through 90, further including: switching the first radio to the second subchannel and the second radio to the first subchannel based on having received the initiating frame via the second radio, where transmitting the response frame using the first radio is based on the switching.
Clause 92: The method of any of clauses 88 through 91, where receiving the initiating frame includes: receiving the initiating frame using the first radio.
Clause 93: The method of any of clauses 88 through 92, further including: estimating a duration of the first transmission opportunity, where transmitting the response frame is based on the estimating.
Clause 94: The method of any of clauses 88 through 93, further including: performing a listen-before-talk procedure for the first subchannel while receiving the second message.
Clause 95: The method of any of clauses 68 through 94, further including: receiving, based on monitoring for communications with a first STA and a second STA, a first portion of a first message associated with a first priority level from a second STA associated with a basic service set via the first subchannel during a first transmission opportunity, where the first STA is associated with the basic service set; receiving, from the first STA via the second subchannel, an initiating frame indicating a requested duration of a second transmission opportunity on the second subchannel, where the initiating frame includes an indication of a second priority level associated with the second transmission opportunity; transmitting, to the first STA via the second subchannel, a response frame indicating an updated duration of the second transmission opportunity, where the first priority level is higher than the second priority level, and where the updated duration of the second transmission opportunity is equal to zero; and receiving a remainder of the first message via the first subchannel.
Clause 96: The method of any of clauses 68 through 95, further including: receiving, based on monitoring for communications with a first STA and a second STA, a first portion of a first message associated with a first priority level from a second STA associated with a basic service set via the first subchannel during a first transmission opportunity, where the first STA is associated with the basic service set; receiving, from the first STA via the second subchannel, an initiating frame indicating a requested duration of a second transmission opportunity on the second subchannel, where the initiating frame includes an indication of a second priority level associated with the second transmission opportunity; transmitting, to the first STA via the second subchannel, a response frame indicating an updated duration of the second transmission opportunity, where the second priority level is higher than the first priority level; and dropping a remainder of the first message via the first subchannel while receiving a second message from the first STA via the second subchannel during the second transmission opportunity.
Clause 97: The method of any of clauses 68 through 96, further including: receiving, from first STA, a reporting message indicating that the first STA supports simultaneous transmit receive operations or non-simultaneous transmit receive operations, a quantity of simultaneous transmit or a quantity of simultaneous receive operations supported over the first subchannel, the second subchannel, or both, or any combination thereof.
Clause 98: The method of any of clauses 68 through 97, where a first radio includes a main radio associated with the first subchannel, and a second radio includes an auxiliary radio capable of preamble detection, reception, transmission, simultaneous reception and transmission, or any combination thereof, transmission or reception procedures via the first radio or the second radio are based on a PPDU type, a modulation and coding scheme (MCS), a number of spatial streams(NSS), or any combination thereof.
Clause 99: The method of any of clauses 68 through 98, further including: transmitting, to a first STA, an indication that request to send and clear to send signaling is enabled; recording one or more request to send message received from the first STA via the second subchannel while communicating one or more Physical Layer Convergence Protocol (PLCP) protocol data units (PPDUs) via the first subchannel; and transmitting one or more delayed triggering messages, or one or more delayed clear to send messages corresponding to the one or more received request to send messages, or a combination thereof, after receiving the one or more PPDUs via the first subchannel.
Clause 100: The method of any of clauses 68 through 99, further including: performing a handshake procedure with a first STA indicating that the operating bandwidth is clear, where the operating bandwidth includes a quantity of subchannels that includes the first subchannel and the second subchannel, and where the quantity of subchannels satisfies a threshold quantity of subchannels supported by the first STA; and communicating with the first STA simultaneously via each of the quantity of subchannels in accordance with the handshake procedure.
Clause 101: The method of clause 100, where communicating with the first STA includes: communicating an initial transmission via one subchannel of the quantity of subchannels; and communicating a copy of the initial transmission via each remaining subchannel of the quantity of subbands.
Clause 102: The method of any of clauses 100 through 101, where communicating with the first STA includes: communicating a first portion of a data transmission via one subchannel of the quantity of subbands; and communicating a second portion of the data via another subchannel of the quantity of subbands.
Clause 103: The method of any of clauses 100 through 102, further including: shifting a center frequency to a non-center frequency for each of a subset of the quantity of subbands.
Clause 104: The method of any of clauses 100 through 103, where performing the handshake procedure includes: exchanging a request to send message and a clear to send message, or a clear-to-send-to-self message, with the first STA.
Clause 105: The method of any of clauses 100 through 104, where the handshake procedure with the first STA further indicates that a second operating bandwidth including a second quantity of subchannels is clear, and the communicating with the first STA further includes communicating with the first STA simultaneously via each of the second quantity of subchannels.
Clause 106: The method of clause 105, further including: receiving, from the AP, a mapping of the quantity of subchannels for application to the second quantity of subchannels.
Clause 107: The method of any of clauses 100 through 106, where the first STA includes a drone located at least a threshold distance from the AP.
Clause 108: A method for wireless communications at a first STA, including: communicating with an AP during a first transmission opportunity via a first subchannel within an operating bandwidth of a wireless communication link, where a second transmission opportunity of a second subchannel of the operating bandwidth at least partially overlaps with the first transmission opportunity, where the STA is capable of performing a listen-before-talk procedure on the first subchannel, the second subchannel, or both.
Clause 109: The method of clause 108, where the first transmission opportunity is associated with the second subchannel, and a transmission is carried in a same Physical Layer Convergence Protocol (PLCP) protocol data unit (PPDU).
Clause 110: The method of clause 109, where the PPDU is a frequency domain aggregate PPDU (A-PPDU) or a high efficiency (HE) multi-user (MU) PPDU, an extremely high throughput MU PPDU (EHT) PPDU, or an ultra high reliability MU PPDU (UHR MU PPDU).
Clause 111: The method of any of clauses 108 through 110, further including: performing an initial frame exchange prior to communicating via at least one of the first subchannel or the second subchannel in accordance with at least one of monitoring the first subchannel or monitoring the second subchannel, the initial frame exchange including an initiating frame and a response frame.
Clause 112: The method of clause 111, where one of the initiating frame or the response frame includes an indication of a remaining duration of a first transmission opportunity on the first subchannel, a duration of a second transmission opportunity, a priority level for signaling associated with the second transmission opportunity, a transmit power, a received signal strength, or any combination thereof.
Clause 113: The method of any of clauses 111 through 112, further including: transmitting, to an AP, a reporting message indicating that the first STA supports the initial frame exchange, where performing the initial frame exchange is based on transmitting the reporting message.
Clause 114: The method of any of clauses 111 through 113, further including: receiving, from the AP, an indication that the initial frame exchange is enabled, where performing the initial frame exchange is based on receiving the indication.
Clause 115: The method of any of clauses 111 through 114, where the initiating frame includes a request to send message or a multi-user request to send or a request to trigger message, and the response frame includes a clear to send message or a trigger message.
Clause 116: The method of any of clauses 108 through 115, further including: receiving, from the AP via the first subchannel or the second subchannel using a first radio, an initiating frame indicating the first transmission opportunity on the first subchannel; tuning a second radio to the second subchannel; transmitting, to the AP via the second subchannel using the second radio, a response frame; and receiving a message from the AP during the first transmission opportunity on the first subchannel.
Clause 117: The method of any of clauses 108 through 116, further including: receiving, from the AP via the second subchannel using a first radio, an initiating frame indicating a transmission opportunity on the second subchannel; tuning a second radio to the second subchannel; transmitting, to the AP via the second subchannel using the second radio, a response frame; and communicating a message with the AP via the second subchannel using the second radio during the transmission opportunity according to the response frame.
Clause 118: The method of clause 117, where an ending boundary of the transmission opportunity is aligned in time with an ending boundary of a second transmission opportunity on the first subchannel.
Clause 119: The method of any of clauses 108 through 118, further including: performing a listen-before talk procedure for the second subchannel using a first radio; tuning a second radio to the second subchannel; transmitting, to the AP via the second subchannel using the second radio, an initiating frame; receiving, from the AP via the second subchannel using the second radio, a response frame; and transmitting a message to the AP via the second subchannel using the second radio during the first transmission opportunity according to the response frame.
Clause 120: The method of any of clauses 108 through 119, further including: performing a listen-before talk procedure for the second subchannel using a first radio; tuning a second radio to the second subchannel; transmitting, to the AP via the second subchannel using the second radio, an initiating frame indicating a requested duration of a transmission opportunity on the second subchannel, where the initiating frame includes an indication of a priority level associated with the transmission opportunity; receiving, from the AP via the second subchannel using the second radio, a response frame indicating an updated duration of the second transmission opportunity, where the updated duration of the second transmission opportunity is equal to zero; and refraining from transmitting during the transmission opportunity according to the updated duration of the second transmission opportunity.
Clause 121: The method of any of clauses 108 through 120, further including: performing a listen-before talk procedure for the second subchannel using a using a first radio, tuning a second radio to the second subchannel; transmitting, to the AP via the second subchannel using the first radio, an initiating frame indicating a requested duration of a transmission opportunity on the second subchannel, where the initiating frame includes an indication of a priority level associated with the transmission opportunity; receiving, from the AP via the second subchannel using the second radio, a response frame indicating an updated duration of the second transmission opportunity, where the updated duration of the second transmission opportunity is less than or equal to the requested duration; and transmitting a message to the AP via the second subchannel using the second radio during a second transmission opportunity according to the updated duration of the second transmission opportunity.
Clause 122: The method of any of clauses 108 through 121, further including: transmitting, to the AP, a reporting message indicating that the STA supports simultaneous transmit receive operations or non-simultaneous transmit receive operations, a quantity of simultaneous transmit or a quantity of simultaneous receive operations supported over the first subchannel, the second subchannel, or both, or any combination thereof.
Clause 123: The method of clause 122, further including: refraining from initiating additional communication on one of the first subchannel or the second subchannel based on detecting communication by the AP via the other of the first subchannel or the second subchannel, where the refraining is based on the quantity of simultaneous transmit or the quantity of simultaneous receive operations supported over the first subchannel, the second subchannel, or both.
Clause 124: The method of any of clauses 108 through 123, further including: where a first radio includes a main radio associated with the first subchannel, and a second radio includes an auxiliary radio capable of preamble detection, reception, transmission, simultaneous reception and transmission, or any combination thereof, where transmission or reception procedures via the first radio or the second radio are based on a PPDU type, a modulation and coding scheme (MCS), a network security.
Clause 125: The method of any of clauses 108 through 124, further including: receiving, based on monitoring the first subchannel, a multi-user request to send message (MU-RTS); and switching from the first subchannel to the second subchannel based on receiving the multi-user request to send message, where monitoring the second subchannel is based on the switching.
Clause 126: The method of any of clauses 108 through 125, further including: receiving, from the AP, an indication of a threshold quantity of cross-primary network allocation vectors (NAVs) the STA is to maintain; and initiating an initial frame exchange including an initiating frame and a response frame based on a quantity of non-zero cross-primary NAVs maintained by the STA not exceeding the threshold quantity.
Clause 127: The method of any of clauses 108 through 126, further including: performing a handshake procedure with the AP indicating that the operating bandwidth is clear, where the operating bandwidth includes a quantity of subchannels that includes the first subchannel and the second subchannel, and where the quantity of subchannels satisfies a threshold quantity of subchannels supported by the first STA; and communicating with the AP simultaneously via each of the quantity of subchannels in accordance with the handshake procedure.
Clause 128: The method of clause 127, where communicating with the AP includes: communicating an initial transmission via one subchannel of the quantity of subchannels; and communicating a copy of the initial transmission via each remaining subchannel of the quantity of subbands.
Clause 129: The method of any of clauses 127 through 128, where communicating with the AP includes: communicating a first portion of a data transmission via one subchannel of the quantity of subchannels; and communicating a second portion of the data via another subchannel of the quantity of subchannels.
Clause 130: The method of any of clauses 127 through 129, further including: shifting a center frequency to a non-center frequency for each of a subset of the quantity of subchannels.
Clause 131: The method of any of clauses 127 through 130, where performing the handshake procedure includes: exchanging a request to send message and a clear to send message, or a clear to send to self message, with the AP.
Clause 132: The method of any of clauses 127 through 131, where the handshake procedure with the AP further indicates that a second operating bandwidth including a second quantity of subchannel is clear, and the communicating with the AP further includes communicating with the AP simultaneously via each of the second quantity of subbands.
Clause 133: The method of clause 132, further including: transmitting, to the first STA, a mapping of the quantity of subbands for application to the second quantity of subbands.
Clause 134: The method of any of clauses 127 through 133, where the first STA includes a drone located at least a threshold distance from the AP.
Clause 135: An apparatus for wireless communications at a first STA, including: means for communicating with an AP during a first transmission opportunity via a first subchannel within an operating bandwidth of a wireless communication link, where a second transmission opportunity of a second subchannel of the operating bandwidth at least partially overlaps with the first transmission opportunity, where the STA is capable of performing a listen-before-talk procedure on the first subchannel, the second subchannel, or both.
Clause 136: The apparatus of clause 135, where the first transmission opportunity is associated with the second subchannel, and a transmission is carried in a same Physical Layer Convergence Protocol (PLCP) protocol data unit (PPDU).
Clause 137: The apparatus of clause 136, where the PPDU is a frequency domain aggregate PPDU (A-PPDU) or a high efficiency (HE) multi-user (MU) PPDU, an extremely high throughput MU PPDU (EHT) PPDU, or an ultra high reliability MU PPDU (UHR MU PPDU).
Clause 138: The apparatus of any of clauses 135 through 137, further including: means for performing an initial frame exchange prior to communicating via at least one of the first subchannel or the second subchannel in accordance with at least one of monitoring the first subchannel or monitoring the second subchannel, the initial frame exchange including an initiating frame and a response frame.
Clause 139: The apparatus of clause 138, where one of the initiating frame or the response frame includes an indication of a remaining duration of a first transmission opportunity on the first subchannel, a duration of a second transmission opportunity, a priority level for signaling associated with the second transmission opportunity, a transmit power, a received signal strength, or any combination thereof.
Clause 140: The apparatus of any of clauses 138 through 139, further including: means for transmitting, to an AP, a reporting message indicating that the first STA supports the initial frame exchange, where performing the initial frame exchange is based on transmitting the reporting message.
Clause 141: The apparatus of any of clauses 138 through 140, further including: means for receiving, from the AP, an indication that the initial frame exchange is enabled, where performing the initial frame exchange is based on receiving the indication.
Clause 142: The apparatus of any of clauses 138 through 141, where the initiating frame includes a request to send message or a multi-user request to send or a request to trigger message, and the response frame includes a clear to send message or a trigger message.
Clause 143: The apparatus of any of clauses 135 through 142, further including: means for receiving, from the AP via the first subchannel or the second subchannel using a first radio, an initiating frame indicating the first transmission opportunity on the first subchannel; means for tuning a second radio to the second subchannel; means for transmitting, to the AP via the second subchannel using the second radio, a response frame; and means for receiving a message from the AP during the first transmission opportunity on the first subchannel.
Clause 144: The apparatus of any of clauses 135 through 143, further including: means for receiving, from the AP via the second subchannel using a first radio, an initiating frame indicating a transmission opportunity on the second subchannel; means for tuning a second radio to the second subchannel; means for transmitting, to the AP via the second subchannel using the second radio, a response frame; and means for communicating a message with the AP via the second subchannel using the second radio during the transmission opportunity according to the response frame.
Clause 145: The apparatus of clause 144, where an ending boundary of the transmission opportunity is aligned in time with an ending boundary of a second transmission opportunity on the first subchannel.
Clause 146: The apparatus of any of clauses 135 through 145, further including: means for performing a listen-before talk procedure for the second subchannel using a first radio; means for tuning a second radio to the second subchannel; means for transmitting, to the AP via the second subchannel using the second radio, an initiating frame; means for receiving, from the AP via the second subchannel using the second radio, a response frame; and means for transmitting a message to the AP via the second subchannel using the second radio during the first transmission opportunity according to the response frame.
Clause 147: The apparatus of any of clauses 135 through 146, further including: means for performing a listen-before talk procedure for the second subchannel using a first radio; means for tuning a second radio to the second subchannel; means for transmitting, to the AP via the second subchannel using the second radio, an initiating frame indicating a requested duration of a transmission opportunity on the second subchannel, where the initiating frame includes an indication of a priority level associated with the transmission opportunity; means for receiving, from the AP via the second subchannel using the second radio, a response frame indicating an updated duration of the second transmission opportunity, where the updated duration of the second transmission opportunity is equal to zero; and means for refraining from transmitting during the transmission opportunity according to the updated duration of the second transmission opportunity.
Clause 148: The apparatus of any of clauses 135 through 147, further including: means for performing a listen-before talk procedure for the second subchannel using a using a first radio; means for tuning a second radio to the second subchannel; means for transmitting, to the AP via the second subchannel using the first radio, an initiating frame indicating a requested duration of a transmission opportunity on the second subchannel, where the initiating frame includes an indication of a priority level associated with the transmission opportunity; means for receiving, from the AP via the second subchannel using the second radio, a response frame indicating an updated duration of the second transmission opportunity, where the updated duration of the second transmission opportunity is less than or equal to the requested duration; and means for transmitting a message to the AP via the second subchannel using the second radio during a second transmission opportunity according to the updated duration of the second transmission opportunity.
Clause 149: The apparatus of any of clauses 135 through 148, further including: means for transmitting, to the AP, a reporting message indicating that the STA supports simultaneous transmit receive operations or non-simultaneous transmit receive operations, a quantity of simultaneous transmit or a quantity of simultaneous receive operations supported over the first subchannel, the second subchannel, or both, or any combination thereof.
Clause 150: The apparatus of clause 149, further including: means for refraining from initiating additional communication on one of the first subchannel or the second subchannel based on detecting communication by the AP via the other of the first subchannel or the second subchannel, where the refraining is based on the quantity of simultaneous transmit or the quantity of simultaneous receive operations supported over the first subchannel, the second subchannel, or both.
Clause 151: The apparatus of any of clauses 135 through 150, further including: means for where a first radio includes a main radio associated with the first subchannel, and a second radio includes an auxiliary radio capable of preamble detection, reception, transmission, simultaneous reception and transmission, or any combination thereof, where transmission or reception procedures via the first radio or the second radio are based on a PPDU type, a modulation and coding scheme (MCS), a network security.
Clause 152: The apparatus of any of clauses 135 through 151, further including: means for receiving, based on monitoring the first subchannel, a multi-user request to send message (MU-RTS); and means for switching from the first subchannel to the second subchannel based on receiving the multi-user request to send message, where monitoring the second subchannel is based on the switching.
Clause 153: The apparatus of any of clauses 135 through 152, further including: means for receiving, from the AP, an indication of a threshold quantity of cross-primary network allocation vectors (NAVs) the STA is to maintain; and means for initiating an initial frame exchange including an initiating frame and a response frame based on a quantity of non-zero cross-primary NAVs maintained by the STA not exceeding the threshold quantity.
Clause 154: The apparatus of any of clauses 135 through 153, further including: means for performing a handshake procedure with the AP indicating that the operating bandwidth is clear, where the operating bandwidth includes a quantity of subchannels that includes the first subchannel and the second subchannel, and where the quantity of subchannels satisfies a threshold quantity of subchannels supported by the first STA; and means for communicating with the AP simultaneously via each of the quantity of subchannels in accordance with the handshake procedure.
Clause 155: The apparatus of clause 154, where the means for communicating with the AP include: means for communicating an initial transmission via one subchannel of the quantity of subchannels; and means for communicating a copy of the initial transmission via each remaining subchannel of the quantity of subbands.
Clause 156: The apparatus of any of clauses 154 through 155, where the means for communicating with the AP include: means for communicating a first portion of a data transmission via one subchannel of the quantity of subchannels; and means for communicating a second portion of the data via another subchannel of the quantity of subchannels.
Clause 157: The apparatus of any of clauses 154 through 156, further including: means for shifting a center frequency to a non-center frequency for each of a subset of the quantity of subchannels.
Clause 158: The apparatus of any of clauses 154 through 157, where the means for performing the handshake procedure include: means for exchanging a request to send message and a clear to send message, or a clear to send to self message, with the AP.
Clause 159: The apparatus of any of clauses 154 through 158, where the handshake procedure with the AP further indicates that a second operating bandwidth including a second quantity of subchannel is clear, and the communicating with the AP further includes communicating with the AP simultaneously via each of the second quantity of subbands.
Clause 160: The apparatus of clause 159, further including: means for transmitting, to the first STA, a mapping of the quantity of subbands for application to the second quantity of subbands.
Clause 161: The apparatus of any of clauses 154 through 160, where the first STA includes a drone located at least a threshold distance from the AP.
Clause 162: A non-transitory computer-readable medium storing code for wireless communications at a first STA, the code including instructions executable by a processor to: communicate with an AP during a first transmission opportunity via a first subchannel within an operating bandwidth of a wireless communication link, where a second transmission opportunity of a second subchannel of the operating bandwidth at least partially overlaps with the first transmission opportunity, where the STA is capable of performing a listen-before-talk procedure on the first subchannel, the second subchannel, or both.
Clause 163: The non-transitory computer-readable medium of clause 162, where the first transmission opportunity is associated with the second subchannel, and a transmission is carried in a same Physical Layer Convergence Protocol (PLCP) protocol data unit (PPDU).
Clause 164: The non-transitory computer-readable medium of clause 163, where the PPDU is a frequency domain aggregate PPDU (A-PPDU) or a high efficiency (HE) multi-user (MU) PPDU, an extremely high throughput MU PPDU (EHT) PPDU, or an ultra high reliability MU PPDU (UHR MU PPDU).
Clause 165: The non-transitory computer-readable medium of any of clauses 162 through 164, where the instructions are further executable by the processor to: perform an initial frame exchange prior to communicating via at least one of the first subchannel or the second subchannel in accordance with at least one of monitoring the first subchannel or monitoring the second subchannel, the initial frame exchange including an initiating frame and a response frame.
Clause 166: The non-transitory computer-readable medium of clause 165, where one of the initiating frame or the response frame includes an indication of a remaining duration of a first transmission opportunity on the first subchannel, a duration of a second transmission opportunity, a priority level for signaling associated with the second transmission opportunity, a transmit power, a received signal strength, or any combination thereof.
Clause 167: The non-transitory computer-readable medium of any of clauses 165 through 166, where the instructions are further executable by the processor to: transmit, to an AP, a reporting message indicating that the first STA supports the initial frame exchange, where performing the initial frame exchange is based on transmitting the reporting message.
Clause 168: The non-transitory computer-readable medium of any of clauses 165 through 167, where the instructions are further executable by the processor to: receive, from the AP, an indication that the initial frame exchange is enabled, where performing the initial frame exchange is based on receiving the indication.
Clause 169: The non-transitory computer-readable medium of any of clauses 165 through 168, where the initiating frame includes a request to send message or a multi-user request to send or a request to trigger message, and the response frame includes a clear to send message or a trigger message.
Clause 170: The non-transitory computer-readable medium of any of clauses 162 through 169, where the instructions are further executable by the processor to: receive, from the AP via the first subchannel or the second subchannel using a first radio, an initiating frame indicating the first transmission opportunity on the first subchannel; tune a second radio to the second subchannel; transmit, to the AP via the second subchannel using the second radio, a response frame; and receive a message from the AP during the first transmission opportunity on the first subchannel.
Clause 171: The non-transitory computer-readable medium of any of clauses 162 through 170, where the instructions are further executable by the processor to: receive, from the AP via the second subchannel using a first radio, an initiating frame indicating a transmission opportunity on the second subchannel; tune a second radio to the second subchannel; transmit, to the AP via the second subchannel using the second radio, a response frame; and communicate a message with the AP via the second subchannel using the second radio during the transmission opportunity according to the response frame.
Clause 172: The non-transitory computer-readable medium of clause 171, where an ending boundary of the transmission opportunity is aligned in time with an ending boundary of a second transmission opportunity on the first subchannel.
Clause 173: The non-transitory computer-readable medium of any of clauses 162 through 172, where the instructions are further executable by the processor to: perform a listen-before talk procedure for the second subchannel using a first radio; tune a second radio to the second subchannel ; transmit, to the AP via the second subchannel using the second radio, an initiating frame; receive, from the AP via the second subchannel using the second radio, a response frame; and transmit a message to the AP via the second subchannel using the second radio during the first transmission opportunity according to the response frame.
Clause 174: The non-transitory computer-readable medium of any of clauses 162 through 173, where the instructions are further executable by the processor to: perform a listen-before talk procedure for the second subchannel using a first radio; tune a second radio to the second subchannel; transmit, to the AP via the second subchannel using the second radio, an initiating frame indicating a requested duration of a transmission opportunity on the second subchannel, where the initiating frame includes an indication of a priority level associated with the transmission opportunity; receive, from the AP via the second subchannel using the second radio, a response frame indicating an updated duration of the second transmission opportunity, where the updated duration of the second transmission opportunity is equal to zero; and refrain from transmitting during the transmission opportunity according to the updated duration of the second transmission opportunity.
Clause 175: The non-transitory computer-readable medium of any of clauses 162 through 174, where the instructions are further executable by the processor to: perform a listen-before talk procedure for the second subchannel using a using a first radio; tune a second radio to the second subchannel; transmit, to the AP via the second subchannel using the first radio, an initiating frame indicating a requested duration of a transmission opportunity on the second subchannel, where the initiating frame includes an indication of a priority level associated with the transmission opportunity; receive, from the AP via the second subchannel using the second radio, a response frame indicating an updated duration of the second transmission opportunity, where the updated duration of the second transmission opportunity is less than or equal to the requested duration; and transmit a message to the AP via the second subchannel using the second radio during a second transmission opportunity according to the updated duration of the second transmission opportunity.
Clause 176: The non-transitory computer-readable medium of any of clauses 162 through 175, where the instructions are further executable by the processor to: transmit, to the AP, a reporting message indicating that the STA supports simultaneous transmit receive operations or non-simultaneous transmit receive operations, a quantity of simultaneous transmit or a quantity of simultaneous receive operations supported over the first subchannel, the second subchannel, or both, or any combination thereof.
Clause 177: The non-transitory computer-readable medium of clause 176, where the instructions are further executable by the processor to: refrain from initiating additional communication on one of the first subchannel or the second subchannel based on detecting communication by the AP via the other of the first subchannel or the second subchannel, where the refraining is based on the quantity of simultaneous transmit or the quantity of simultaneous receive operations supported over the first subchannel, the second subchannel, or both.
Clause 178: The non-transitory computer-readable medium of any of clauses 162 through 177, where the instructions are further executable by the processor to: where a first radio include a main radio associated with the first subchannel, and a second radio includes an auxiliary radio capable of preamble detection, reception, transmission, simultaneous reception and transmission, or any combination thereof, where transmission or reception procedures via the first radio or the second radio are based on a PPDU type, a modulation and coding scheme (MCS), a network security.
Clause 179: The non-transitory computer-readable medium of any of clauses 162 through 178, where the instructions are further executable by the processor to: receive, based on monitoring the first subchannel, a multi-user request to send message (MU-RTS); and switch from the first subchannel to the second subchannel based on receiving the multi-user request to send message, where monitoring the second subchannel is based on the switching.
Clause 180: The non-transitory computer-readable medium of any of clauses 162 through 179, where the instructions are further executable by the processor to: receive, from the AP, an indication of a threshold quantity of cross-primary network allocation vectors (NAVs) the STA is to maintain; and initiate an initial frame exchange including an initiating frame and a response frame based on a quantity of non-zero cross-primary NAVs maintained by the STA not exceeding the threshold quantity.
Clause 181: The non-transitory computer-readable medium of any of clauses 162 through 180, where the instructions are further executable by the processor to: perform a handshake procedure with the AP indicating that the operating bandwidth is clear, where the operating bandwidth includes a quantity of subchannels that includes the first subchannel and the second subchannel, and where the quantity of subchannels satisfies a threshold quantity of subchannels supported by the first STA; and communicate with the AP simultaneously via each of the quantity of subchannels in accordance with the handshake procedure.
Clause 182: The non-transitory computer-readable medium of clause 181, where the instructions to communicate with the AP are executable by the processor to: communicate an initial transmission via one subchannel of the quantity of subchannels; and communicate a copy of the initial transmission via each remaining subchannel of the quantity of subbands.
Clause 183: The non-transitory computer-readable medium of any of clauses 181 through 182, where the instructions to communicate with the AP are executable by the processor to: communicate a first portion of a data transmission via one subchannel of the quantity of subchannels; and communicate a second portion of the data via another subchannel of the quantity of subchannels.
Clause 184: The non-transitory computer-readable medium of any of clauses 181 through 183, where the instructions are further executable by the processor to: shift a center frequency to a non-center frequency for each of a subset of the quantity of subchannels.
Clause 185: The non-transitory computer-readable medium of any of clauses 181 through 184, where the instructions to perform the handshake procedure are executable by the processor to: exchange a request to send message and a clear to send message, or a clear to send to self message, with the AP.
Clause 186: The non-transitory computer-readable medium of any of clauses 181 through 185, where the handshake procedure with the AP further indicates that a second operating bandwidth including a second quantity of subchannel is clear, and the communicating with the AP further includes communicating with the AP simultaneously via each of the second quantity of subbands.
Clause 187: The non-transitory computer-readable medium of clause 186, where the instructions are further executable by the processor to: transmit, to the first STA, a mapping of the quantity of subbands for application to the second quantity of subbands.
Clause 188: The non-transitory computer-readable medium of any of clauses 181 through 187, where the first STA includes a drone located at least a threshold distance from the AP.
Clause 189: An apparatus for wireless communications at a first STA, including: a controller associated with a memory device, where the controller is configured to cause the apparatus to: communicate with an AP during a first transmission opportunity via a first subchannel within an operating bandwidth of a wireless communication link, where a second transmission opportunity of a second subchannel of the operating bandwidth at least partially overlaps with the first transmission opportunity, where the STA is capable of performing a listen-before-talk procedure on the first subchannel, the second subchannel, or both.
Clause 190: The apparatus of clause 189, where the first transmission opportunity is associated with the second subchannel, and a transmission is carried in a same Physical Layer Convergence Protocol (PLCP) protocol data unit (PPDU).
Clause 191: The apparatus of clause 190, where the PPDU is a frequency domain aggregate PPDU (A-PPDU) or a high efficiency (HE) multi-user (MU) PPDU, an extremely high throughput MU PPDU (EHT) PPDU, or an ultra high reliability MU PPDU (UHR MU PPDU).
Clause 192: The apparatus of any of clauses 189 through 191, where the controller is further configured to cause the apparatus to: perform an initial frame exchange prior to communicating via at least one of the first subchannel or the second subchannel in accordance with at least one of monitoring the first subchannel or monitoring the second subchannel, the initial frame exchange including an initiating frame and a response frame.
Clause 193: The apparatus of clause 192, where one of the initiating frame or the response frame includes an indication of a remaining duration of a first transmission opportunity on the first subchannel, a duration of a second transmission opportunity, a priority level for signaling associated with the second transmission opportunity, a transmit power, a received signal strength, or any combination thereof.
Clause 194: The apparatus of any of clauses 192 through 193, where the controller is further configured to cause the apparatus to: transmit, to an AP, a reporting message indicating that the first STA supports the initial frame exchange, where performing the initial frame exchange is based on transmitting the reporting message.
Clause 195: The apparatus of any of clauses 192 through 194, where the controller is further configured to cause the apparatus to: receive, from the AP, an indication that the initial frame exchange is enabled, where performing the initial frame exchange is based on receiving the indication.
Clause 196: The apparatus of any of clauses 192 through 195, where the initiating frame includes a request to send message or a multi-user request to send or a request to trigger message, and the response frame includes a clear to send message or a trigger message.
Clause 197: The apparatus of any of clauses 189 through 196, where the controller is further configured to cause the apparatus to: receive, from the AP via the first subchannel or the second subchannel using a first radio, an initiating frame indicating the first transmission opportunity on the first subchannel; tune a second radio to the second subchannel; transmit, to the AP via the second subchannel using the second radio, a response frame; and receive a message from the AP during the first transmission opportunity on the first subchannel.
Clause 198: The apparatus of any of clauses 189 through 197, where the controller is further configured to cause the apparatus to: receive, from the AP via the second subchannel using a first radio, an initiating frame indicating a transmission opportunity on the second subchannel; tune a second radio to the second subchannel; transmit, to the AP via the second subchannel using the second radio, a response frame; and communicate a message with the AP via the second subchannel using the second radio during the transmission opportunity according to the response frame.
Clause 199: The apparatus of clause 198, where an ending boundary of the transmission opportunity is aligned in time with an ending boundary of a second transmission opportunity on the first subchannel.
Clause 200: The apparatus of any of clauses 189 through 199, where the controller is further configured to cause the apparatus to: perform a listen-before talk procedure for the second subchannel using a first radio; tune a second radio to the second subchannel; transmit, to the AP via the second subchannel using the second radio, an initiating frame; receive, from the AP via the second subchannel using the second radio, a response frame; and transmit a message to the AP via the second subchannel using the second radio during the first transmission opportunity according to the response frame.
Clause 201: The apparatus of any of clauses 189 through 200, where the controller is further configured to cause the apparatus to: perform a listen-before talk procedure for the second subchannel using a first radio; tune a second radio to the second subchannel; transmit, to the AP via the second subchannel using the second radio, an initiating frame indicating a requested duration of a transmission opportunity on the second subchannel, where the initiating frame includes an indication of a priority level associated with the transmission opportunity; receive, from the AP via the second subchannel using the second radio, a response frame indicating an updated duration of the second transmission opportunity, where the updated duration of the second transmission opportunity is equal to zero; and refrain from transmitting during the transmission opportunity according to the updated duration of the second transmission opportunity.
Clause 202: The apparatus of any of clauses 189 through 201, where the controller is further configured to cause the apparatus to: perform a listen-before talk procedure for the second subchannel using a using a first radio; tune a second radio to the second subchannel; transmit, to the AP via the second subchannel using the first radio, an initiating frame indicating a requested duration of a transmission opportunity on the second subchannel, where the initiating frame includes an indication of a priority level associated with the transmission opportunity; receive, from the AP via the second subchannel using the second radio, a response frame indicating an updated duration of the second transmission opportunity, where the updated duration of the second transmission opportunity is less than or equal to the requested duration; and transmit a message to the AP via the second subchannel using the second radio during a second transmission opportunity according to the updated duration of the second transmission opportunity.
Clause 203: The apparatus of any of clauses 189 through 202, where the controller is further configured to cause the apparatus to: transmit, to the AP, a reporting message indicating that the STA supports simultaneous transmit receive operations or non-simultaneous transmit receive operations, a quantity of simultaneous transmit or a quantity of simultaneous receive operations supported over the first subchannel, the second subchannel, or both, or any combination thereof.
Clause 204: The apparatus of clause 203, where the controller is further configured to cause the apparatus to: refrain from initiating additional communication on one of the first subchannel or the second subchannel based on detecting communication by the AP via the other of the first subchannel or the second subchannel, where the refraining is based on the quantity of simultaneous transmit or the quantity of simultaneous receive operations supported over the first subchannel, the second subchannel, or both.
Clause 205: The apparatus of any of clauses 189 through 204, where the controller is further configured to cause the apparatus to: where a first radio include a main radio associated with the first subchannel, and a second radio includes an auxiliary radio capable of preamble detection, reception, transmission, simultaneous reception and transmission, or any combination thereof, where transmission or reception procedures via the first radio or the second radio are based on a PPDU type, a modulation and coding scheme (MCS), a network security.
Clause 206: The apparatus of any of clauses 189 through 205, where the controller is further configured to cause the apparatus to: receive, based on monitoring the first subchannel, a multi-user request to send message (MU-RTS); and switch from the first subchannel to the second subchannel based on receiving the multi-user request to send message, where monitoring the second subchannel is based on the switching.
Clause 207: The apparatus of any of clauses 189 through 206, where the controller is further configured to cause the apparatus to: receive, from the AP, an indication of a threshold quantity of cross-primary network allocation vectors (NAVs) the STA is to maintain; and initiate an initial frame exchange including an initiating frame and a response frame based on a quantity of non-zero cross-primary NAVs maintained by the STA not exceeding the threshold quantity.
Clause 208: The apparatus of any of clauses 189 through 207, where the controller is further configured to cause the apparatus to: perform a handshake procedure with the AP indicating that the operating bandwidth is clear, where the operating bandwidth includes a quantity of subchannels that includes the first subchannel and the second subchannel, and where the quantity of subchannels satisfies a threshold quantity of subchannels supported by the first STA; and communicate with the AP simultaneously via each of the quantity of subchannels in accordance with the handshake procedure.
Clause 209: The apparatus of clause 208, where communicating with the AP is configured to cause the apparatus to: communicate an initial transmission via one subchannel of the quantity of subchannels; and communicate a copy of the initial transmission via each remaining subchannel of the quantity of subbands.
Clause 210: The apparatus of any of clauses 208 through 209, where communicating with the AP is configured to cause the apparatus to: communicate a first portion of a data transmission via one subchannel of the quantity of subchannels; and communicate a second portion of the data via another subchannel of the quantity of subchannels.
Clause 211: The apparatus of any of clauses 208 through 210, where the controller is further configured to cause the apparatus to: shift a center frequency to a non-center frequency for each of a subset of the quantity of subchannels.
Clause 212: The apparatus of any of clauses 208 through 211, where performing the handshake procedure is configured to cause the apparatus to: exchange a request to send message and a clear to send message, or a clear to send to self message, with the AP.
Clause 213: The apparatus of any of clauses 208 through 212, where the handshake procedure with the AP further indicates that a second operating bandwidth including a second quantity of subchannel is clear, and the communicating with the AP further includes communicating with the AP simultaneously via each of the second quantity of subbands.
Clause 214: The apparatus of clause 213, where the controller is further configured to cause the apparatus to: transmit, to the first STA, a mapping of the quantity of subbands for application to the second quantity of subbands.
Clause 215: The apparatus of any of clauses 208 through 214, where the first STA includes a drone located at least a threshold distance from the AP.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communications at an access point (AP), comprising:
one or more interfaces configured to:
communicate during a first transmission opportunity (TXOP) via a first subchannel within an operate bandwidth of a wireless communication link, wherein the first subchannel is a primary channel; and
communicate during a second transmission opportunity (TXOP) that at least partially overlap with the first transmission opportunity via a second subchannel, wherein the second subchannel is different from the primary channel.

2. The apparatus of claim 1, wherein the AP is capable of performing a listen-before-talk procedure on the first subchannel, the second subchannel, or both.

3. The apparatus of claim 1, wherein the first subchannel is a main primary channel, and the second subchannel is an opportunistic primary subchannel.

4. The apparatus of claim 1, wherein the one or more interfaces are further configured to:
perform an initial frame exchange prior to communicating via at least one of the first subchannel or the second subchannel in accordance with monitoring the first subchannel or monitoring the second subchannel, the initial frame exchange comprising an initiating frame and a response frame.

5. The apparatus of claim 1, wherein the one or more interfaces are further configured to:
output, to a first STA via the first subchannel using a first radio, a first initiating frame indicating a first transmission opportunity on the first subchannel;
output, to a second STA via the first subchannel or the second subchannel, the first initiating frame or a second initiating frame indicating a second transmission opportunity on the second subchannel, wherein an ending boundary of the first transmission opportunity is aligned in time with an ending boundary of the second transmission opportunity;
obtain a first response frame from the first STA via the first subchannel and a second response frame from the second STA via the second subchannel; and
output a first message to the first STA and a second message to the second STA during the transmission opportunity according to the first initiating frame and the second initiating frame, respectively.

6. The apparatus of claim 5, wherein the second transmission opportunity is the same as the first transmission opportunity and a transmission is carried in a same Physical Layer Convergence Protocol (PLCP) protocol data unit (PPDU).

7. (canceled)

8. The apparatus of claim 5, wherein the one or more interfaces are further configured to:
perform a first listen-before-talk procedure for the first subchannel using the first radio; and
tune the first radio to cover the first subchannel and the second subchannel according to the first listen-before-talk procedure, a second listen-before-talk procedure for the second subchannel using the second radio, or both, wherein transmitting the first initiating frame and the second initiating frame using the first radio is based at least in part on tuning the first radio.

9. The apparatus of claim 5, wherein the one or more interfaces are further configured to:
perform a first listen-before-talk procedure for the first subchannel using the first radio; and
perform a second listen-before-talk procedure for the second subchannel using the first radio, wherein transmitting the first initiating frame and the second initiating frame is based at least in part on the first listen-before-talk procedure and the second listen-before-talk procedure.

10. The apparatus of claim 1, wherein the one or more interfaces are further configured to:
detect, using a first radio, a first message from a first STA associated with an overlapping basic service set via the first subchannel during a first transmission opportunity;
output, to a second STA via the second subchannel using the first radio, an initiating frame indicating a second transmission opportunity on the second subchannel,
obtain a response frame from the second STA via the second subchannel using the first radio; and
communicate a second message from the second STA via the second subchannel using the first radio during the second transmission opportunity according to the response frame.

11. (canceled)

12. The apparatus of claim 1, wherein the one or more interfaces are further configured to:
perform a handshake procedure with a first STA indicating that the operating bandwidth is clear, wherein the operating bandwidth comprises a quantity of subchannels that includes the first subchannel and the second subchannel, and wherein the quantity of subchannels satisfies a threshold quantity of subchannels supported by the first STA; and
communicate with the first STA simultaneously via each of the quantity of subchannels in accordance with the handshake procedure.

13. (canceled)

14. (canceled)

15. An apparatus for wireless communications at a first station (STA), comprising:
one or more interfaces configured to:
communicate with an access point (AP) during a first transmission opportunity via a first subchannel within an operating bandwidth of a wireless communication link, wherein a second transmission opportunity of a second subchannel of the operating bandwidth at least partially overlaps with the first transmission opportunity, wherein the STA is capable of performing a listen-before-talk procedure on the first subchannel, the second subchannel, or both.

16. The apparatus of claim 15, wherein the one or more interfaces are further configured to:
perform an initial frame exchange prior to communicating via at least one of the first subchannel or the second subchannel in accordance with at least one of monitoring the first subchannel or monitoring the second subchannel, the initial frame exchange comprising an initiating frame and a response frame.

17. The apparatus of claim 15, wherein the one or more interfaces are further configured to:
obtain, from the AP via the first subchannel or the second subchannel using a first radio, an initiating frame indicating the first transmission opportunity on the first subchannel;
tune a second radio to the second subchannel;
output, to the AP via the second subchannel using the second radio, a response frame; and
obtain a message from the AP during the first transmission opportunity on the first subchannel.

18. The apparatus of claim 15, wherein the instructions are further executable by the processor to cause the apparatus to:
obtain, from the AP via the second subchannel using a first radio, an initiating frame indicating a transmission opportunity on the second subchannel;
tune a second radio to the second subchannel;
output, to the AP via the second subchannel using the second radio, a response frame; and
communicate a message with the AP via the second subchannel using the second radio during the transmission opportunity according to the response frame.

19. The apparatus of claim 15, wherein the one or more interfaces are further configured to:
perform a handshake procedure with the AP indicating that the operating bandwidth is clear, wherein the operating bandwidth comprises a quantity of subchannels that includes the first subchannel and the second subchannel, and wherein the quantity of subchannels satisfies a threshold quantity of subchannels supported by the first STA; and
communicate with the AP simultaneously via each of the quantity of subchannels in accordance with the handshake procedure.

20. (canceled)

21. (canceled)

22. A method for wireless communications at an access point (AP), comprising:
communicating during a first transmission opportunity via a first subchannel within an operating bandwidth of a wireless communication link, wherein the first subchannel is a primary channel; and
communicating during a second transmission opportunity that at least partially overlaps with the first transmission opportunity via a second subchannel, wherein the second subchannel is different from the primary channel.

23. The method of claim 22, further comprising:
performing an initial frame exchange prior to communicating via at least one of the first subchannel or the second subchannel in accordance with monitoring the first subchannel or monitoring the second subchannel, the initial frame exchange comprising an initiating frame and a response frame.

24. (canceled)

25. The method of claim 22, further comprising:
receiving, from first STA, a reporting message indicating that the first STA supports simultaneous transmit receive operations or non-simultaneous transmit receive operations, a quantity of simultaneous transmit or a quantity of simultaneous receive operations supported over the first subchannel, the second subchannel, or both, or any combination thereof.

26. The method of claim 22, wherein a first radio comprises a main radio associated with the first subchannel, and a second radio comprises an auxiliary radio capable of preamble detection, reception, transmission, simultaneous reception and transmission, or any combination thereof, wherein transmission or reception procedures via the first radio or the second radio are based at least in part on a PPDU type, a modulation and coding scheme (MCS), a number of spatial streams (NSS), or any combination thereof.

27. The method of claim 22, further comprising:
transmitting, to a first STA, an indication that request to send and clear to send signaling is enabled;
recording one or more request to send message received from the first STA via the second subchannel while communicating one or more Physical Layer Convergence Protocol (PLCP) protocol data units (PPDUs) via the first subchannel; and
transmitting one or more delayed triggering messages, or one or more delayed clear to send messages corresponding to the one or more received request to send messages, or a combination thereof, after receiving the one or more PPDUs via the first subchannel.

28-30. (canceled)
